(19) United States
(12) Patent Application Publication
(10) Pub. No.: US 2017/0180803 A1
(43) Pub. Date: Jun. 22, 2017

(54) BROADCAST TRANSMISSION DEVICE, BROADCAST RECEPTION DEVICE, METHOD FOR OPERATING BROADCAST TRANSMISSION DEVICE, AND METHOD FOR OPERATING BROADCAST RECEPTION DEVICE

(71) Applicant: LG ELECTRONICS INC., Seoul (KR)

(72) Inventors: Jinwon LEE, Seoul (KR); Seungryul YANG, Seoul (KR); Sejin OH, Seoul (KR); Woosuk KO, Seoul (KR); Seungjoo AN, Seoul (KR); Kyoungsoo MOON, Seoul (KR); Sungryong HONG, Seoul (KR)

(73) Assignee: LG ELECTRONICS INC., Seoul (KR)

(21) Appl. No.: 15/410,976

(22) Filed: Jan. 20, 2017

Related U.S. Application Data
(63) Continuation of application No. PCT/KR2015/007944, filed on Jul. 29, 2015.
(60) Provisional application No. 62/030,620, filed on Jul. 30, 2014.
(60) Provisional application No. 62/033,094, filed on Aug. 4, 2014.
(60) Provisional application No. 62/044,940, filed on Sep. 2, 2014.

(51) Int. Cl. H04N 21/462; H04N 21/2387; H04N 21/436; H04N 21/84

(52) U.S. Cl. CPC H04N 21/4622; H04N 21/84; H04N 21/2387; H04N 21/436; H04N 21/64322

(57) ABSTRACT

A broadcast reception device comprises: a broadcast interface for receiving a service, which includes a program, and signaling information; a companion screen interface for discovering a companion screen device; and a control unit for discovering the service and extracting the signaling information including descriptive information on the service, wherein the control unit generates playback state information for indicating a playback state of the program on the basis of the signaling information, and the companion screen interface can transmit the playback state information to the companion screen device.

### TECHNICAL FIELD

The present invention relates to a broadcast transmission device, a broadcast reception device, a method of operating the broadcast transmission device and a method of operating the broadcast reception device.

### BACKGROUND ART

With improvement in digital broadcasting and communication, hybridcast broadcast using a broadband network as well as broadcast networks has come into the spotlight. Such hybrid broadcast provides applications or broadcast services interoperating with terminal devices such as smartphones or tablets. Furthermore, hybrid broadcast provides applications related to broadcast services and a personalization function of providing content adapted to each user.

For such hybrid broadcast, a broadcast reception device needs to freely access a broadband network and to reproduce content received through the broadband network. To this end, a broadcast reception device and a broadcast transmission device need to support a content delivery protocol that supports both a broadcast network and a broadband network. In view of this, the broadcast transmission device and the broadcast reception device can use MPEG-Dynamic Adaptive Streaming over HTTP (DASH) that is standard technology for adaptively delivering media content depending on network environment and MPEG media transport (MMT) that is a transport standard for efficiently delivering media content through an IP network.

### DISCLOSURE

### Technical Problem

An object of the present invention is to provide a broadcast transmission device, a broadcast reception device, a method of operating the broadcast transmission device and a method of operating the broadcast reception device for transmitting and reproducing media content through a broadband network and a broadcast network.

An embodiment of the present invention provides a method of delivering, by a broadcast reception device, service time information to a companion screen device.

An embodiment of the present invention provides a method of supporting time-shift of an interactive application that can be executed along with a program when the program is time-shifted.

An embodiment of the present invention provides a method of synchronizing a broadcast reception device with a companion screen device.

### Technical Solution

A broadcast reception device according to an embodiment of the present invention includes: a broadcast interface for receiving a service including a program, and signaling information; a companion screen interface for discovering a companion screen device; and a controller for discovering the service and extracting signaling descriptive information on the service, wherein the controller generates playback state information indicating a playback state of the program on the basis of the signaling information, and wherein the companion screen interface delivers the playback state information to the companion screen device.

The signaling information may include at least one of a fragmentation_indicator indicating whether the signaling information has been fragmented, a payload_format_indicator indicating whether a header of the signaling information includes information about a payload format, an expiration_indicator indicating whether the header of the signaling information includes expiration of the signaling information, a fragment_number attribute indicating the number of a fragment of the signaling information, a last_fragment_number attribute indicating the number of the last fragment of the signaling information, a payload_format attribute indicating a payload format of the signaling information, and an expiration attribute indicating expiration of the signaling information.

The signaling information may include first information providing discovery and acquisition of the service and at least one content component included in the service.

The signaling information may include second information containing data related to fast channel participation and switching, wherein the second information builds a list of the service and provides bootstrap discovery of the first information.

The playback state information may include a speed attribute indicating a playback speed of the program.

The companion screen interface may receive, from the companion screen device, a playback information request for acquisition of playback information, wherein the controller generates playback information including playback state information indicating a playback state of the playback program and the companion screen interface delivers the playback information to the companion screen device.

The controller may generate playback information including playback state information indicating the playback state of the program when the playback state of the program has changed, and the companion screen interface may generate an event and delivers the playback information to the companion screen device.

The controller may generate service time information providing information related to synchronization between the program and a program displayed through the companion screen device on the basis of the signaling information, wherein the service time information includes the playback state information.

The service time information may further include at least one of a serviceId attribute indicating an ID of the service, a programId attribute indicating an ID of the playback program in the service, a mediaTime element indicating the media time information of the program and a currentTime element indicating wall-clock time.

The companion screen interface may deliver the service time information to the companion screen device on the basis of a first request for acquisition of the service time information received from the companion screen device.

The controller may generate service time information including playback state information indicating the playback state of the program when the playback state of the program has changed, and the companion screen interface may generate an event and delivers the service time information to the companion screen device.

The controller may generate update interval information indicating an interval at which the service time information is delivered, and the companion screen interface may deliver the service time information to the companion screen device on the basis of the update interval information.

The update interval information may be one of update duration information indicating a duration in which the service time information is delivered and update frequency information indicating frequency with which the service time information is delivered.

The companion screen interface may receive a second request for acquisition of update interval information from the companion screen device, the controller may generate current update interval information indicating a value of the update interval information at a time indicated by the wall-clock time on the basis of the second request, and the companion screen interface may deliver the current update interval information to the companion screen device.

The companion screen interface may receive a third request for setting of update interval information from the companion screen device, wherein the third request includes requested update interval information indicating a value of update interval information requested by the companion screen device, the controller may generate confirmed update interval information indicating one of the same value as the requested update interval information and a value closest to the requested update interval information, and the companion screen interface may deliver the service time information to the companion screen device on the basis of the confirmed update interval information.

### Advantageous Effects

An embodiment of the present invention provides a broadcast transmission device, a broadcast reception device, a method of operating the broadcast transmission device and a method of operating the broadcast reception device for transmitting and reproducing media content through broadband networks and broadcast networks.

An embodiment of the present invention can deliver application signaling per application ID to a companion device.

An embodiment of the present invention provides a method of delivering interactive application signaling of a next generation hybrid broadcast system.

An embodiment of the present invention can deliver interactive application signaling received by a TV, that is, a primary device, to a second screen, that is, a companion device, in a next generation hybrid broadcast system.

An embodiment of the present invention can provide synchronization between content displayed through a broadcast reception device and content displayed through a companion screen device.

An embodiment of the present invention can support time-shift of an interactive application that can be executed along with a program when the program is time-shifted.

An embodiment of the present invention can synchronize a program played back through the broadcast reception device with a program played back through the companion screen device.

### DESCRIPTION OF DRAWINGS

FIG. 1 illustrates a structure of an apparatus for transmitting broadcast signals for future broadcast services according to an embodiment of the present invention;

FIG. 2 illustrates a BICM block according to an embodiment of the present invention;

FIG. 3 illustrates an OFDM (orthogonal frequency division multiplexing) generation block according to an embodiment of the present invention;

FIG. 4 illustrates a structure of media presentation description (MPD) according to an embodiment of the present invention;

FIG. 5 is a flowchart of an operation for receiving media content through an IP network by a broadcast reception device according to an embodiment of the present invention;

FIG. 6 is a flowchart illustrating an operation for scanning a broadcast service and generating a channel map by a broadcast reception device 100;

FIG. 7 is a flowchart illustrating an operation for receiving a broadcast signal by the broadcast reception device 100;

FIG. 8 is a flowchart illustrating an operation for acquiring a media component by a broadcast reception device based on media content presentation information;

FIG. 9 illustrates configuration of a service signaling message according to an embodiment of the present invention;

FIG. 10 illustrates a configuration of a broadcast service signaling message in a next-generation broadcast system according to an embodiment of the present invention;

FIG. 11 illustrates the syntax of bootstrap( ) field according to values of time base_transport_mode field and signaling_transport_mode field according to an embodiment of the present invention;

FIG. 12 illustrates a procedure of acquiring time base and a service signaling message;

FIG. 13 illustrates a configuration of a broadcast service signaling message in a next-generation broadcast system according to an embodiment of the present invention;

FIG. 14 illustrates a configuration of a signaling message for signaling a component data acquisition path of a broadcast service in a next-generation broadcast system;

FIG. 15 is a flowchart illustrating an operation of a broadcast reception device according to an embodiment of the present invention;

FIG. 16 illustrates service types and component types of the service types according to an embodiment of the present invention;

FIG. 17 illustrates transmission of a broadcast signal based on application signaling information by a broadcast transmission device according to embodiments of the present invention;

FIG. 18 illustrates acquisition of application signaling information based on a broadcast signal by a broadcast reception device according to embodiments of the present invention;

FIG. 19 is a diagram illustrating event information according to an embodiment of the present invention;

FIG. 20 is a diagram illustrating UPnP Action Mechanism according to an embodiment of the present invention;

FIG. 21 is a diagram illustrating a REST mechanism according to an embodiment of the present invention.

FIG. 22 is a flowchart illustrating an operation of a broadcast reception device according to an embodiment of the present invention;

FIG. 23 is a diagram illustrating a broadcast system for delivery of time information according to an embodiment of the present invention;

FIG. 24 is a diagram illustrating state variables for delivery of service time information according to an embodiment of the present invention;

FIG. 25 is a diagram illustrating service time information according to an embodiment of the present invention;

FIG. 26 is a diagram illustrating operations required to transmit service time information according to an embodiment of the present invention;

FIG. 27 is a diagram illustrating delivery frequency information according to an embodiment of the present invention;

FIG. 28 is a flow diagram of transmitting service time information to a companion screen device by a broadcast reception device using an eventing method according to an embodiment of the present invention;

FIG. 29 is a flow diagram of transmitting service time information to a companion screen device by a broadcast reception device using a requesting method according to an embodiment of the present invention;

FIG. 30 is a flowchart illustrating an operation of a broadcast reception device according to an embodiment of the present invention;

FIG. 31 is a diagram illustrating a structure of a broadcast reception device for supporting a time-shifted application according to an embodiment of the present invention;

FIG. 32 is a diagram illustrating a time-shift management table (TMT) according to an embodiment of the present invention;

FIG. 33 is a diagram illustrating TPT signaling according to an embodiment of the present invention;

FIG. 34 is a diagram illustrating trigger signaling according to an embodiment of the present invention;

FIG. 35 is a flowchart illustrating an operation of an application based on a broadcast signal by a broadcast reception device according to another embodiment of the present invention.

FIG. 36 illustrates a configuration of a broadcast system according to an embodiment of the present invention;

FIG. 37 illustrates a configuration of a broadcast reception device according to an embodiment of the present invention;

FIG. 38 illustrates an application layer transport protocol stack according to an embodiment of the present invention;

FIG. 39 illustrates a broadcast transport frame according to an embodiment of the present invention;

FIG. 40 illustrates delivery of signaling information through an FIC and/or a PLP according to an embodiment of the present invention;

FIG. 41 illustrates a service signaling message configuration according to an embodiment of the present invention;

FIG. 42 illustrates synchronization between a broadcast reception device and a companion screen device according to an embodiment of the present invention;

FIG. 43 illustrates asynchronization between a broadcast reception device and a companion screen device according to an embodiment of the present invention;

FIG. 44 illustrates a method for synchronizing the broadcast reception device and the companion screen device according to an embodiment of the present invention;

FIG. 45 illustrates service time information including playback state information according to an embodiment of the present invention;

FIG. 46 illustrates an XML format of service time information according to an embodiment of the present invention;

FIG. 47 illustrates delivery of playback state information according to an embodiment of the present invention;

FIG. 48 illustrates delivery of playback state information according to an embodiment of the present invention;

FIG. 49 illustrates delivery of playback state information according to an embodiment of the present invention;

FIG. 50 illustrates delivery of playback state information according to an embodiment of the present invention;

FIG. 51 illustrates state variables for delivering playback information according to an embodiment of the present invention;

FIG. 52 illustrates playback information according to an embodiment of the present invention;

FIG. 53 illustrates an XML format of playback information according to an embodiment of the present invention;

FIG. 54 illustrates operations necessary to deliver playback information according to an embodiment of the present invention;

FIG. 55 is a flow diagram illustrating a process through which a broadcast reception device delivers playback information to a companion screen device using an eventing method;

FIG. 56 is a flow diagram illustrating a process through which the broadcast reception device delivers playback information to the companion screen device using a requesting method;

FIG. 57 illustrates delivery of playback state information according to an embodiment of the present invention;

FIG. 58 illustrates delivery of playback state information according to an embodiment of the present invention;

FIG. 59 is a flowchart illustrating operation of a broadcast reception device according to an embodiment of the present invention.

### BEST MODE

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention.

Although most terms of elements in this specification have been selected from general ones widely used in the art taking into consideration functions thereof in this specification, the terms may be changed depending on the intention or convention of those skilled in the art or the introduction of new technology. Some terms have been arbitrarily selected by the applicant and their meanings are explained in the following description as needed. Thus, the terms used in this specification should be construed based on the overall content of this specification together with the actual meanings of the terms rather than their simple names or meanings.

The term “signaling” in the present invention may indicate that service information (SI) that is transmitted and received from a broadcast system, an Internet system, and/or a broadcast/Internet convergence system. The service information (SI) may include broadcast service information (e.g., ATSC-SI and/or DVB-SI) received from the existing broadcast systems.

The term “broadcast signal” may conceptually include not only signals and/or data received from a terrestrial broadcast, a cable broadcast, a satellite broadcast, and/or a mobile broadcast, but also signals and/or data received from bidirectional broadcast systems such as an Internet broadcast, a broadband broadcast, a communication broadcast, a data broadcast, and/or VOD (Video On Demand).

The term “PLP” may indicate a predetermined unit for transmitting data contained in a physical layer. Therefore, the term “PLP” may also be replaced with the terms ‘data unit’ or ‘data pipe’ as necessary.

A hybrid broadcast service configured to interwork with the broadcast network and/or the Internet network may be used as a representative application to be used in a digital television (DTV) service. The hybrid broadcast service transmits, in real time, enhancement data related to broadcast A/V (Audio/Video) contents transmitted through the terrestrial broadcast network over the Internet, or transmits, in real time, some parts of the broadcast A/V contents over the Internet, such that users can experience a variety of contents.

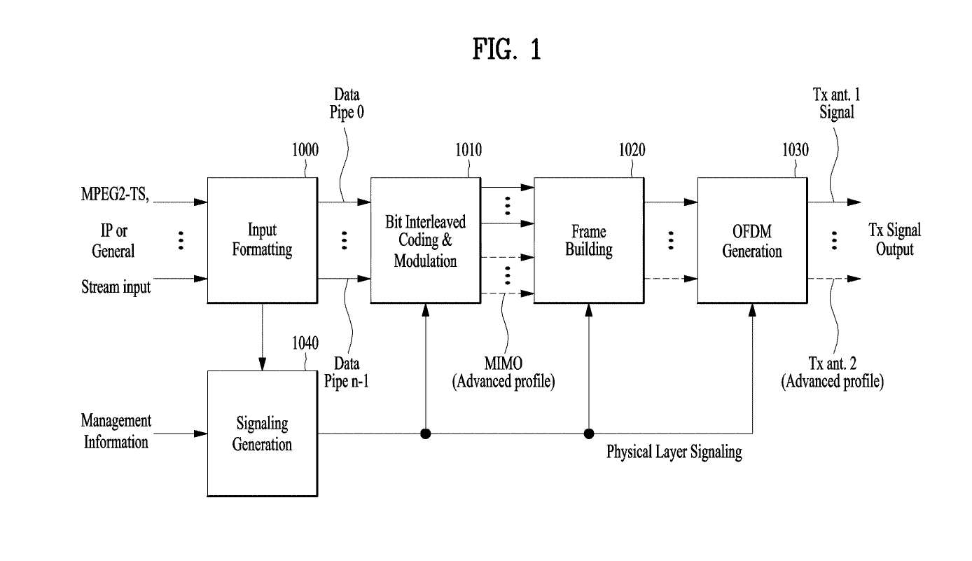

The present invention provides apparatuses and methods for transmitting and receiving broadcast signals for future broadcast services. Future broadcast services according to an embodiment of the present invention include a terrestrial broadcast service, a mobile broadcast service, a UHDTV service, etc. FIG. 1 illustrates a structure of an apparatus for transmitting broadcast signals for future broadcast services according to an embodiment of the present invention.

The apparatus for transmitting broadcast signals for future broadcast services according to an embodiment of the present invention can include an input formatting block 1000, a BICM (Bit interleaved coding & modulation) block 1010, a frame building block 1020, an OFDM (Orthogonal Frequency Division Multiplexing) generation block 1030 and a signaling generation block 1040. A description will be given of the operation of each module of the apparatus for transmitting broadcast signals.

IP stream/packets and MPEG2-TS are the main input formats, other stream types are handled as General Streams. In addition to these data inputs, Management Information is input to control the scheduling and allocation of the corresponding bandwidth for each input stream. One or multiple TS stream(s), IP stream(s) and/or General Stream(s) inputs are simultaneously allowed.

The input formatting block 1000 can demultiplex each input stream into one or multiple data pipe(s), to each of which an independent coding and modulation is applied. The data pipe (DP) is the basic unit for robustness control, thereby affecting quality-of-service (QoS). One or multiple service(s) or service component(s) can be carried by a single DP. Details of operations of the input formatting block 1000 will be described later.

The data pipe is a logical channel in the physical layer that carries service data or related metadata, which may carry one or multiple service(s) or service component(s).

Also, the data pipe unit: a basic unit for allocating data cells to a DP in a frame.

In the BICM block 1010, parity data is added for error correction and the encoded bit streams are mapped to complex-value constellation symbols. The symbols are interleaved across a specific interleaving depth that is used for the corresponding DP. For the advanced profile, MIMO encoding is performed in the BICM block 1010 and the additional data path is added at the output for MIMO transmission. Details of operations of the BICM block 1010 will be described later.

The Frame Building block 1020 can map the data cells of the input DPs into the OFDM symbols within a frame. After mapping, the frequency interleaving is used for frequency-domain diversity, especially to combat frequency-selective fading channels. Details of operations of the Frame Building block 1020 will be described later.

After inserting a preamble at the beginning of each frame, the OFDM Generation block 1030 can apply conventional OFDM modulation having a cyclic prefix as guard interval. For antenna space diversity, a distributed MISO scheme is applied across the transmitters. In addition, a Peak-to-Average Power Reduction (PAPR) scheme is performed in the time domain. For flexible network planning, this proposal provides a set of various FFT sizes, guard interval lengths and corresponding pilot patterns. Details of operations of the OFDM Generation block 1030 will be described later.

The Signaling Generation block 1040 can create physical layer signaling information used for the operation of each functional block. This signaling information is also transmitted so that the services of interest are properly recovered at the receiver side. Details of operations of the Signaling Generation block 1040 will be described later.

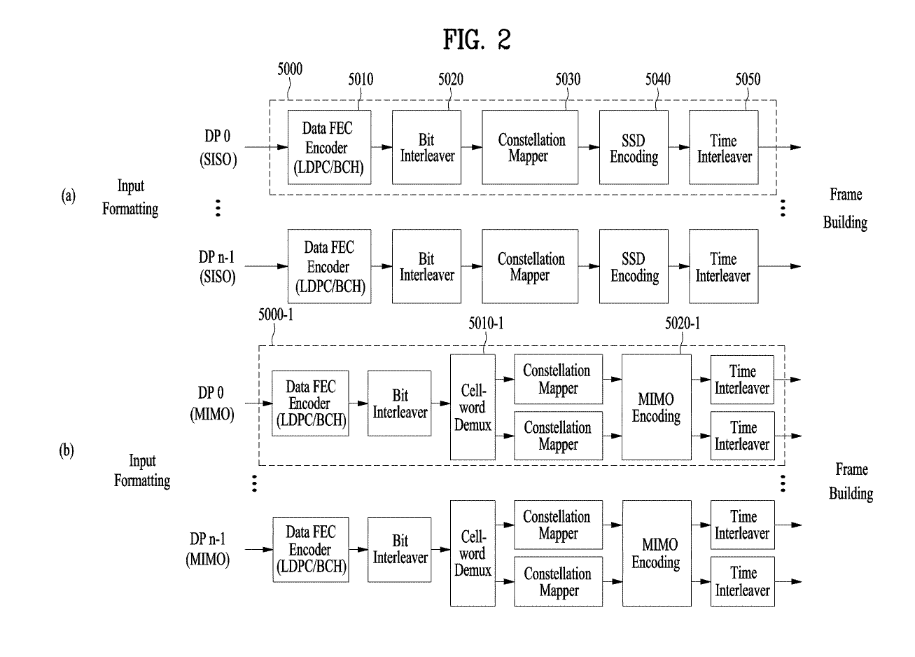

FIG. 2 illustrates a BICM block according to an embodiment of the present invention.

The BICM block illustrated in FIG. 2 corresponds to an embodiment of the BICM block 1010 described with reference to FIG. 1.

As described above, the apparatus for transmitting broadcast signals for future broadcast services according to an embodiment of the present invention can provide a terrestrial broadcast service, mobile broadcast service, UHDTV service, etc.

Since QoS (quality of service) depends on characteristics of a service provided by the apparatus for transmitting broadcast signals for future broadcast services according to an embodiment of the present invention, data corresponding to respective services needs to be processed through different schemes. Accordingly, the a BICM block according to an embodiment of the present invention can independently process DPs input thereto by independently applying SISO, MISO and MIMO schemes to the data pipes respectively corresponding to data paths. Consequently, the apparatus for transmitting broadcast signals for future broadcast services according to an embodiment of the present invention can control QoS for each service or service component transmitted through each DP.

(a) shows the BICM block shared by the base profile and the handheld profile and (b) shows the BICM block of the advanced profile.

The BICM block shared by the base profile and the handheld profile and the BICM block of the advanced profile can include plural processing blocks for processing each DP.

A description will be given of each processing block of the BICM block for the base profile and the handheld profile and the BICM block for the advanced profile.

A processing block 5000 of the BICM block for the base profile and the handheld profile can include a Data FEC encoder 5010, a bit interleaver 5020, a constellation mapper 5030, an SSD (Signal Space Diversity) encoding block 5040 and a time interleaver 5050.

The Data FEC encoder 5010 can perform the FEC encoding on the input BBF to generate FECBLOCK procedure using outer coding (BCH), and inner coding (LDPC). The outer coding (BCH) is optional coding method. Details of operations of the Data FEC encoder 5010 will be described later.

The bit interleaver 5020 can interleave outputs of the Data FEC encoder 5010 to achieve optimized performance with combination of the LDPC codes and modulation scheme while providing an efficiently implementable structure. Details of operations of the bit interleaver 5020 will be described later.

The constellation mapper 5030 can modulate each cell word from the bit interleaver 5020 in the base and the handheld profiles, or cell word from the Cell-word demultiplexer 5010-1 in the advanced profile using either QPSK, QAM-16, non-uniform QAM (NUQ-64, NUQ-256, NUQ-1024) or non-uniform constellation (NUC-16, NUC-64, NUC-256, NUC-1024) to give a power-normalized constellation point, el. This constellation mapping is applied only for DPs. Observe that QAM-16 and NUQs are square shaped, while NUCs have arbitrary shape. When each constellation is rotated by any multiple of 90 degrees, the rotated constellation exactly overlaps with its original one. This “rotation-sense” symmetric property makes the capacities and the average powers of the real and imaginary components equal to each other. Both NUQs and NUCs are defined specifically for each code rate and the particular one used is signaled by the parameter DP_MOD filed in PLS2 data.

The time interleaver 5050 can operates at the DP level. The parameters of time interleaving (TI) may be set differently for each DP. Details of operations of the time interleaver 5050 will be described later.

A processing block 5000-1 of the BICM block for the advanced profile can include the Data FEC encoder, bit interleaver, constellation mapper, and time interleaver. However, the processing block 5000-1 is distinguished from the processing block 5000 further includes a cell-word demultiplexer 5010-1 and a MIMO encoding block 5020-1.

Also, the operations of the Data FEC encoder, bit interleaver, constellation mapper, and time interleaver in the processing block 5000-1 correspond to those of the Data FEC encoder 5010, bit interleaver 5020, constellation mapper 5030, and time interleaver 5050 described and thus description thereof is omitted.

The cell-word demultiplexer 5010-1 is used for the DP of the advanced profile to divide the single cell-word stream into dual cell-word streams for MIMO processing. Details of operations of the cell-word demultiplexer 5010-1 will be described later.

The MIMO encoding block 5020-1 can processing the output of the cell-word demultiplexer 5010-1 using MIMO encoding scheme. The MIMO encoding scheme was optimized for broadcasting signal transmission. The MIMO technology is a promising way to get a capacity increase but it depends on channel characteristics. Especially for broadcasting, the strong LOS component of the channel or a difference in the received signal power between two antennas caused by different signal propagation characteristics makes it difficult to get capacity gain from MIMO. The proposed MIMO encoding scheme overcomes this problem using a rotation-based pre-coding and phase randomization of one of the MIMO output signals.

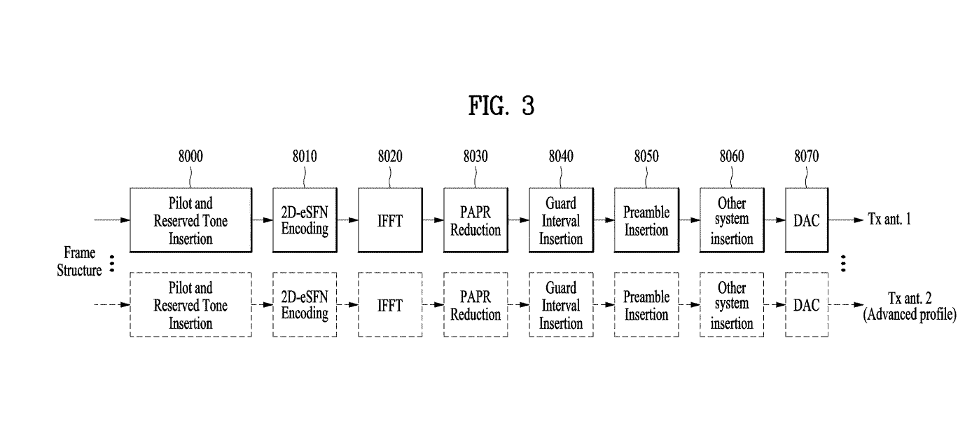

FIG. 3 illustrates an OFDM generation block according to an embodiment of the present invention.

The OFDM generation block modulates the OFDM carriers by the cells produced by the Frame Building block, inserts the pilots, and produces the time domain signal for transmission. Also, this block subsequently inserts guard intervals, and applies PAPR (Peak-to-Average Power Radio) reduction processing to produce the final RF signal.

Referring to FIG. 3, the OFDM generation block can include a pilot and reserved tone insertion block 8000, a 2D-eSFN encoding block 8010, an IFFT (Inverse Fast Fourier Transform) block 8020, a PAPR reduction block 8030, a guard interval insertion block 8040, a preamble insertion block 8050, other system insertion block 8060 and a DAC block 8070.

The other system insertion block 8060 can multiplex signals of a plurality of broadcast transmission/reception systems in the time domain such that data of two or more different broadcast transmission/reception systems providing broadcast services can be simultaneously transmitted in the same RF signal bandwidth. In this case, the two or more different broadcast transmission/reception systems refer to systems providing different broadcast services. The different broadcast services may refer to a terrestrial broadcast service, mobile broadcast service, etc.

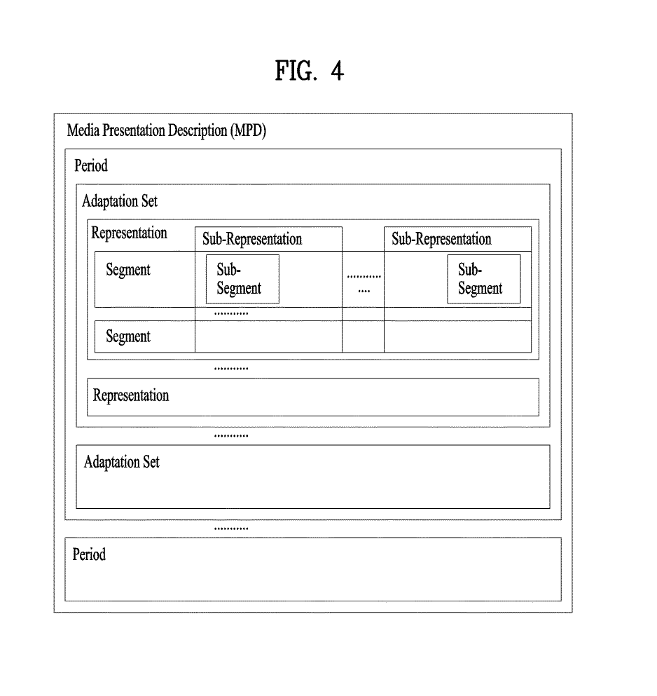

FIG. 4 illustrates a structure of media presentation description (MPD) according to an embodiment of the present invention. The MPD may include a period element, an adaptation set element, and a representation element.

The period element may include information on a period. The MPD may include information on a plurality of periods. The period may indicate a continuous time period of media content presentation.

The adaptation set element may include information on an adaptation set. The MPD may include information on a plurality of adaptation sets. The adaptation set may be a set of media components including one or more convertible media components. The adaptation set may include one or more representations. Each adaptation set may include different languages of audio or different languages of subtitles.

The representation element may include information on representation. The MPD may include information on a plurality of representations. The representation may be a set obtained by configuring one or more media components and may have a plurality of representations that are differently encoded with respect to the same media content component. When bitstream switching is possible, the broadcast reception device 100 may convert representation received based on information updated during media content presentation into another representation. In particular, the broadcast reception device 100 may convert the received representation into other representation according to an environment of a bandwidth. The representation may be divided into a plurality of segments.

A segment is a unit of media content data. In detail, the segment may be a transfer unit of media content data. The representation may be transmitted as a segment or a portion of the segment according to a request from a media content receiver 30 using an HTTP GET or HTTP partial GET method defined in HTTP 1.1 (RFC 2616).

In addition, the segment may include a plurality of sub-segments. The sub-segment may refer to a smallest unit to be indexed at the segment level. The segment may include an initialization segment, a media segment, an index segment, a bitstream switching segment, and so on.

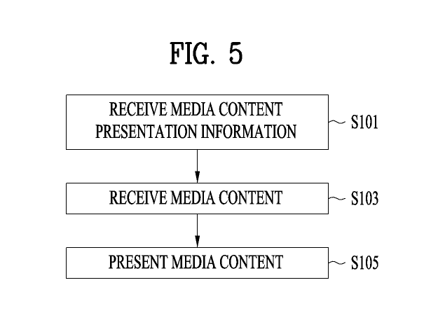

FIG. 5 is a flowchart of an operation for receiving media content through an IP network by the broadcast reception device 100 according to an embodiment of the present invention.

The broadcast reception device 100 may receive media content presentation information through the IP transceiver 130 (S101). In a detailed embodiment, media content presentation information may be MPD according to the MPEG-DASH standard. In this case, the broadcast reception device 100 may receive the MPD through the IP transceiver 130. In another embodiment, the media content presentation information may be a PI file according to the MMT standard. In this case, the broadcast reception device 100 may receive the PI file through the IP transceiver 130.

The broadcast reception device 100 may receive media content based on the media content presentation information through the IP transceiver 130 (S103).

The broadcast reception device 100 may present media content through the controller 150 (S105). In detail, the broadcast reception device 100 may present media content based on the media content presentation information through the controller 150.

It may be necessary to receive media content presentation information as described above in order to receive media content through a communication network (a broadband network) by the broadcast reception device 100 that receives a broadcast stream through a broadcast network such as satellite, cable, and terrestrial networks. In particular, media content presentation information may be transmitted and received through a broadcast stream so as to be effectively associated with content transmitted through a broadcast network. This is because, when the media content presentation information is transmitted through a broadcast stream, a content provider or a broadcaster integrates and manages content information provided through a broadcast network and information on media content transmitted through a communication network (a broadband network). The broadcast reception device 100 continuously receives a broadcast stream and, thus, when media content presentation information is transmitted through a broadcast stream, the broadcast reception device 100 may rapidly recognize whether the media content presentation information is updated without a separate information request message. In addition, when information on media content provided through a broadcast network and information on media content transmitted through a communication network (a broadband network) are integrated and signaled through the media content presentation information, a broadcast reception device may receive and present both media content transmitted through a broadcast network and media content transmitted through a communication network (a broadband network) based on the media content presentation information. Accordingly, the broadcast reception device may enhance efficiency and simplify an operation of the broadcast reception device.

When the media content presentation information is transmitted in the media content presentation information, the broadcast reception device 100 may receive the media content presentation information based on the media content presentation information table. In detail, the broadcast reception device 100 may extract the media content presentation information from the media content presentation information table and receive the media content presentation information.

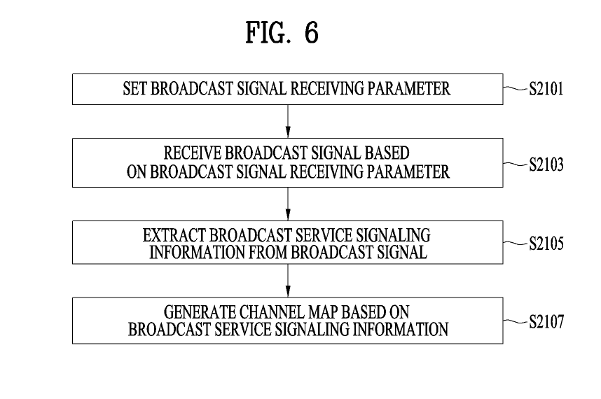

FIG. 6 is a flowchart illustrating an operation for scanning a broadcast service and generating a channel map by the broadcast reception device 100.

The controller 150 may set a broadcast signal receiving parameter. In detail, the controller 150 may set at least one of a frequency, a bandwidth, a symbol rate, and a physical layer pipe (PLP) identifier, for receiving a broadcast signal. In this case, the physical layer pipe may be a logical data transmission channel for identifying one radio frequency (RF) channel. One RF channel may include one or more physical layer pipes. The physical layer pipe may be referred to as a data pipe (DP). In a detailed embodiment, the controller 150 may set a broadcast signal receiving parameter based on a frequency table for storing a plurality of broadcast signal receiving parameters. For example, the broadcast reception device 100 may sequentially set broadcast signal receiving parameters stored in the frequency table and sequentially receive broadcast signals corresponding to the respective broadcast signal receiving parameters. In this case, the frequency table may be set according to regional standards or regional broadcast environments.

The broadcast receiver 110 may receive a broadcast signal based on the broadcast signal receiving parameter (S2103). In detail, the broadcast receiver 110 may receive a broadcast signal corresponding to the broadcast signal receiving parameter. The broadcast receiver 110 may demodulate the broadcast signal and extract a physical frame of the broadcast signal.

The controller 150 may extract broadcast service signaling information from the broadcast signal (S2105). In detail, the controller 150 may extract the broadcast service signaling information for signaling information on the broadcast service from the broadcast signal. The information on the broadcast service may include information for identifying the broadcast service. The information for identifying the broadcast service may include a channel number indicating a broadcast service. The information for identifying the broadcast service may include a broadcast service identifier for identifying the broadcast service. The information for identifying the broadcast service may include a channel number indicating the broadcast service. The information for identifying the broadcast service may include a broadcast service name indicating the broadcast service. The information on the broadcast service may include information for receiving the broadcast service. The information for receiving the broadcast service may include a broadcast signal receiving parameter required for setting of a broadcast receiver in order to receive the broadcast service. The information for receiving the broadcast service may include a broadcast stream identifier for identifying a broadcast stream transmitted by the broadcast service. The information for receiving the broadcast service may include an IP address and UDP port number for identifying the IP/UDP datagram transmitted by the broadcast service. The information for receiving the broadcast service may include a session identifier for identifying a session of the session-based transport protocol. The information for receiving the broadcast service may include a packet identifier for identifying a packet of a packet-based transmission protocol. In detail, the controller 150 may extract broadcast service signaling information of link layer signaling extracted from a link layer. In another detailed embodiment, the controller 150 may extract broadcast service signaling information from an application layer. As described above, upon receiving the broadcast service signaling information from the link layer, the controller 150 may reduce broadcast service scan time.

The controller 150 may generate a channel map for storing information on the broadcast service based on the broadcast service signaling information (S2107). In detail, the controller 150 may generate the channel map according to information on a broadcast service provided by the broadcast service signaling information. The channel map may include at least one of information for identifying each of the aforementioned broadcast services and information for receiving each of the broadcast services. The controller 150 may store the generated channel map in the channel map DB 267. The broadcast reception device 100 may receive the broadcast service based on the channel map.

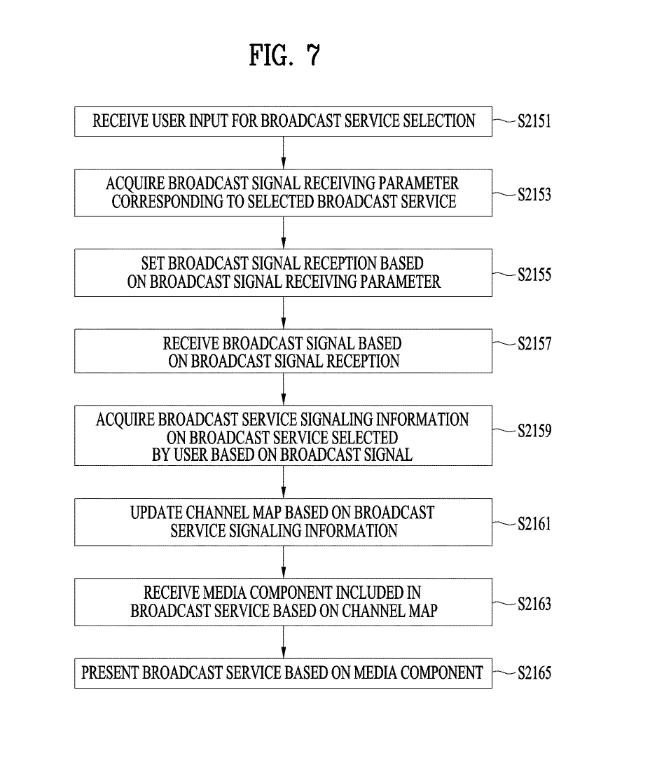

FIG. 7 is a flowchart illustrating an operation for receiving a broadcast signal by the broadcast reception device 100.

The controller 150 may receive a user input according to selection of the broadcast service (S2151). The controller 150 may receive a user input according to selection of the broadcast signal through the user input receiver 263. In detail, the controller 150 may receive an input for selecting any one broadcast service from a broadcast service list showing broadcast services by a user. The controller 150 may receive user input of a channel number through a remote controller.

The controller 150 may acquire a broadcast signal receiving parameter corresponding to the broadcast service selected by the user (S2153). In detail, the controller 150 may acquire a broadcast signal receiving parameter corresponding to the broadcast service selected by the user from the channel map. As described above, the broadcast signal receiving parameter may include at least one of a frequency, a bandwidth, a symbol rate, and a physical layer pipe identifier, for receiving a broadcast signal.

The controller 150 may set reception of the broadcast signal based on the broadcast signal receiving parameter. In detail, the controller 150 may set the broadcast receiver 110 according to the broadcast signal receiving parameter. For example, the controller 150 may set at least one of a frequency, a bandwidth, a symbol rate, and a physical layer pipe, for receiving the broadcast signal of the broadcast receiver 110. When a broadcast signal receiving parameter of a currently received broadcast signal is the same as an acquired broadcast signal receiving parameter, this operation may be omitted.

The broadcast receiver 110 may receive the broadcast signal based on the broadcast signal receiving setting (S2157). In detail, the broadcast receiver 110 may receive and demodulate the broadcast signal.

The controller 150 may acquire signaling information on the broadcast service selected by the user based on the broadcast signal (S2159). As described above, the controller 150 may acquire the broadcast service signaling information from the link layer. The controller 150 may acquire the broadcast service signaling information from the link layer. Although the channel map includes information on the broadcast service extracted from the broadcast service signaling information, the broadcast service signaling information is re-acquired. This is because information on the broadcast service is changeable after the channel map is generated. In addition, this is because only basic information for generating the channel map may be acquired and information on a component included in the broadcast service or information for broadcast service presentation may not be acquired during generation of the channel map.

The controller 150 may update the channel map based on the broadcast service signaling information. In detail, when the broadcast service signaling information is changed, the controller 150 may update the channel map. In a detailed embodiment, when previously acquired broadcast service signaling information and the broadcast service signaling information are different, the controller 150 may update the channel map. Upon comparing version information of the previously acquired broadcast service signaling information and version information of the broadcast service signaling information to determine that the broadcast service signaling information is changed, the controller 150 may update the channel map.

The controller 150 may receive a media component included in the broadcast service based on the channel map (S2163). The channel map may include information on reception of the media component. In detail, the channel map may include information for receiving the media component. The controller 150 may acquire information for receiving the media component from the channel map and receive the media component. For example, the controller 150 may acquire information for identifying an IP/UDP datagram for transmitting the media component from the channel map and information for identifying a session-based transport protocol packet for transmitting the media component and receive the media component. The information for identifying the IP/UDP datagram may include at least one of an IP address and a UDP port number. In this case, the IP address may include at least one of a source address and a destination address. The information for identifying the session-based transport protocol packet may include a session identifier for identifying a session. In detail, the session identifier may be TSI of the ALC/LCT session. In another detailed embodiment, the controller 150 may acquire information for identifying the IP/UDP datagram for transmitting the media component and information for identifying a packet-based transmission protocol packet for transmitting the media component from the channel map and receive the media component. The broadcast reception device 100 may receive the media component based on the media content presentation information.

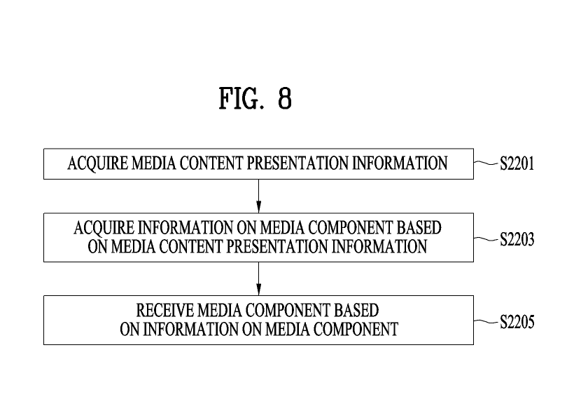

FIG. 8 is a flowchart illustrating an operation for acquiring a media component by a broadcast reception device based on media content presentation information.

The broadcast reception device 100 may acquire the media content presentation information (S2201). The broadcast reception device 100 may acquire the media content presentation information through a signaling message of the broadcast signal as described above.

The broadcast reception device 100 may acquire information on the media component based on the media content presentation information (S2203). The information on the media component may include information for receiving the aforementioned media component. The media content presentation information may include information on a broadcast service and the media component included in the broadcast service.

The broadcast reception device 100 may receive the media component based on the information on the media component (S2205). The broadcast reception device 100 may receive the media component through a broadcast network. The broadcast reception device 100 may receive the media component through a communication network. The broadcast reception device 100 may receive any one of a plurality of media components and receive another media component through a communication network. For example, the broadcast reception device 100 may receive a video component through a broadcast network and receive an audio component through a communication network.

The controller 150 may present the broadcast service based on the media component (S2165).

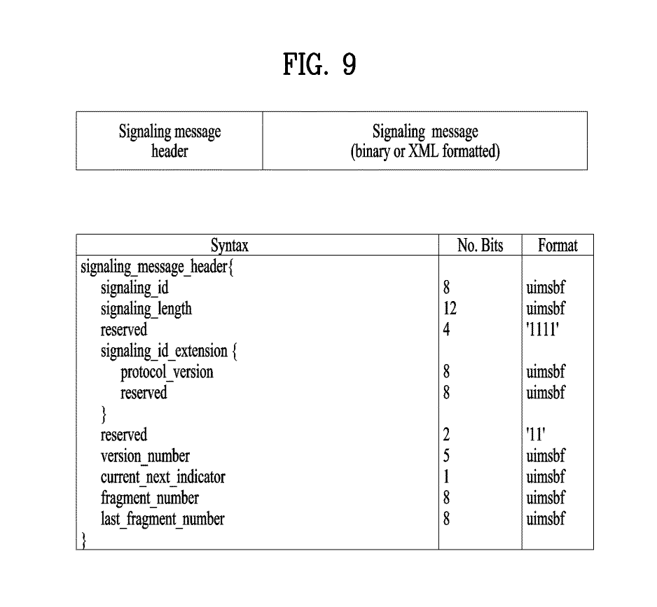

FIG. 9 illustrates configuration of a service signaling message according to an embodiment of the present invention. In detail, FIG. 9 illustrates the syntax of the service signaling message according to an embodiment of the present invention. The service signaling message according to an embodiment of the present invention may include a signaling message header and a signaling message. In this case, the signaling message may be represented in binary or in XML format. The service signaling message may be included in a payload of a transmission protocol packet.

The signaling message header according to the embodiment of FIG. 9 may include identifier information for identifying the signaling message. For example, the signaling message may have a session format. In this case, the identifier information of the signaling message may indicate an identifier (ID) of a signaling table section. A field indicating the identifier information of the signaling message may be singnaling_id. In a detailed embodiment, the signaling_id field may be 8 bits long.

A signaling message header according to the embodiment of FIG. 9 may include length information indicating a length of the signaling message header. A field indicating the length information of the signaling message may be signaling_length. In a detailed embodiment, the signaling_length field may be 12 bits long.

The signaling message header according to the embodiment of FIG. 9 may include identifier extension information for extension of an identifier of a signaling message. In this case, the identifier extension information may be information for identifying signaling together with the signaling identifier information. A field indicating the identifier extension information of the signaling message may be signaling_id_extension.

In this case, the identifier extension information may include protocol version information of the signaling message. A field indicating the protocol version information of the signaling message may be protocol_version. In a detailed embodiment, the protocol_version field may be 8 bits long.

A signaling message header according to the embodiment of FIG. 9 may include version information of the signaling message. The version information of the signaling message may be changed when content included in the signaling message is changed. A field indicating the version information of the signaling message may be version_number. In a detailed embodiment, the version_number field may be 5 bits long.

A signaling message header according to the embodiment of FIG. 9 may include information indicating whether the signaling message is currently available. A field indicating whether the signaling message is available may be current_next_indicator. For example, when the current_next_indicator field is 1, the current_next_indicator field may indicate that the signaling message is available. As another example, when the current_next_indicator field is 0, the current_next_indicator field may indicate that the signaling message is not available and another subsequent signaling message including the same signaling identifier information, signaling identifier extension information, or fragment number information is available.

A signaling message header according to the embodiment of FIG. 9 may include fragment number information of a signaling message. One signaling message may be divided into a plurality of fragments and transmitted. Accordingly, information for identifying the plurality of divided fragments by a receiver may be fragment number information. A field indicating the fragment number information may be a fragment_number field. In a detailed embodiment, the fragment_number field may be 8 bits long.

A signaling message header according to the embodiment of FIG. 9 may include number information of a last fragment when one signaling message is divided into a plurality of fragments and transmitted. For example, when information on a last fragment number indicates 3, this may indicate that the signaling message is divided into three parts. In addition, this may indicate that a fragment including a fragment number indicating 3 includes last data of the signaling message. A field indicating number information of a last fragment may be last_fragment_number. In a detailed embodiment, the last_fragment_number field may be 8 bits long.

FIG. 10 illustrates a configuration of a broadcast service signaling message in a next-generation broadcast system according to an embodiment of the present invention.

The broadcast service signaling message according to an embodiment of the present invention may correspond to a broadcast service signaling method for receiving at least one of a broadcast service and content by the broadcast reception device 100 in a next-generation broadcast system.

The broadcast service signaling method according to the embodiment of FIG. 10 may be based on the signaling message configuration illustrated in FIG. 9. The broadcast service signaling message according to the embodiment of FIG. 10 may be transmitted through a service signaling channel. In this case, the service signaling channel may be one type of a physical layer pipe for directly transmitting service signaling information for broadcast service scan without passing through another layer. In a detailed embodiment, the service signaling channel may be referred to as at least one of a fast information channel (FIC) and low layer signaling (LLS). A broadcast service signaling message according to the embodiment of FIG. 7 may be one type of XML.

The service signaling message according to the embodiment of FIG. 10 may include number information of included services. In detail, one service signaling message may include a plurality of services and include information indicating the number of included services. The number information of services may be the num_services field. In a detailed embodiment, the num_services field may be 8 bits long.

The service signaling message according to the embodiment of FIG. 10 may include identifier information on a service. The identifier information may be a service_id field. In a detailed embodiment, the service_idfield may be 16 bits long.

The service signaling message according to the embodiment of FIG. 10 may include service type information. The service type information may be service_type field. In a detailed embodiment, when the service type field has a value of 0x00, a service type indicated by the signaling message may be a scheduled audio service.

According to another embodiment, when the service_type field has a value of 0x01, a service type indicated by the signaling message may be a scheduled audio/video service. In this case, the scheduled audio/video service may be an audio/video service broadcast according to a predetermined schedule.

According to another embodiment, when the service_type field has a value of 0x02, a service type indicated by the signaling message may be an on-demand service. In this case, the on-demand service may be an audio/video service presented on-demand. The on-demand service may be a service opposite to the scheduled audio/video service.

According to another embodiment, when the service_type field has a value of 0x03, a service type indicated by the signaling message may be an app-based service. In this case, the app-based service may be a non real time (NRT) service but not a real time broadcast service and may be a service provided through an application. The app-based service may include at least one of a service associated with the real time broadcast service and a service that is not associated with the real time broadcast service. The broadcast reception device 100 may download an application and provide the app-based service.

According to another embodiment, when the service_type field has a value of 0x04, a service type indicated by the signaling message may be rights issuer service. In this case, the rights issuer service may be a service provided only to a user that is issued rights to receive a service.

According to another embodiment, when the service_type field has a value of 0x05, a service type indicated by the signaling message may be a service guide service. In this case, the service guide service may be a service for providing information on a provided service. For example, the information of the provided service may be a broadcast schedule.

The service signaling message according to the embodiment of FIG. 10 may include service name information. The service name information may be short_service_name field.

The service signaling message according to the embodiment of FIG. 10 may include length information of the short_service_name field. The length information of the short_service_name field may be contained in the short_service_name_length field.

The service signaling message according to the embodiment of FIG. 10 may include broadcast service channel number information associated with a signaled service. The associated broadcast service channel number information may be a channel_number field.

The service signaling message according to the embodiment of FIG. 10 may include data required to acquire a time base or a signaling message by a broadcast reception device according to each transmission mode to be described below. The data for acquisition of the time base or the signaling message may be a bootstrap( ) field.

The aforementioned transmission mode may be at least one of a time base transmission mode and a signaling transmission mode. The time base transmission mode may be a transmission mode of a time base including metadata about a timeline used in a broadcast service. The timeline may be a series of time information for media content. In detail, the timeline may be a series of reference times as a reference for media content presentation. Information on the time base transmission mode may correspond to a time base_transport_mode field.

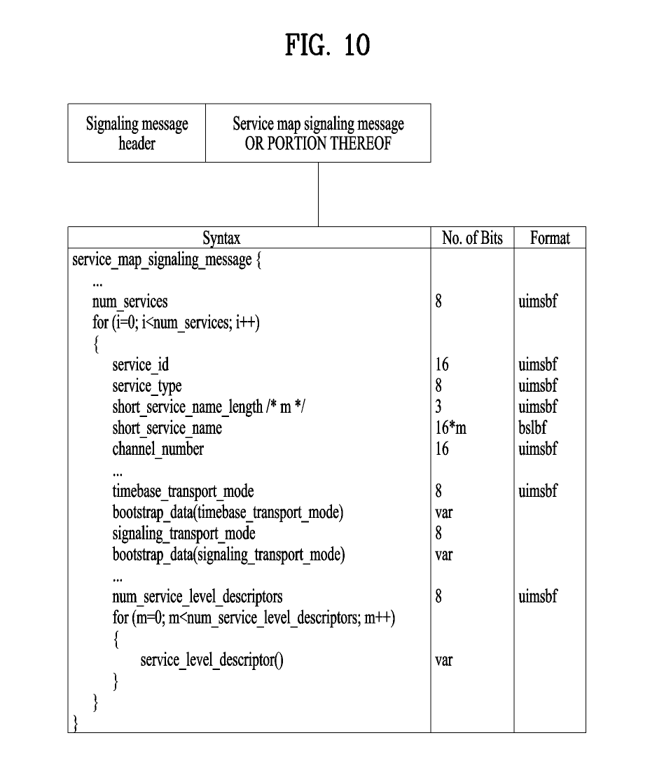

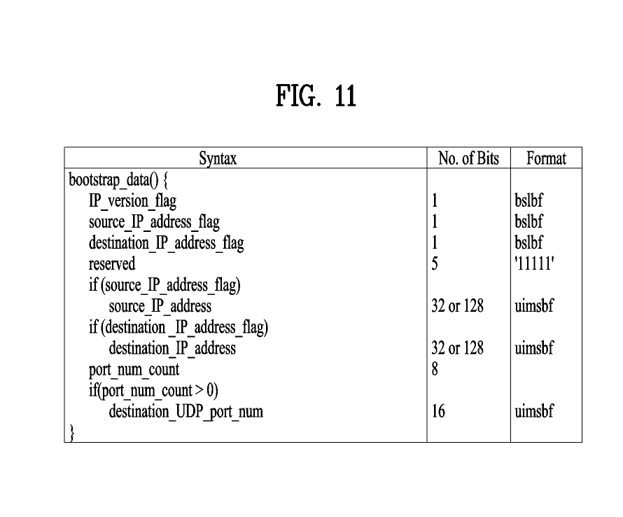

The signaling transmission mode may be a mode for transmitting a signaling message used in the broadcast service. Information on the signaling transmission mode may be contained in the signaling_transport_mode field. FIG. 11 illustrates the syntax of a bootstrap( ) field when a time base transport_mode_field and a signaling_transport_mode field have a value of 0x00 according to an embodiment of the present invention.

In the embodiment of FIG. 11, bootstrap data may include information on an IP address format of IP datagram including a time base or a signaling message. The information on the IP address format may be an IP_version_flag field. The information on the IP address format may indicate that the IP address format of the IP datagram is IPv4. According to an embodiment of the present invention, when the information on the IP address format is 0, the information on the IP address format may indicate that the IP address format of the IP datagram is IPv4. The information on the IP address format may indicate that the IP address format of IP datagram is IPv6. According to another embodiment, when the information on the IP address format is 1, the information on the IP address format may indicate that the IP address format of the IP datagram is IPv6.

In the embodiment of FIG. 11, bootstrap data may include information indicating whether the IP datagram including a time base or a signaling message includes a source IP address. In this case, the source IP address may be a source address of the IP datagram. Information indicating whether the IP datagram includes a source IP address may be source_IP_address_flag field. According to an embodiment, when the source_IP_address_flag field is 1, this may indicate that the IP datagram includes the source IP address.

In the embodiment of FIG. 11, the bootstrap data may include information indicating whether an IP datagram including the time base or the signaling message includes a destination IP address. In this case, the destination IP address may be a destination address of the IP datagram. Information indicating whether the IP datagram includes the destination IP address may be destination_IP_address field. According to an embodiment, when the destination_IP_address field is 1, this may indicate that the IP datagram includes the destination IP address.

In the embodiment of FIG. 11, the bootstrap data may include source IP address information of the IP datagram including the time base or the signaling message. The source IP address information may be a source_IP_address field.

In the embodiment of FIG. 11, the bootstrap data may include destination IP address information of the IP datagram including the time base or the signaling message. The destination IP address information may be destination_IP_address field.

In the embodiment of FIG. 11, the bootstrap data may include information on the number of flow ports of the IP datagram including the time base or the signaling message. In this case, the port may be a path for receiving a flow of the IP datagram. The information on the number of user datagram protocol (UDP) ports of the IP datagram may be port_num_count field.

In the embodiment of FIG. 11, the bootstrap data may include information on a UDP port number of the IP datagram including the time base or the signaling message. The UDP may be a communication protocol for unilaterally transmitting information from one side but not exchanging information during transmission and reception of the information via the Internet.

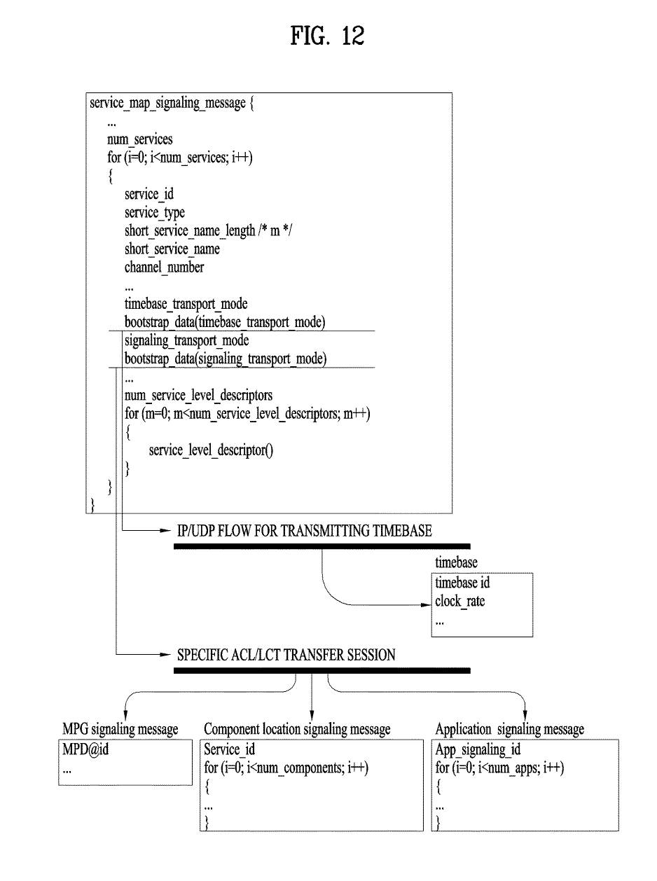

FIG. 12 illustrates a procedure of acquiring a time base and a service signaling message.

As illustrated in FIG. 12, the broadcast reception device 100 according to an embodiment of the present invention may acquire a time base through a packet-based transmission protocol. In detail, the broadcast reception device 100 may acquire a time base through an IP/UDP flow using the service signaling message. The broadcast reception device 100 according to an embodiment of the present invention may acquire a service related signaling message through the session-based transport protocol. In detail, the broadcast reception device 100 may acquire the service related signaling message through the ALC/LCT transfer session.

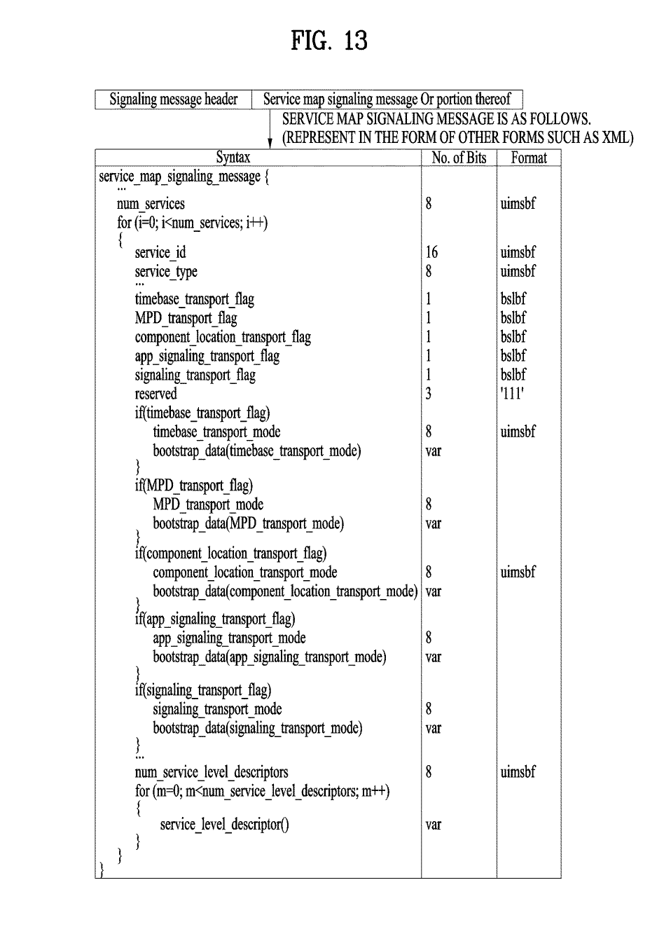

In a detailed embodiment, the signaling channel may be referred to as at least one of a fast information channel (FIC), low layer signaling (LLS), and an application layer transmission session. FIG. 13 illustrates a configuration of a broadcast service signaling message in a next-generation broadcast system according to an embodiment of the present invention. The broadcast service signaling message according to an embodiment of the present invention may correspond to a service signaling method for receiving a broadcast service and content by a broadcast reception device in a next-generation broadcast system. The broadcast service signaling according to the embodiment of FIG. 13 may be based on the signaling message configuration illustrated in FIG. 12. The broadcast service signaling message according to the embodiment FIG. 13 may be transmitted through a service signaling channel. In this case, the service signaling channel may be one form of a physical channel pipe for directly transmitting service signaling information for scanning a broadcast service without passing through another layer. In a detailed embodiment, the signaling channel may be referred to as at least one of a fast information channel (FIC), low layer signaling (LLS), and an application layer transmission session. The broadcast service signaling message according to the embodiment of FIG. 13 may be represented in XML.

The service signaling message according to the embodiment of FIG. 13 may indicate whether the service signaling message includes information required to acquire a time base. In this case, the time base may include metadata about a timeline used in the broadcast service. The timeline may be a series of time information for media content. Information indicating whether the information required to acquire the time base is included may be a timeline_transport_flag field. According to an embodiment of the present invention, when the timeline_transport_flag field has a value of 1, this may indicate that the service signaling message includes information for transmitting the time base.

The service signaling message according to the embodiment of FIG. 13 may indicate whether the service signaling message includes information required to acquire the signaling message. In this case, the signaling message may be a signaling message related to media presentation data (MPD) or MPD URL used in the broadcast service. The information indicating whether the information for acquisition of the signaling message is included may be an MPD_transport_flag field. According to an embodiment, when the MPD_transport_flag field has a value of 1, this may indicate that the service signaling message includes signaling message transmission related information related to MPD or MPD URL. Adaptive media streaming based on HTTP may be referred to as a dynamic adaptive streaming over HTTP (DASH). In addition, detailed information for acquisition of a segment included in a broadcast service and content in adaptive media streaming by a broadcast reception device may be referred to as MPD. The MPD may be represented in XML. The MPD URL related signaling message may include address information for acquisition of the MPD.

The service signaling message according to the embodiment of FIG. 13 may indicate whether the service signaling message includes information on an acquisition path for component data. In this case, the component may be one unit of content data for providing the broadcast service. The information indicating whether the path information of acquisition of the component data is included may be a component_location_transport_flag field. According to an embodiment, when the component_location_transport_flag field has a value of 1, the component_location_transport_flag field may indicate that the service signaling message includes path information for acquisition of the component data.

The service signaling message according to the embodiment of FIG. 13 may indicate whether information required for acquisition of an application related signaling message is included. The information indicating whether information required to acquisition of the application related signaling message is included may be an app_signaling_transport_flag field. According to an embodiment, when the app_signaling_transport_flag field has a value of 1, the app_signaling_transport_flag field may indicate that the service signaling message includes path information for acquisition of the component data.

The service signaling message according to the embodiment of FIG. 13 may indicate whether signaling message transmission related information is included. The information indicating whether signaling message transmission related information is included may be a signaling_transport_flag field. According to an embodiment, when the signaling_transport_flag field has a value of 1, the signaling_transport_flag field may indicate that the service signaling message includes the signaling message transmission related information. When the service signaling message does not include the aforementioned MPD related signaling, component acquisition path information, and application related signaling information, the broadcast reception device may acquire the MPD related signaling, component acquisition path information, and application related signaling information through a signaling message transmission path.

The service signaling message according to the embodiment of FIG. 13 may indicate a mode for transmitting the time base used in the broadcast service. Information on the mode for transmitting time base may be the time base_transport_mode field.

The service signaling message according to the embodiment of FIG. 13 may indicate a mode for transmitting the MPD or MPD URL related signaling message used in the broadcast service. The information on the mode for transmitting the MPD or the MPD URL related signaling message may be MPD_transport_mode field.

The service signaling message according to the embodiment of FIG. 13 may indicate a mode for transmitting a component location signaling message including an acquisition path of component data used in the broadcast service. The information on the mode for transmitting the component location signaling message including the acquisition path of the component data may be component_location_transport_mode field.

The service signaling message according to the embodiment of FIG. 13 may indicate a mode for transmitting an application related signaling message used in the broadcast service. The information on the mode for transmitting the application related signaling message may be app_signaling_transport_mode field.

The service signaling message according to the embodiment of FIG. 13 may indicate a mode for transmitting the service related signaling message used in the broadcast service. The information on the mode for transmitting the service related signaling message may be signaling_transport_mode field.

The meanings of values of the aforementioned time base_transport_mode field, MPD_transport_mode field, component_location_transport_mode field, app_signaling_transport_mode field, and signaling_transport_mode field will be described below.

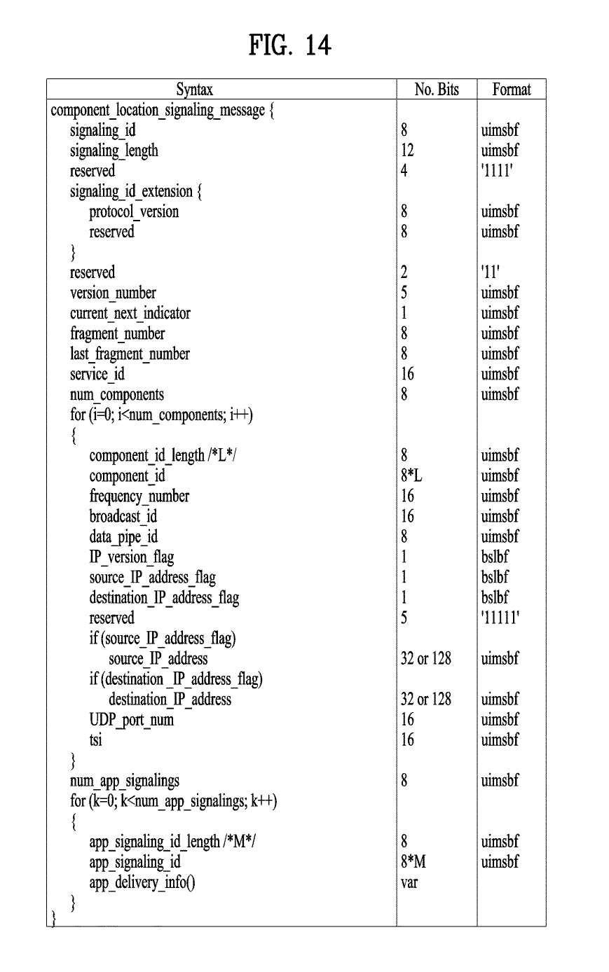

FIG. 14 illustrates a configuration of a signaling message for signaling a component data acquisition path of a broadcast service in a next-generation broadcast system. In the next-generation broadcast system, one broadcast service may include one or more components. The broadcast reception device may acquire information of an acquisition path of component data and related application in a broadcast stream. In this case, the signaling message according to the embodiment of FIG. 14 may be represented in XML.

The signaling message according to the embodiment of FIG. 14 may include information for identifying that a signaling message is a message for signaling a component location. The information for identifying that the signaling message is a message for signaling a component location may be a signaling_id field. In a detailed embodiment, the signaling_id field may be 8 bits long.

The signaling message according to the embodiment of FIG. 14 may include extension information for identifying that the signaling message is a message for signaling the component location. In this case, the extension information may include a protocol version of a message for signaling of the component location. The extension information may be signaling_id_extension field.

The signaling message according to the embodiment of FIG. 14 may include version information of a message for signaling component location. In this case, the version information may indicate that a message for signaling the component location is changed. The version information may be version_number field.

The signaling message according to the embodiment of FIG. 14 may include identifier information of an associated broadcast service. In this case, the identifier information of the associated broadcast service may be service_id field.

The signaling message according to the embodiment of FIG. 14 may include the number of components associated with the broadcast service. In this case, information on the number of associated components may be num_component field.

The signaling message according to the embodiment of FIG. 14 may include an identifier of each component. The component identifier may be configured by combining MPD@id, period@id, and representation@id of MPEG DASH. In this case, the identifier information of each component may be component_id field.

The signaling message according to the embodiment of FIG. 14 may include length information of the component_id field. In this case, the length information of the component_id field may be component_id_length field.

The signaling message according to the embodiment of FIG. 14 may include frequency information indicating a frequency for acquisition of component data. The component data may be a DASH segment. In this case, the frequency information for acquisition of the component data may be frequency_number field.

The signaling message according to the embodiment of FIG. 14 may include a unique identifier of a broadcaster. The broadcaster may transmit component data through a specific frequency or a transmitted transport frame. In this case, the unique identifier information of a broadcaster may be broadcast_id field. The broadcast_id field may indicate an identifier of a transmission stream of a broadcast service.

The signaling message according to the embodiment of FIG. 14 may include an identifier of a physical layer pipe for transmitting the component data. In this case, the identifier information of the physical layer pipe for transmitting the component data may be datapipe_id field.

The signaling message according to the embodiment of FIG. 14 may include an IP address format of an IP datagram including component data. The IP address format information of the IP datagram may be IP_version_flag field. In a detailed embodiment, when the IP_version_flag field has a field value of 0, this may indicate IPv4 format and when the IP_version_flag field has a field value of 1, this may indicate IPv6 format.

The signaling message according to the embodiment of FIG. 14 may include information indicating whether an IP datagram including component data includes a source IP address. The information indicating whether the IP datagram includes the source IP address may be source_IP_address_flag field. According to an embodiment, when the source_IP_address_flag field has a value of 1, this may indicate that the IP datagram includes the source IP address.

The signaling message according to the embodiment of FIG. 14 may include information indicating whether an IP datagram including component data includes the destination IP address. The information indicating whether the IP datagram includes the destination IP address may be a destination_IP_address_flag field. In an embodiment, when the destination_IP_address_flag field has a value of 1, this may indicate that the IP datagram includes the destination IP address.

The signaling message according to the embodiment of FIG. 14 may include source IP address information of IP datagram including component data. According to an embodiment, when the source_IP_address_flag field has a value of 1, the signaling message may include the source IP address information. The source IP address information may be a source_IP_address field.

The signaling message according to the embodiment of FIG. 14 may include destination IP address information of IP datagram including the component data. According to an embodiment, when the destination_IP_address_flag field has a value of 1, the signaling message may include the destination IP address information. The destination IP address information may be destination_IP_addres field.

The signaling message according to the embodiment of FIG. 14 may include UDP port number information of IP datagram including component data. The UDP port number information may be UDP_port_num field.

The signaling message according to the embodiment of FIG. 14 may include information of a transport session identifier of an application layer for transmitting a transport packet including component data. The session for transmitting the transport packet may be at least one of an ALC/LCT session and a FLUTE session. The identifier information of the session may be tsi field.

The signaling message according to the embodiment of FIG. 14 may include identifier information of a transport packet including component data. The identifier information of the transport packet may be packet_id field.

The signaling message according to the embodiment of FIG. 14 may include the number of application signaling messages associated with the broadcast service. In this case, the broadcast service may be a broadcast service identified according to service_id field. The number information of the application signaling messages may be num_app_signaling field.

The signaling message according to the embodiment of FIG. 14 may include identifier information of the application signaling message. The identifier information of the application signaling message may be app_signaling_id field.

The signaling message according to the embodiment of FIG. 14 may include length information of app_signaling_id field. The length information of the app_signaling_id field may be app_signaling_id_length field.

The signaling message according to the embodiment of FIG. 14 may include data about a path for acquisition of data of an application included in a signaling message associated with an identifier of the application signaling message. The path information for acquisition of the application included in the signaling message associated with the identifier of the application signaling message may be app_delivery_info( ) field.

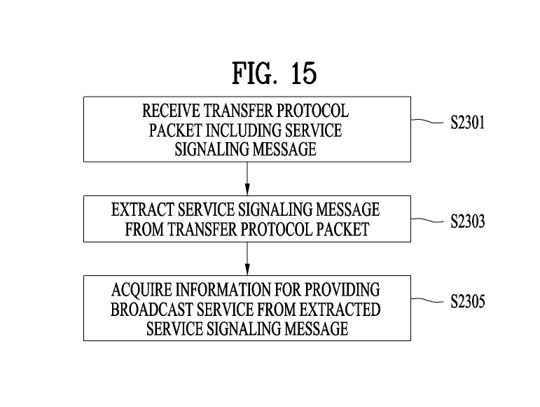

FIG. 15 is a flowchart illustrating an operation of a broadcast reception device according to an embodiment of the present invention.

A receiver of the broadcast reception device may receive a transmission protocol packet including a service signaling message (S2301). The receiver may include an Internet protocol communicator and a broadcast receiver. The service signaling message may be information for signaling at least one of a broadcast service and media content. According to an embodiment, the transmission protocol may be an Internet protocol (IP). In an embodiment, the service signaling message may be represented in the form of at least one of binary format and XML format. The transmission protocol packet may include a signaling message header and a signaling message.

A controller of the broadcast reception device may extract the service signaling message from a received transmission protocol packet (S2303). In detail, the controller may parse the transmission protocol packet to extract a service signaling message. The controller may acquire Internet protocol datagram from the hierarchical transmission protocol packet. The acquired Internet protocol datagram may include a service signaling message.

The controller of the broadcast reception device may acquire information for providing a broadcast service from the service signaling message (S2305). The information for providing the broadcast service may be a portion of the service signaling message.

According to an embodiment, the information for providing the broadcast service may be transmission mode information for time base including metadata about a timeline as series of time information for content.

The information for providing the broadcast service according to another embodiment may be transmission mode information for detailed information for acquisition of segments included in content in the adaptive media streaming. The detailed information for acquisition of the segments included in content in the adaptive media streaming may be referred to as media presentation description (MPD).

The information for providing the broadcast service according to another embodiment may be transmission mode information for a path for acquisition of component data included in content from the broadcast service. The component data may be objects included in the broadcast service or content. In this case, the acquisition path information of the component data may be identification information of a physical layer pipe for transmitting the component data. The hierarchical transmission protocol packet may include a physical layer pipe transmitted through a physical layer. A plurality of physical layer pipes may be present. Accordingly, it may be necessary to identify a physical layer pipe including component data to be acquired among the plurality of physical layer pipes.

The information for providing the broadcast service according to another embodiment may be transmission mode information for a signaling message for an application used in the broadcast service. In this case, the transmission mode information for a signaling message for an application may be at least one of identifier information of a broadcaster for transmitting an application, a source IP address of Internet protocol datagram including an application, a destination IP address of Internet protocol datagram including an application, a port number of a user data protocol (UDP) of Internet protocol datagram including the application, identifier information for a transmission session for transmitting the application, and identifier information of a packet for transmitting the application.

The information for providing the broadcast service according to another embodiment may be transmission mode information for a signaling message for a service used in the broadcast service. In this case, the service may be one content item.

The information for providing the broadcast service according to another embodiment may include transmission mode information for component data included in the service. In this case, the transmission mode information for component data may indicate at least one of a transmission mode for supporting a non real service, a transmission mode for supporting a real time service, and a transmission mode for packet transmission.

The information for providing the broadcast service according to another embodiment may include information for receiving a file type of real service.

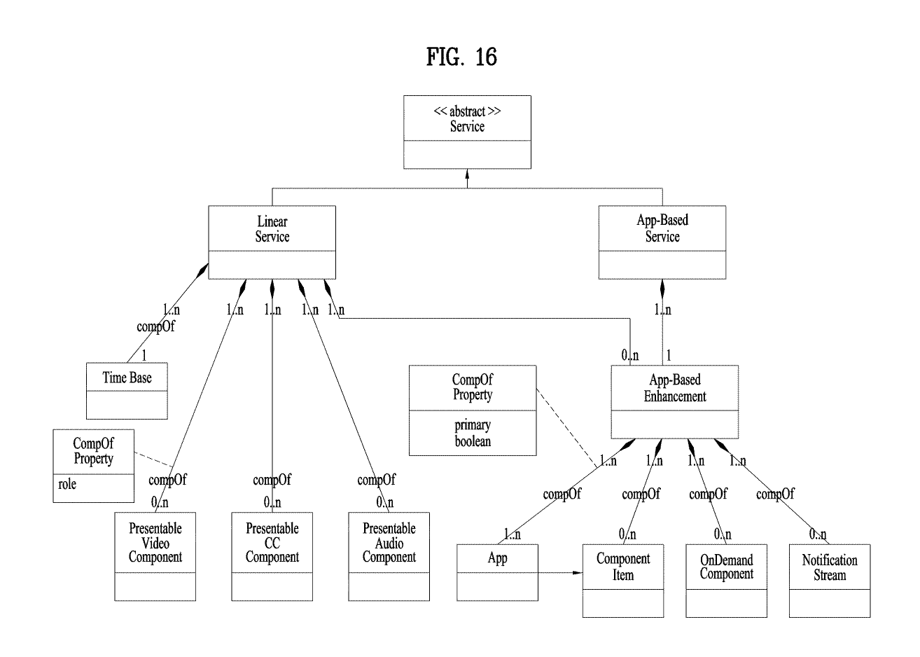

FIG. 16 illustrates service types and component types of the service types according to an embodiment of the present invention.

A linear service may transmit a broadcast signal to a broadcast reception device (e.g. TV). The linear service may be used for a service appropriate for a broadcast receiver without video decoding/display capability. For example, the linear service may transmit a service including only an audio component to the broadcast reception device. The linear service may include at least one of a time base, a presentable video component, a presentable audio component, presentable CC components, and app-based enhancement.

The application (App) may indicate a content item (or data item) for an ATSC application. The application (App) may be included in a content item (or data item).

The app-based enhancement may indicate application based enhancement for a TV service (or linear service). The app-based enhancement may include at least one of essential capabilities attribute, non-essential capabilities attribute, and/or target device attribute. The target device attribute may have a value indicating a primary device and/or a value indicating a companion device.

The app-based enhancement may include at least one of an application (App), a content item (or data item) component, a notification stream, and/or an on-demand component.

The time base may indicate metadata used to generate a time line for synchronizing components of the linear service. The time base may include clock rate attribute indicating a clock rate of the time base.

The app-based service may indicate an application-base service. The app-based service may include app-based enhancement. The app-based service may be included in a service.

The app-based enhancement may include at least one of a notification stream, an application (App), a content item, and/or an on-demand component. The notification stream may transmit notification information of a performed operation. The application may be represented as App. The content item may include a data item and/or an NRT content item. The content item may be used by the application. The on-demand component may be managed by the application.

An application of the app-based enhancement may be determined as a primary application. When a predetermined primary application is present, the primary application may be activated as soon as a service to which the primary application belongs is selected. The application may be activated by notification information included in the notification stream. The application may be activated by a pre-executed different application.

The app-based service may be at least one service including app-based enhancement. Enhancement based on one application included in the app-based service may include a predetermined primary application. The app-based service may selectively include a time base.

The application (App) may be a special case of the content item (or data item). That is, the application may include at least one file. A set of at least one file may constitute an application.

The NRT content item may include at least one of a continuous component, a non-continuous component, and/or a combination of the continuous component and the non-continuous component.

According the aforementioned embodiment of the present invention, operations of the broadcast transmission device 10 and the broadcast reception device 100 according to transmission and reception of the application signaling information will be described in detail with reference to the following drawings.

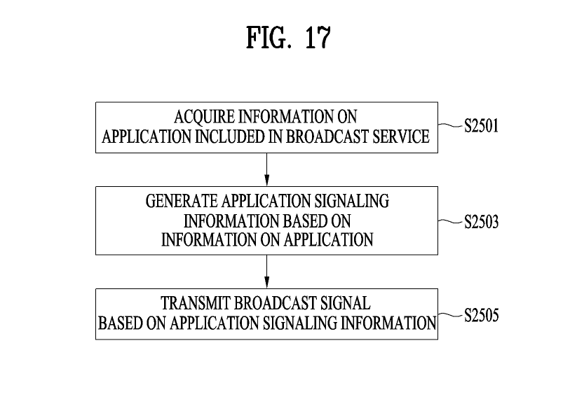

FIG. 17 illustrates transmission of a broadcast signal based on application signaling information by a broadcast transmission device according to embodiments of the present invention.

The broadcast transmission device 10 may acquire information on an application included in a broadcast service (S2501). In detail, the broadcast server 10 may acquire information on the application included in the broadcast service through a controller.

The broadcast transmission device 10 may generate application signaling information based on information on the application (S2503). In detail, the broadcast transmission device 10 may generate the application signaling information based on information on the application through the controller. In this case, the application signaling information may include a trigger for triggering an action of an application and triggering application information for signaling information on the triggered application, as described above.

The broadcast transmission device 10 may transmit a broadcast signal based on the application signaling information (S2505). In detail, the broadcast transmission device 10 may transmit a broadcast signal based on the application signaling information through a transmitter. In detail, as described above, the broadcast transmission device 10 may transmit application signaling information using an MPEG-DASH protocol. In detail, the broadcast transmission device 10 may transmit application signaling information in an event stream of MPD of MPEG-DASH. The broadcast transmission device 10 may transmit the application signaling information in an inband event stream. For example, the broadcast transmission device 10 may transmit the application signaling information through an event message box. In another detailed embodiment, the broadcast transmission device 10 may transmit application signaling information using an MMT protocol. In detail, the broadcast transmission device 10 may transmit the application signaling message based on packet format including the MPU of the MMT protocol. The broadcast transmission device 10 may transmit the application signaling message based on packet format including a generic object of the MMT protocol. The broadcast transmission device 10 may transmit the application signaling message based on packet format including the signaling message of the MMT protocol. The broadcast transmission device 10 may transmit the application signaling message based on the header extension information of the packet of the MMT protocol.

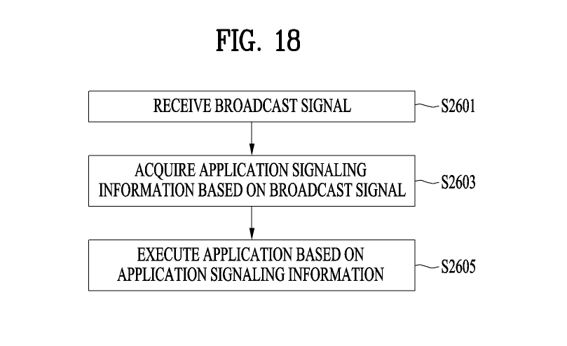

FIG. 18 illustrates acquisition of application signaling information based on a broadcast signal by a broadcast reception device according to embodiments of the present invention.

The broadcast reception device 100 may receive a broadcast signal (S2601). In detail, the broadcast reception device 100 may receive a broadcast signal through the broadcast receiver 110.

The broadcast reception device 100 may acquire application signaling information based on the broadcast signal (S2603). In detail, the broadcast reception device 100 may acquire the application signaling information based on the broadcast signal through the controller 150. In detail, as described above, the broadcast reception device 100 may acquire the application signaling information based on the MPEG-DASH protocol. In detail, the broadcast reception device 100 may acquire the application signaling information based on an event stream of MPD of MPEG-DASH. The broadcast reception device 100 may acquire application signaling information based on the inband event stream. For example, the broadcast reception device 100 may transmit application signaling information from an event message box. In another detailed embodiment, the broadcast reception device 100 may acquire application signaling information based on the MMT protocol. In detail, the broadcast reception device 100 may acquire the application signaling message based on packet format including the MPU of the MMT protocol. The broadcast reception device 100 may acquire the application signaling message based on packet format including a generic object of the MMT protocol. The broadcast reception device 100 may acquire an application signaling message based on packet format including the signaling message of the MMT protocol. The broadcast reception device 100 may acquire the application signaling message based on the header extension information of the packet of the MMT protocol. The application signaling information may include at least one of a trigger for triggering an action of an application and triggering application information for signaling information on the triggered application, as described above.

The broadcast reception device 100 may execute an application based on the application signaling information (S2605). In detail, the broadcast reception device 100 may execute the application based on the application signaling information through a controller. In a detailed embodiment, the broadcast reception device 100 may change a state of an application based on the application signaling information. In detail, the broadcast reception device 100 may change a state of the application based on the application signaling information of the triggering event start time. The broadcast reception device 100 may change the state of the application based on the application signaling information prior to triggering event termination time after triggering event start time. In another detailed embodiment, the broadcast reception device 100 may perform an operation triggered to an application based on the application signaling information. In detail, the broadcast reception device 100 may perform an operation triggered to an application based on the application signaling information of the triggering event start time. The broadcast reception device 100 may perform an operation triggered to an application based on the application signaling information prior to triggering event termination time after triggering event start time. In another detailed embodiment, the broadcast reception device 100 may receive triggering application information based on the application signaling information. In another detailed embodiment, the broadcast reception device 100 may acquire media time of content based on the application signaling information. In detail, the broadcast reception device 100 may acquire media time of presented content. The broadcast reception device 100 may acquire media time and generate a time line as a reference of synchronization between triggering event and content based on the media time of content.

Through this operating method, the broadcast transmission device 10 may effectively transmit the application signaling information. In particular, the broadcast transmission device 10 may transmit the application signaling information through the MPEG-DASH protocol or the MMT protocol. The broadcast reception device 100 may effectively receive the application signaling information. In particular, the broadcast server 10 may transmit the application signaling information through the MPEG-DASH protocol or the MMT protocol.

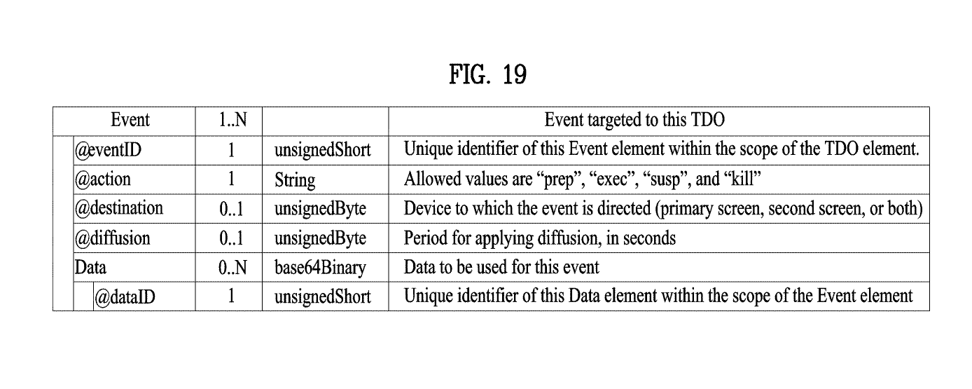

FIG. 19 is a diagram illustrating event information according to an embodiment of the present invention.

According to an embodiment of the present invention, the first receiver may receive signaling information through a broadcast network and/or the Internet. In detail, the first receiver may receive application signaling information including a trigger and/or triggering application information (e.g., TPT). The first receiver may store event information included in the triggering application information in a storage (or primary device storage) included in the first receiver.

According to an embodiment of the present invention, the first receiver may transmit the signaling information to the second receiver. In detail, the first receiver may transmit the application signaling information to the second receiver (e.g. companion device).

For example, the signaling information may include application signaling information. The application signaling information may include at least one of a trigger for triggering an operation of an application and triggering application information for signaling information on a triggered application.

The trigger may include at least one of a trigger for signaling a state (or life cycle) of an application, a trigger for signaling an operation of an application, and/or a trigger for signaling media time. The state of the application may include at least one of preparing, execution, termination, and/or suspending.

The triggering application information may include additional information required to execute an application.

According to an embodiment of the present invention, the triggering application information may include application information (TDO). The application information may include event information indicating information on an event of an application. In a detailed embodiment, the event information may be referred to as event.

The event information may include an event identifier for identifying an event. In detail, the event identifier may uniquely identify an event in a corresponding application range. In a detailed embodiment, the event identifier may be referred to as eventID. In a detailed embodiment, the event identifier may be a 16-bit element.

The event information may include action information indicating an operation of an event. In detail, the event information may include preparing, execution, termination or kill, and/or suspending. In a detailed embodiment, the action information may be referred to as action.

The event information may include destination information indicating target information targeted by an application. The destination information may indicate that an application is used for only the first receiver (or primary device) for receiving a broadcast signal. The destination information may indicate that an application is used for only one or more second receivers (or companion device) that are operatively associated with the first receiver (or primary device) for receiving a broadcast signal. The destination information may indicate that an application is used for both the first receiver and the second receiver. In a detailed embodiment, the destination information may be referred to as destination.

The event information may include diffusion information for diffusing a triggering application information request, in detail, the first receiver may calculate a random value based on the diffusion information, may be on standby by as much as the random value and, then may make a request for triggering application information to a server. In detail, the receiver may be on standby by as much as a value obtained by multiplying the random value by 10 ms and then may make a request for the triggering application information to the server. In a detailed embodiment, the diffusion information may be referred to as diffusion. In a detailed embodiment, the diffusion information may be an 8-bit element.

The event information may include data information indicating data associated with an event. Each event may have a data element associated with an event. In a detailed embodiment, the data information may be referred to as data.

The data information may include a data identifier for identifying data. The data identifier may be referred to as dataID. The data identifier may be a 16-bit element.

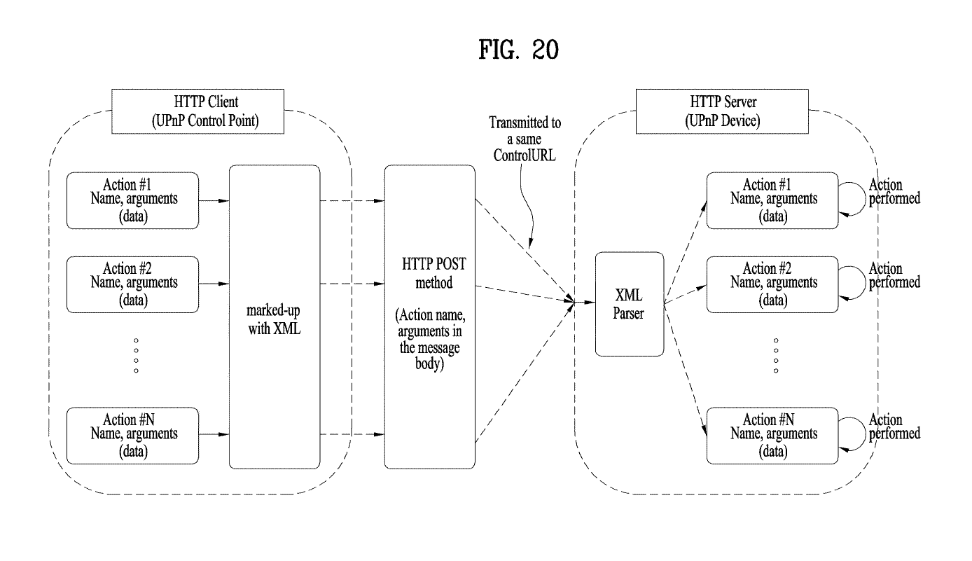

FIG. 20 is a diagram illustrating UPnP Action Mechanism according to an embodiment of the present invention.

Referring to the drawing, one method of communication between devices applied to an embodiment of the present invention may be a communication protocol between devices, obtained by combining protocols of IP-TCP/UDP-HTTP among technology of various layers.

According to an embodiment of the present invention, the technology of layer will be described.

First, according to an embodiment of the present invention, communication between devices may be represented to exchange message, command, call, action, and/or request/response.

Second, according to an embodiment of the present invention, in order to stably transmit a message used during communication between devices to a desired target device, various protocols such as an Internet control message protocol (ICMP) and an Internet group management protocol (IGMP) as well as an Internet protocol (IP) may be applied and may not be limited to a specific protocol.

Third, according to an embodiment of the present invention, in order to stably transmit a message used during communication between devices, to control a message flow, to overcome collision or congestion between a plurality of messages, and to support multiplexing, various protocols such as a datagram congestion control protocol (DCCP) and a stream control transmission protocol (SCTP) as well as a transmission control protocol (TCP) and a user datagram protocol (UDP) and may not be limited to a specific protocol.

Fourth, according to an embodiment of the present invention, in order to transmit various information items in a message used during communication between devices for various purposes, various protocols such as a hypertext transfer protocol (HTTP), a real-time transport protocol (RTP), an extensible messaging and presence protocol (XMPP), and a file transfer protocol (FTP) may be applied and may not be limited to a specific protocol.

Fifth, according to an embodiment of the present invention, when a message used during communication between devices is transmitted through the aforementioned various protocols, desired message data may be transmitted in various message component such as a message header and a message body among message components defined in each protocol and a specific message component may not be limited.

Sixth, according to an embodiment of the present invention, when a message used during communication between devices is transmitted, data to be transmitted may be transmitted using various types (string, integer, floating point, boolean, character, array, list, etc.) defined in each protocol. In order to more structurally represent, transmit, and store data with complex information, a markup method such as extensible markup language (XML), hypertext markup language (HTML), extensible hypertext markup language (XHTML), and javascript object notation (JSON) or text, image format, etc. and a specific method may not be limited.

Seventh, according to an embodiment of the present invention, data included in a message used during communication between devices may be transmitted using various data compression technologies such as “gzip” (RFC 1952), “deflate” (RFC 1950), and “compress” (RFC 2616) and a specific method may not be limited.

UPnP action proposed according to an embodiment of the present invention may be one of various methods of communication between devices and data to be actually transmitted may be transmitted in XML format in an HTTP POST message body using a POST method defined in the HTTP to a control URL acquired during UPnP discovery and description. In the case of a UPnP protocol, an action name is defined and used for each action and is transmitted together with the HTTP POST message body transmitted in XML and, thus, only one URL may be present with respect to a communication target device and an infinite type of action (message) may be exchanged even if only one HTTP POST method is used.

All UPnP actions proposed according to an embodiment of the present invention may be applied via various types of combinations of the aforementioned various technologies of layer and all contents proposed by an embodiment of the present invention may not be limited to the UPnP method.

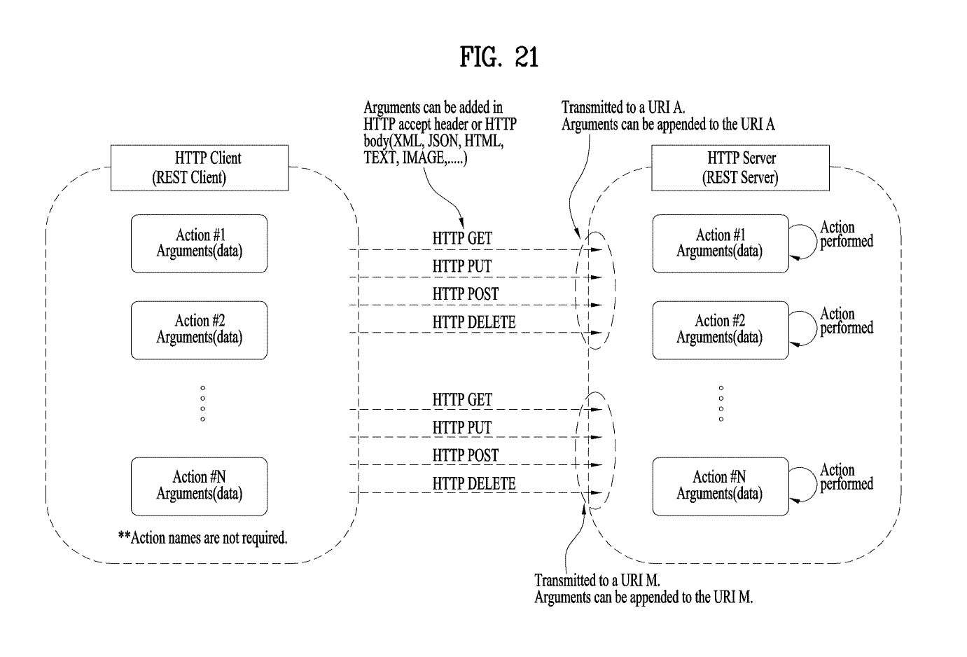

FIG. 21 is a diagram illustrating a REST mechanism according to an embodiment of the present invention.

Referring to the drawing, a REST method as one method of communication between devices applied to an embodiment of the present invention may define a plurality of URIs to be accessed to a communication target device.

For example, when various methods GET, HEAD, PUT, DELETE, TRACE, OPTIONS, CONNECT, and PATCH as well as POST among HTTP methods are used and a plurality of URIs to be accessed to a communication target device are defined, communication between devices proposed by an embodiment of the present invention may be applied without definition of an action name. Data to be transmitted may be appended to a corresponding URL or may be transmitted and transmitted in an HTTP body in various forms. A plurality of URI values required in the REST method may be acquired during a discovery or description procedure.

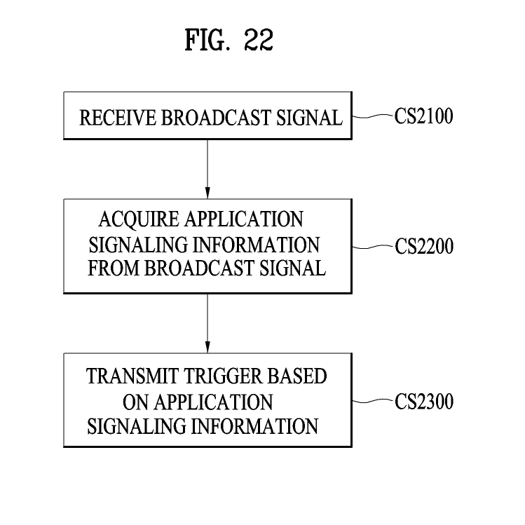

FIG. 22 is a flowchart illustrating an operation of a broadcast reception device according to an embodiment of the present invention.

A transceiving system according to an embodiment of the present invention may include at least one of a transmitter, a broadcast reception device (or first receiver), and/or a second screen device (or second receiver). A description of the transceiving system according to an embodiment of the present invention may include the entire above description of the aforementioned transceiving system. Hereinafter, an operation of the broadcast reception device will be described.

The broadcast reception device may receive a broadcast signal using a broadcast receiver (CS2100). For example, the broadcast reception device may receive the broadcast signal using the broadcast receiver and/or the IP transceiver.

The broadcast reception device may acquire application signaling information for signaling an application included in the broadcast server from the broadcast signal using a controller (CS2200). For example, the broadcast reception device may acquire signaling information from the broadcast signal using the controller and acquire application signaling information from the signaling information.

The broadcast reception device may acquire application signaling information based on an MPEG-DASH protocol and/or an MMT protocol.

The application signaling information may include at least one of a trigger, trigger position information, and triggering application information. The trigger may trigger an operation of an application. For example, the trigger may perform a timing related signaling operation for supporting an interactive service. The trigger position information may indicate a position of the trigger. The triggering application information may signal information on the triggered application. For example, the triggering application information may include an application and metadata about an event targeted to the application.

The broadcast reception device may transmit the trigger to the second screen device based on the application signaling information using the app transceiver (CS2300).

The broadcast reception device may transmit trigger transmission information for transmitting the trigger to the second screen device using the app transceiver.

The trigger transmission information may include at least one of trigger information indicating attribute for a trigger, trigger list information including at least one trigger information item, trigger position information indicating a position of a trigger, and application identifier list information indicating a list of an application identifier.

The trigger information may include at least one of an application identifier for identifying an application, trigger type information indicating a type of a trigger, action information indicating an operation of an application, event start time information indicating start time of a trigger, event termination time information indicating termination time of a trigger, data information including data related to a trigger, and/or data position information indicating data related to a trigger.

The broadcast reception device may further transmit application notification information including information on application notification for the second screen device using the app transceiver.

The application notification information may include at least one of targetDevice attribute indicating a device on which application notification is displayed, topMargin attribute indicating top margin of application notification, rightMargin attribute indicating right margin of application notification, show attribute indicating time at which application notification is first displayed, lasting attribute indicating lasting time at which application notification is displayed, interval attribute indicating an interval time between application notifications, a message element indicating a notification message of application notification, and/or a logo element indicating a logo image of application notification.

The broadcast reception device may transmit the signaling information, the application signaling information, the trigger transmission information, and/or the application notification information to a second screen device based on an event and/or in response to a request of the second screen device. The broadcast reception device transmits data based on the event and in response to the second screen device, as described above.

Hereinafter, operations of a PD (or broadcast reception device) and a CD (companion screen device) will be described.

A first function may use a PD in order to stream continuous components that are some of services that are currently selected by the PD for simultaneous presentation by a CD. Components may be the same as components presented by a PD. Alternatively, the components may be general components that are not currently presented by a PD.

A second function may use a PD in order to deliver data or files that are some of services that are currently selected by the PD to a CD. The data may contain a place or method of accessing content from sources other than the PD. For example, the data may include a URL of a remote server. The CD may make a request for a single particular file or a data package. Alternatively, the CD may make a request for “subscription” of a series of particular files or data.

A third function may use a PD for delivering media timeline information on a service that is currently selected by the PD in order for a CD to synchronize content presented in the CD along with content presented in the PD.

A fourth function may use a CD application that cooperates with a PD application. The PD application may be an enhancement application that is a portion of a scheduled linear service. Alternatively, the PD application may be an application that is a portion of an app-based service or an unscheduled service.

A fifth function may be EAM delivery. That is, the fifth function uses a PD in order to deliver emergency alert messages to a CD. This is particularly important when a CD displays continuous contents. This is because a user (or viewer) may not concentrate on the PD and may not be in the same room as the PD when emergency alert occurs.

Along with a PD that functions as a server, an appropriate paradigm for supporting a CD is expected to be a client-server paradigm. That is, the PD may support certain CD support operations. This may also be applied to the CD. Each interaction may be initiated according to a request to a server (or PD) from a client (or CD) in order to apply a particular operation. Two-way communications may be initiated according to a request to a server (or PD) from a client (or CD) in order to set up communications. Asynchronous notifications to a CD from a PD may be initiated according to a request of a client (or CD) that makes a request for subscription of a stream of notifications to a server (or PD). All messages described below may be unicast unless the context clearly indicates otherwise.

A security mechanism may be required to authenticate CD application requests.

In several operations, a CD may receive a URL in order to retrieve content in a remote server. In this case, in order for the remote server to transmit an appropriate version of requested content to a particular CD, the CD may provide information on the remote server to the remote server. For example, to this end, ATSC 2.0 clearly describes “User Agent” based on HbbTV specifications (Per TS 102 796 Section 7.3.2.4, except replace “HbbTV/1.2.1” with “ATSC-ISS/1.0”).

Hereinafter, device discovery will be described.

Both a PD application and a CD application may transmit multicast discovery messages for searching and/or advertising presence of the PD application and the CD application and ATSC 3.0 service supporting.

One household may have one or more PDs on a home network and, accordingly, a CD application may receive display messages from a plurality of PDs. In this case, the CD application may ask a user a question about PD(s) that interacts with the user.

The CD application may multicast a CD application search request message for searching the PD. For example, when the CD participates in a network or the CD application is initiated, when discovery scan in the CD application is initiated (e.g., when a user wants to access a new or another TV receiver and new scan is initiated), when the CD transmits a multicast request for a device type/service type of the PD, and/or dependently upon execution and periodically, the CD application may multicast a CD app search request message for searching the PD. For example, parameters may include at least one of a device and/or service type CD app is looking for (in order to avoid a response from a DVD player. etc.).

The PD may multicast a PD advertisement message and unicast a search response message. For example, when the PD participates in a network/LAN (advertisement-multicast), when a list of CD supporting operations provided by the PD is changed (advertisement-multicast), dependently upon execution and periodically. (advertisement-multicast), and/or when a multicast search request is received from the CD (search response-unicast), the PD may multicast a PD advertisement message and unicast a search response message. For example, parameters may include at least one of a PD device ID, a PD device type (ATSC 3.0 TV set) and (ATSC 3.0 support) version, a user-friendly name of a PD (e.g., living room TV), supported CD supporting operations, and/or other parameters.

The CD may multicast a CD advertisement message and unicast a search response message. For example, when the CD participates in a network (or when a CD application is initiated) (advertisement-multicast), when a list of CD supporting operations provided by the PD is changed (advertisement-multicast), dependently upon execution and periodically, and/or when a (multicast) search request for a device/service type of the CD is received from the PD (unicast search message response from the CD), the CD may multicast a CD advertisement message and unicast a search response message. For example, parameters may include at least one of a CD device ID, a CD application ID, a CD application version, a name of a CD readable by the human, supported CD services (service types), and/or other parameters.

The PD may multicast a PD search request message for searching the CD. For example, when the PD is initiated/the PD participates in a network, when discovery scan in the PD is initiated (e.g., when a user wants to access a new or another CD and new scan is initiated), whenever the PD transmits a multicast request for a device type/service type of the CD, and/or dependently upon execution and periodically, the PD may multicast a PD search request message for searching the CD. For example, message parameters may include at least one of a retrieved CD device type and/or CD service type. Optionally, message parameters may include PD information (e.g., a PD device ID, a PD application ID, and a PD application version).

Hereinafter, subscription to content identification will be described.

Several CD applications (e.g., “American Idol” companion application) may be designed for only one show. In addition, several CD applications (e.g., WBZ Channel 4 companion application) may be designed for only one service. On the other hand, other CD applications may be designed to be operated with respect to a plurality of services and/or a plurality of shows. In addition, a CD application (e.g., Ford truck application) may be designed to accompany interstitials. Accordingly, the CD application may need to know a service that is currently selected by a PD and need to trace service changes (e.g., channel changes). In a certain case, the CD application may need to know a show or to even know a segment that is currently presented and need to trace changes thereof.

The CD may transmit a content identification subscription request. For example, a time may not be clearly indicated (that is, this may be determined according to an application designer). For example, parameters may include at least one of subscription callback URL/information, and/or requested subscription duration. Optionally, parameters may include a CD device ID, a CD application ID, a CD application version, and so on.

The PD may transmit content identification subscription response. For example, as soon as a subscription request is received (initial response), and/or whenever content is changed (subsequent responses) (i.e., whenever a service, a show, or a segment is changed), the PD may transmit content identification subscription response. For example, parameters may include at least one of a PD device ID, a subscription ID, and/or confirmed subscription duration.

The CD may transmit a content identification subscription renew/cancel request. For example, prior to subscription timeout for renewing subscription and/or at any time for canceling subscription, the CD may transmit a content identification subscription renew/cancel request. For example, parameters may include at least one of subscription ID, and/or requested subscription duration to renew subscription. Optionally, parameters may include CD information (CD device ID), a CD application ID, a CD application version, and so on.

The PD may transmit content identification subscription renew/cancel response. For example, as soon as receiving a subscription renew/cancel request, the PD may transmit the content identification subscription renew/cancel response. For example, parameters may include at least one of a subscription ID, and/or confirmed subscription duration for subscription renewal.

The PD may transmit a content identification message. For example, as soon as a subscription request is received, and/or when identification of current content or related information is changed, the PD may transmit a content identification message. For example, parameters may include at least one of a service ID, a show ID, and/or a segment ID. In addition, the parameters may include a current temporal location within the given show and/or segment. Each service, show, and/or segment may include available information, available continuous components, and/or available files and data. With respect to the available information, parameters may include at least one of a textual name, description, logo, and/or other ESG info (rating, etc.). With respect to each component of the available continuous components, parameters may include at least one of a component ID, a component type, a component name, component description, component attributes (e.g., bit rate, aspect ratio, device capabilities required/desired, etc.), a component filtering criterion (e.g., targeted to certain demographic profiles), and/or a location of each component (e.g., URLs or IP address, port, and protocol) (the location may indicate a stream from the PD or a stream directly from the Internet). With respect to the each file or data element of the available files or data, parameters may include at least one of a file ID/data ID, a file type/data type, a file name/data name, file description/data description, file attributes/data attributes (e.g., size, codec, device capabilities require/desired, etc.), available as subscription or one-off or both, a component filtering criterion (e.g., component filtering criterion targeted to certain demographic profiles), and/or a location for assessing data and/or files (e.g., a location for assessing data and/or files from the PD, a location for assessing data and/or files from a remote server from a certain URL, etc.).

The CD may transmit response to the content identification message. For example, upon receiving the content identification message from the PD, the CD may transmit response to the content identification message. For example, parameters may include a CD device ID or a CD application ID.

Hereinafter, a ESG-type information request for the current service or show will be described.

According to the information, the CD may make a request for information on content in a TV. For example, the information may include information contained in ESG such as a textual name, description, a logo, and rating. According to the information, the CD application may display information readable by the human to a user. For example, the CD application may display “You are watching [Show] starring [actor].”.

The CD may transmit a service/show information request. For example, a time may not be clearly indicated. That is, according to decision of an application designer, the CD may transmit a service/show information request. For example, parameters may include CD information (e.g., CD device ID, CD application ID, CD application version, etc.).

The PD may transmit service/show information response. For example, as soon as receiving a CD request, the PD may transmit service/show information response. For example, parameters may include at least one of a service ID and show ID, and/or service ESG information and show ESG information. Optionally, a parameter may include PD information (e.g., PD device ID, etc.).

Hereinafter, a request for current information about a current service, show or segment without subscription will be described.

In addition to subscription based approach and a follow-on request, the CD may directly obtain information on a service/show/segment that is currently presented by the PD using communication of a single transaction request-response style directed to the PD from the CD as follows without first subscription of service identification.

The CD may transmit a CD request to PD to receive current service information. For example, whenever a CD request is needed by an application, the CD may transmit the CD request to PD to receive current service information. For example, parameters may include at least one of information for making a request for current show ESG information, information for making a request for current available components of a current show, information for making a request for a current timeline location in a current show, information for making a request for current available files of a current show or non real-time content, and/or information for making a request for a filtering criterion (e.g., component attributes). Optionally, parameters may include CD information (CD device ID. CD application ID, a CD application version, etc.).

The PD may transmit PD current service information response. For example, as soon as receiving a current service information request, the PD may transmit PD current service information response. For example, parameters may include current show ESG information, information about current available components for the current show, a current timeline location with the current show, information about current available files or non real-time content for the current show, and/or a filtering criterion. Optionally, parameters may include PD information (e.g., PD device ID emd).

Hereinafter, a request for a continuous component from a PD will be described.

When PD service information response includes an access location and availability of continuous components streaming from the PD, the CD may request reception of the stream (Continuous components are available from a remote server through a broadband (or the Internet) but a detailed description thereof will be omitted.).

The CD may transmit a continuous component request. For example, a time may not be clearly indicated. That is, according to an application designer, the CD may transmit a continuous component request. For example, parameters may include a component ID. Optionally, parameters may include CD information (CD device ID), CD application ID, a CD application version, and so on.

The PD may transmit continuous component request response. For example, as soon as receiving a valid CD application request, the PD may transmit the continuous component request response. For example, parameters may include a component ID, and/or an access location of a component. Optionally, parameters may include PD information (e.g., PD device ID, etc.).

After obtaining the access location (e.g., URL) of a component, the CD may pull content using a HTTP GET method without clearly indicating new content. In addition, a stream is not “pushed” by the PD and is “pulled” by the CD (i.e., streaming is controlled by the CD) and, thus, it may not be necessary to define message protocols (e.g., “Start” or “End”) between the PD and the CD in order to control a stream.

Hereinafter, a request for a data/file from a PD will be described.

When PD service information response includes availability of data or file components accessible from the PD, the CD may request reception of component(s) (data/file components are available from a remote server through a broadband but a detailed description thereof will be omitted.).

The CD may transmit a data/file request. For example, a time may not be clearly indicated. That is, according to decision of an application designer, the CD may transmit the data/file request. For example, a time may not be clearly indicated. For example, parameters may include data/file ID(s) for item(s) to be received by the CD application. When subscription is optional, whether subscription is appropriate may be clearly indicated. When subscription is appropriate, start or stop for receiving subscription may be clearly indicated. Optionally, parameters may include CD information (CD device ID, CD application ID, CD application version, etc.).

The PD may transmit data/file request response. For example, as soon as receiving a CD application request, the PD may transmit data/file request response. In addition, when there is a subscription request, the PD may transmit supplementary data/files according to notifications present in a broadcast stream. For example, parameters may include at least one of an access location of the data/file and/or data/file ID(s) of requested item(s). Optionally, parameters may include PD information (e.g., PD device ID, etc.).

Hereinafter, a request for media timeline checkpoints will be described.

When the CD accesses supplementary content directly from the PD or through another source (e.g., remote server), the CD may require on-going media timeline information from the PD in order to maintain sync between content displayed by the CD and content displayed by the PD.

Subscription based approach as well as single request response approach may be supported in order to receive timeline checkpoints from the PD. The CD has an accurate internal clock and, thus, request response architecture may permit polling of a timeline in an appropriate interval by the CD in order to maintain synchronization with the PD.

Hereinafter, the subscription based approach will be described.

The CD may transmit a media timeline checkpoints subscription request. For example, a time may not be clearly indicated. That is, according to decision of an application designer, the CD may transmit the media timeline checkpoints subscription request. For example, parameters may include a service/show/segment ID of interest. In addition, parameters may include a notification frequency. The notification frequency may be a requested frequency that does not exceed a clearly indicated maximum frequency and may be a requested frequency (e.g., frequency that does not exceed every two seconds) for receiving temporal updates. When the notification frequency is not clearly indicated, a receiver may determine a frequency. In addition, the receiver may set a default value to be determined. Parameters may include at least one of subscription callback URL/information, and/or requested subscription duration. Optionally, parameters may include CD information (CD device ID, CD application ID, CD application version, etc.).

The PD may transmit media timeline checkpoints subscription response. For example, when a request is received from a CD application (initial response), and/or according to a confirmed notification frequency (subsequent responses), the PD may transmit media timeline checkpoints subscription response. For example, parameters may include at least one of a PD device ID, a service/show/segment ID of interest, a subscription ID, confirmed subscription duration, and/or a confirmed notification frequency.

The CD may transmit a media timeline checkpoints subscription renew/cancel request. For example, prior to subscription timeout for renewing subscription and/or at any time for canceling subscription, the CD may transmit a media timeline checkpoints subscription renew/cancel request. For example, parameters may include requested subscription duration in order to renew a subscription ID and/or subscription. Optionally, parameters may include CD information (CD device ID, CD application ID, CD application version, etc.).

The PD may transmit media timeline checkpoints subscription renew/cancel response. For example, as soon as receiving a subscription renew/cancel request, the PD may transmit media timeline checkpoints subscription renew/cancel response. For example, parameters may include at least one of a subscription ID, and/or confirmed subscription duration for subscription renew request.

Hereinafter, media playback state information communication will be described.

An operation for transmitting a media playback state to the CD by the PD may be supported. This may be useful to playback a media stream when the CD synchronizes with the PD.

The CD may transmit the CD subscription request to the PD to receive current media playback state information. For example, whenever a CD subscription request is needed by an application, the CD may transmit the CD subscription request to the PD to receive current media playback state information. For example, parameters may include a URL/ID for which media playback state is requested, media state subscription callback URL/information, and/or requested subscription duration. Optionally, parameters may include CD information (CD device ID, CD application ID. CD application version, etc.).

The PD may transmit PD media callback state subscription response. For example, as soon as receiving a current media playback state subscription information request, the PD may transmit the PD media callback state subscription response. For example, parameters may include at least one of a PD device ID, a media playback state subscription ID, and/or confirmed subscription duration.

The PD may transmit a media playback state PD notification to the CD. For example, when a media playback state is changed in the PD or periodically, the PD may transmit the media playback state PD notification to the CD. For example, notification parameters may include current media playback state information on a requested URL/ID. For example, the state may include at least one of playing, paused, stopped, fast forward; speed of fast forward, fast backward; speed of fast backward, and buffering.

Hereinafter, PD application to CD application communication will be described.

In some cases, the PD application and the CD application may be designed to operate in tandem. In this case, an application designer may be expected to determine detailed content of app-to-app communication. PD applications and CD applications may include information on a user of the other applications and include methods of downloading and launching the other applications. Even if the CD application is not currently launched, the CD application may include a mechanism that always “listens carefully” to an announcement message from a PD application. ATSC may not be expected to clearly indicate standards for this operation (HbbTV 2.0 provides some specifications for required operations.).

Hereinafter, transmission of an emergency alert message from a PD to a CD will be described.

Subscription based delivery of the emergency alert message (EAM) to the CD from the PD may be supported via the following message exchange.

The CD may transmit a CD subscription request to the PD to receive the EAM. For example, when the CD participates in a network to activate an EAM function (or when the CD application is launched), the CD may transmit a CD subscription request to the PD to receive EAMs. For example, parameters may include at least one of subscription callback URL/information and/or requested subscription duration. Optionally, parameters may include at least one of EAM filtering criterion (e.g., geo-location) and/or CD information (CD device ID, CD application ID, CD application version, etc.).

The PD may transmit PD EAM subscription response. For example, as soon as receiving a subscription request, the PD may transmit PD EAM subscription response. For example, parameters may include at least one of a PD device ID, a subscription ID, and/or confirmed subscription duration.

The CD may transmit a CD EAM subscription renew/cancel request. For example, before subscription timeout to renew subscription and/or when subscription is canceled, the CD may transmit a CD EAM subscription renew/cancel request. For example, parameters may include a subscription ID and/or requested subscription duration to renew subscription. Optionally, parameters may include CD information (CD device ID, CD application ID, CD application version, etc.).

The PD may transmit PD EAM subscription renew/cancel response. For example, as soon as receiving a subscription renew/cancel request, the PD may transmit PD EAM subscription renew/cancel response. For example, parameters may include at least one of a subscription ID, and/or confirmed subscription duration for a subscription renewal request.

The PD may transmit a PD Notification of EAM. For example, as soon as receiving the emergency alert message, the PD may transmit a PD notification of EAM. For example, parameters may include a subscription ID, initial contents of the EAM, characteristics of initial contents of the EAM) (e.g., new message, continual or one-time message, includes rich media as well as text), and/or additional available content.

The CD may transmit CD response to the EAM. For example, upon receiving the emergency alert message from the PD, the CD may transmit CD response to the EAM. For example, parameters may include at least one of a CD device ID and/or a CD application ID. Optionally, parameters may include a request for supplementary content.

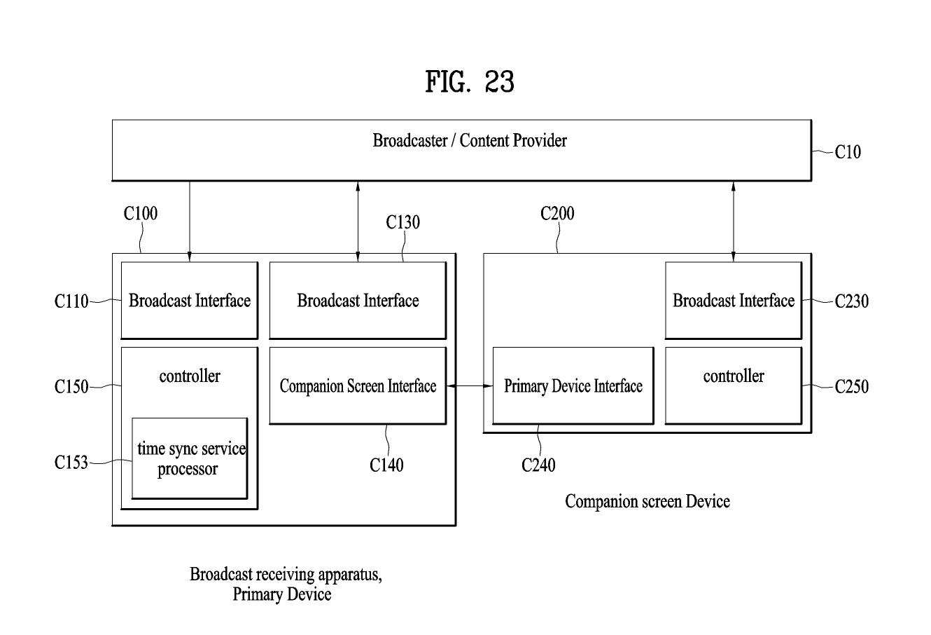

FIG. 23 is a diagram illustrating a broadcast system for delivery of time information according to an embodiment of the present invention.

The broadcast system according to an embodiment of the present invention may include at least one of the broadcaster/content provider C10, the broadcast reception device C100, and/or the companion screen device C200. The broadcaster/content provider C10 may provide a broadcast service. The broadcaster/content provider C10 may include at least one of the aforementioned broadcast transmission device (not shown), a content provider (not shown), a content server (not shown), a controller (not shown), and/or a transmitter (not shown). In addition, the broadcaster/content provider C10 may be represented by a transmitter. The broadcast reception device C100 may receive a broadcast service through a broadcast network and/or the Internet. The broadcast reception device C100 may be represented by a receiver, a first receiver, a first screen device, a master device (MD), and/or a primary device (PD). The broadcast reception device C100 may include at least one of a broadcast interface (or broadcast receiver) C110, the broadband interface (or IP transceiver) C130, the companion screen interface (or app transceiver) C140, a decoder (not shown), a display (not shown), and/or the controller C150. The companion screen device C200 may receive a broadcast service through the Internet. The companion screen device C200 may be represented by a second broadcast reception device, a second receiver, a second screen device, a slave device (SD), and/or a companion device (CD). The companion screen device C200 may include at least one of the broadband interface (or IP transceiver) C230, the primary device interface (or app transceiver) C240, a decoder (not shown), a display (not shown), and/or the controller C250. A detailed description of the broadcaster/content provider C10, the broadcast reception device C100, and/or the companion screen device C200 may include the entire above description.

The controller C150 of the broadcast reception device C100 according to an embodiment of the present invention may operate the broadcast interface C110 and the companion screen interface C140.

The controller C150 may include an application signaling service processor (not shown) for delivery of signaling information (e.g., application signaling information, trigger) to the companion screen device C200 from the broadcast reception device C100. A detailed description of the application signaling service processor is the same as the above description.

The companion screen device C200 needs to maintain time synchronization between the broadcast reception device C100 and the companion screen device C200 in order to provide a service in association with the broadcast reception device C100. The broadcast system according to an embodiment of the present invention may receive signaling information including media time information of A/V content using the broadcast reception device C100, generate service time information for providing data related to synchronization between A/V content displayed by a broadcast reception device and A/V content displayed by the companion screen device C200 based on the signaling information, and transmit the service time information to the companion screen device C200.

To this end, the controller C150 of the broadcast reception device C100 according to an embodiment of the present invention may further include a time synchronization service processor C153 for generating service time information for providing data related to time synchronization between A/V content displayed by a broadcast reception device and A/V content displayed by a companion screen device based on signaling information.

The time synchronization service may refer to a service for generating service time information for time synchronization of the broadcast reception device C100 and the companion screen device C200 and transmitting the service time information to the companion screen device C200 from the broadcast reception device C100. The service time information may be information related to synchronization between A/V content displayed by the broadcast reception device C100 and A/V content displayed by the companion screen device C200. The service time information for providing time synchronization to the companion screen device C200 by the broadcast reception device C100 may include at least one of media time information (e.g., media time) of a served (e.g., linear service) program and/or current time information (e.g., wall clock).

That is, a processor that is in charge of generation of the service time information and/or transmission of service time information to the companion screen device C200 from the broadcast reception device C100 may also be referred to as the time sync service processor C153. The time synchronization service processor C153 may transmit at least one of media time information and/or current time information (wall clock information) to the companion screen device C200 for time synchronization of media, an interactive application, and so on to the companion screen device C200 by the broadcast reception device C100. According to an embodiment of the present invention, Service Type may be defined according to urn:atsc.org:serviceId:atsc3.0:timesync.

For example, the broadcast reception device C100 may receive signaling information. The broadcast reception device C100 may receive signaling information through a broadcast network. The signaling information may include application signaling. The application signaling information may include a trigger and/or triggering application information. In addition, the signaling information may include media time information of presented A/V content.

The broadcast reception device C100 according to an embodiment of the present invention may generate service time information for time synchronization between the broadcast reception device C100 and the companion screen device C200 based on the signaling information using the time synchronization service processor C153 of the controller C150. Then, the broadcast reception device C100 may transmit the service time information to the companion screen device C200 using the companion screen interface C140.

In detail, the broadcast reception device C100 may generate update interval information indicating an interval for delivery of the service time information using the time synchronization service processor C153. The broadcast reception device C100 may transmit the service time information to the companion screen device C200 based on the update interval information using the companion screen interface C140.

The interval may be a concept including duration and frequency. Hereinafter, the duration will be first described and the frequency will be described.

Hereinafter, a method of receiving signaling information including media time information of A/V content through a broadcast network, generating service time information based on the signaling information, and transmitting the service time information to the companion screen device C200 by the broadcast reception device C100 will be described. For example, the broadcast reception device C100 may execute an event (or triggering event) (eventing method) to transmit service time information for time synchronization to the companion screen device C200. The broadcast reception device C100 may transmit service time information for time synchronization to the companion screen device C200 in response to a request of the companion screen device C200 (requesting method).

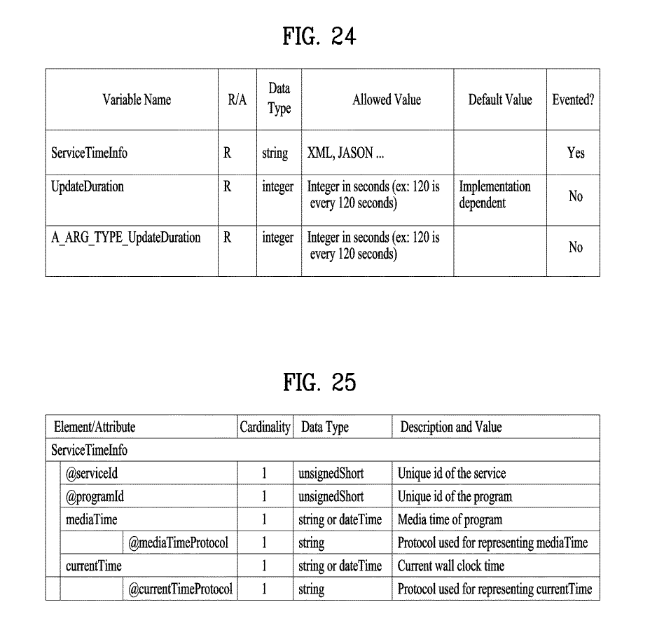

FIG. 24 is a diagram illustrating state variables for delivery of service time information according to an embodiment of the present invention.

The drawing illustrates state variables for delivery of the service time information. The state variables for delivery of the service time information may include at least one of a ServiceTimeInfo state variable including the service time information, an UpdateDuration state variable including delivery duration information, and/or an A_ARG_TYPE_UpdateDuration state variable including requested delivery duration information. The ServiceTimeInfo state variable, the UpdateDuration state variable, and/or the A_ARG_TYPE_UpdateDuration state variable may be a required state variable. The ServiceTimeInfo state variable may include media time and current time, i.e., wall-clock time information of a program that is presented or served by a broadcast reception device. The UpdateDuration state variable may be variable indicating delivery duration of time information when a broadcast reception device transmit the time information for synchronization to a companion screen device using an eventing method. The A_ARG_TYPE_UpdateDuration state variable may be variable to be used to make a request for particular delivery duration when a companion screen device receives time information for synchronization from a broadcast reception device using an eventing method.

Service time information (ServiceTimeInfo) may be information for providing data related to time synchronization between A/V content displayed by a broadcast reception device and A/V content displayed by a companion screen device. For example, the service time information may include at least one of media time information and/or wall-clock time of a program that is presented or served by a broadcast reception device. The broadcast reception device may execute an event (or triggering event) (eventing method) to transmit service time information for time synchronization to a companion screen device. In addition, the broadcast reception device may transmit the service time information for time synchronization to the companion screen device in response to a request of the companion screen device (requesting method).

The delivery duration information may be information indicating duration for delivery of the service time information. The broadcast reception device may transmit the service time information to the companion screen device based on the delivery duration information. For example, the delivery duration information (UpdateDuration) may be information indicating delivery duration when the broadcast reception device transmits service time information for time synchronization to the companion screen device using an eventing method. That is, the delivery duration information may indicate duration for eventing the service time information. When the broadcast reception device transmits the service time information for time synchronization to the companion screen device using an eventing method, the broadcast reception device may transmit the service time information to the companion screen device with duration indicated by the delivery duration information.

The requested delivery duration information may be information indicating a value of delivery duration information requested by the companion screen device when the companion screen device receives service time information for time synchronization from the broadcast reception device using an eventing. In detail, when the broadcast reception device transmits service time information for time synchronization to the companion screen device using an eventing method, the companion screen device may make a request for predetermined (or particular) delivery duration to the broadcast reception device based on the requested delivery duration information. In response to the request of the companion screen device, the broadcast reception device may determine delivery duration information based on the requested delivery duration information and transmit the service time information to the companion screen device with duration indicated by the delivery duration information.

FIG. 25 is a diagram illustrating service time information according to an embodiment of the present invention.

The service time information may be information for time synchronization between the broadcast reception device and the companion screen device. The service time information may include at least one of media time information and/or current time information of a program that is presented or served by the broadcast reception device. The service time information may include the aforementioned media timeline checkpoint.

In detail, the service time information may include at least one of serviceId attribute, programId attribute, mediaTime element, and/or currentTime element.

The serviceId attribute may indicate a unique ID of a service that is currently selected by a first receiver. For example, the service may include at least one of a linear service and/or a non-linear service.

The programId attribute may indicate a unique ID of a currently presented program. For example, the program may include content included in a linear service and/or a non-linear service.

The mediaTime element may indicate media time information of a currently presented program. The mediaTime element may include mediaTimeProtocol attribute indicating a program used to represent the mediaTime element. For example, the mediaTimeProtocol attribute may indicate a timestamp.

The currentTime element may indicate current time information (wall-clock time). The currentTime element may include currentTimeProtocol attribute indicating a program used to represent the currentTime element. For example, the currentTimeProtocol attribute may indicate a network time protocol (NTP).

The broadcast reception device may execute an event (or triggering event) (eventing method) to transmit service time information for time synchronization between the broadcast reception device and the companion screen device to the companion screen device. In addition, the broadcast reception device may transmit the service time information for time synchronization to the companion screen device in response to a request of the companion screen device (requesting method).

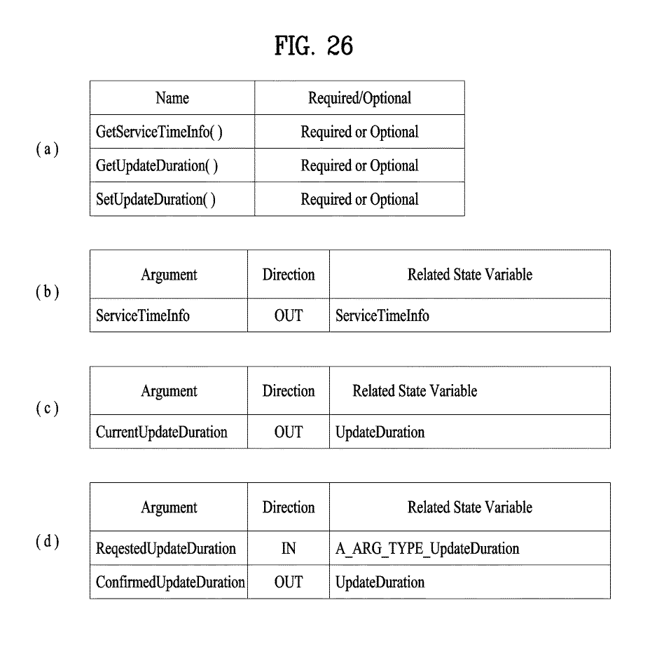

FIG. 26 is a diagram illustrating operations required to transmit service time information according to an embodiment of the present invention.

Referring to (a) of the figure, the operations required to transmit the service time information may include at least one of a service time information request (GetServiceTimeInfo( ) or first request), a delivery duration information request (GetUpdateDuration( ) or second request), and/or a delivery duration information setup request (SetUpdateDuration( ) or third request).

The service time information request (GetServiceTimeInfo( ) or first request) may be an operation of making a request for acquisition of service time information for time synchronization to the service time information by the companion screen device.

The delivery duration information request (GetUpdateDuration( )) may be an operation of making a request for acquisition of delivery duration information to the broadcast reception device by the companion screen device when the companion screen device receives service time information for time synchronization from the broadcast reception device using an eventing method.

The delivery duration information setup request (SetUpdateDuration( ) or third request) may be an operation of making a request for setup of delivery duration information to the broadcast reception device by the companion screen device when the companion screen device receives service time information for time synchronization from the broadcast reception device using an eventing method.

Each of the service time information request, the delivery duration information request, and/or the delivery duration information setup request may be a necessary operation or an optional operation.

(b) of the figure illustrates Argument related to a service time information request.

The service time information request (GetServiceTimeInfo( )) may be used when the companion screen device makes a request for service time information for time synchronization from the broadcast reception device. The companion screen device may make a request for service time information for time synchronization to the broadcast reception device based on the service time information request. In response to the service time information request from the companion screen device, the broadcast reception device may transmit service time information (ServiceTimeInfo Argument) to the companion screen device based on the service time information request (or first request) for making a request for acquisition of the service time information using a companion screen interface. The service time information (ServiceTimeInfo Argument) may be information related to the ServiceTimeInfo state variable.

That is, the broadcast reception device may transmit service time information for time synchronization to the companion screen device in response to a request of the companion screen device (requesting method).

(c) of the figure illustrates Argument related to a delivery duration information request.

The delivery duration information request (GetUpdateDuration( )) may be used to make a request for current delivery duration information of the broadcast reception device from the broadcast reception device by the companion screen device. The companion screen device may make a request for current delivery duration information of the broadcast reception device to the broadcast reception device based on the delivery duration information request.

The delivery duration information may refer to duration for eventing service time information. In response to the delivery duration information request from the companion device, the broadcast reception device may transmit current delivery duration information (CurrentUpdateDuration Argument) indicating a value of delivery duration information at a time point indicated by wall-clock time (or current time) to the companion screen device. The current delivery duration information (CurrentUpdateDuration Argument) may be information related to UpdateDuration state variable.

That is, the broadcast reception device may transmit current delivery duration information to the companion screen device in response to a request of the companion screen device (requesting method). The broadcast reception device and/or the companion screen device may confirm current delivery duration information and, then, make a request for setup (or change) of the delivery duration information as necessary.

(d) of the figure illustrates Arguments related to a delivery duration information setup request.

The delivery duration information setup request (SetUpdateDuration( )) may be used to setup and/or change the delivery duration information when the companion screen device receives service time information for time synchronization from the broadcast reception device using an eventing method. The companion screen device may setup/change the delivery duration information when receiving service time information for time synchronization from the broadcast reception device using an eventing method based on the delivery duration information setup request.

When the broadcast reception device transmits service time information for time synchronization to the companion screen device using an eventing method, the broadcast reception device may transmit the service time information to the companion screen device with predetermined duration. For example, the broadcast reception device may transmit service time information when media time and/or current time (wall-clock time) are changed (e.g., every second). In this case, delivery duration of the service time information may be very short or long. The broadcast reception device may set delivery duration information (e.g., every second) that is basically set to a default value. According to the characteristics and/or types of an application and/or service to be provided in association with the broadcast reception device by the companion screen device, the delivery duration information setup request may be used to set up the delivery duration information (UpdateDuration) by the companion screen device.

Arguments related to the delivery duration information setup request may include at least one of requested delivery duration information (ReqestedUpdateDuration Argument) and/or confirmed delivery duration information (ConfirmedUpdateDuration Argument).

When the companion screen device makes a request for particular delivery duration information (UpdateDuration) of service time information for time synchronization based on the delivery duration information setup request (SetUpdateDuration(action), the companion screen device may transmit requested delivery duration information (RequestedUpdateDuration Argument) indicating a value of the requested delivery duration information as an input argument to the broadcast reception device. The requested delivery duration information (RequestedUpdateDuration Argument) may be information related to the A_ARG_TYPE_UpdateDuration state variable.

In response to the delivery duration information setup request (SetUpdateDuration( ) action) from the companion screen device, the broadcast reception device may transmit the confirmed delivery duration information (ConfirmedUpdateDuration argument) as an output argument to the companion screen device. The confirmed delivery duration information (ConfirmedUpdateDuration variable) may be information related to the UpdateDuration state variable.

When the broadcast reception device is capable of normally transmitting the service time information to the companion screen device with the delivery duration information (RequestedUpdateDuration Argument) requested by the companion screen device, the broadcast reception device may set the confirmed delivery duration information as the same value as the requested delivery duration information. Then, the broadcast reception device may return the confirmed delivery duration information (ConfirmedUpdateDuration Argument) including the delivery duration information indicated by the requested delivery duration information as an output argument. Then, the broadcast reception device may transmit the service time information to the companion screen device based on the confirmed delivery duration information using an eventing method.

When the broadcast reception device is not capable of transmitting the service time information to the companion screen device with the delivery duration information (RequestedUpdateDuration Argument) requested by the companion screen device, the broadcast reception device may set (or maintain) the delivery duration information to a value (default value or minimum value) closest to the requested delivery duration information. Then, the broadcast reception device may return the confirmed delivery duration information (ConfirmedUpdateDuration Argument) including the delivery duration information indicating the value closest to the requested delivery duration information as an output argument. Then, the broadcast reception device may transmit the service time information to the companion screen device based on the confirmed delivery duration information using an eventing method.

For example, the companion screen device transmits the requested delivery duration information indicating the delivery duration information (UpdateDuration) in a unit of “every second” to the broadcast reception device (RequestedUpdateDuration=1) but a corresponding program or application may set the delivery duration information (UpdateDuration) only in a unit of minimum “every minute (default value)” in the broadcast reception device. In this case, the broadcast reception device may return the confirmed delivery duration information indicating the delivery duration information in a unit of “every minute” as an output argument (ConfirmedUpdateDuration=60). The delivery duration information (UpdateDuration) of the confirmed delivery duration information may be maintained as “every minute” as a default value of the broadcast reception device (UpdateDuration=60). Then, the broadcast reception device may transmit the service time information to the companion screen device based on the confirmed delivery duration information indicating the delivery duration information in a unit of “every minute” using an eventing method.

When the broadcast reception device is set (or change) the delivery duration information (UpdateDuration) in a unit of “per second (every second)”, the broadcast reception device may return the confirmed delivery duration information indicating the delivery duration information in a unit of “every second” as an output argument (ConfirmedUpdateDuration=1). Then, the broadcast reception device may transmit the service time information to the companion screen device based on the confirmed delivery duration information indicating the delivery duration information of a unit of “every second” using an eventing method.

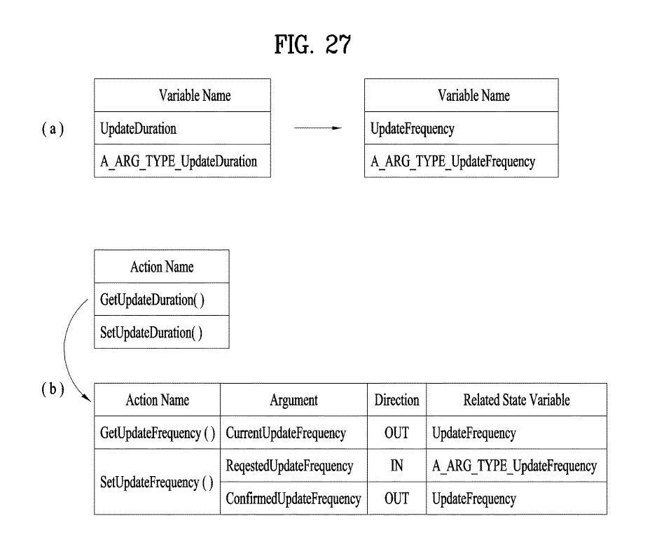

FIG. 27 is a diagram illustrating delivery frequency information according to an embodiment of the present invention.

According to an embodiment of the present invention, Duration may be replaced with Frequency. In this case, Duration=1/Frequency may be satisfied. Here, a unit of Duration may be a second and a unit of Frequency may be 1/second. That is, when a value of Duration is “2 (second)”. Frequency is “0.5 (1/second)”.

When Frequency is used instead of Duration, names of state variable and action may be changed as illustrated in the drawing.

Referring to (a) of the figure, delivery duration information (UpdateDuration state variable) may be changed to delivery frequency information (UpdateFrequency state variable). The delivery frequency information may indicate a delivery frequency when the broadcast reception device transmits service time information for time synchronization to the companion screen device using an eventing.

The request delivery duration information (A_ARG_TYPE_UpdateDuration state variable) may be changed to the request delivery frequency information (A_ARG_TYPE_UpdateFrequency state variable). The requested delivery frequency information may be information indicating a value of the delivery frequency information requested by the companion screen device when the companion screen device receives service time information for time synchronization from the broadcast reception device using an eventing method.

Referring to (b) of the figure, operations required to transmit the service time information may include at least one of a service time information request, a delivery frequency information request, and/or a delivery frequency information setup request.

The service time information request may be an operation of making a request for service time information for time synchronization from the broadcast reception device by the companion screen device.

The delivery duration information request (GetUpdateDuration( )) may be changed to the delivery frequency information request (GetUpdateFrequency( )).

The delivery frequency information request (GetUpdateFrequency( )) may be used when the companion screen device makes a request for current delivery frequency information of the broadcast reception device from the broadcast reception device. The companion screen device may make a request for the current delivery frequency information of the broadcast reception device to the broadcast reception device based on the delivery frequency information request.

The delivery frequency information indicates a frequency for eventing the service time information. In response to the delivery frequency information request from the companion device, the broadcast reception device may transmit current delivery frequency information (CurrentUpdateFrequency Argument) indicating a value of delivery frequency information at a time point indicated by wall-clock time (or current time) to the companion screen device. The current delivery frequency information (CurrentUpdateFrequency Argument) may be information related to the UpdateFrequency state variable.

That is, the broadcast reception device may transmit the current delivery frequency information to the companion screen device in response to a request of the companion screen device (requesting method). The broadcast reception device and/or the companion screen device may confirm the current delivery frequency information and, then, make a request for setup (or change) of the delivery frequency information as necessary.

The delivery duration information setup request (SetUpdateDuration( )) may be changed to delivery frequency information setup request (SetUpdateFrequency( )).

The delivery frequency information setup request (SetUpdateFrequency( )) may be used to setup and/or change delivery frequency information when the companion screen device receives the service time information for time synchronization from the broadcast reception device using an eventing method. Upon receiving the service time information for time synchronization from the broadcast reception device based on the delivery frequency information setup request using an eventing method, the companion screen device may setup and/or change the delivery frequency information.

Arguments related to the delivery frequency information setup request may include at least one of requested delivery frequency information (ReqestedUpdateFrequency Argument) and/or confirmed delivery frequency information (ConfirmedUpdateFrequency Argument).

When the companion screen device makes a request for particular delivery frequency information (UpdateFrequency) of service time information for time synchronization based on the delivery frequency information setup request (SetUpdateFrequency( ) action), the companion screen device may transmit the requested delivery frequency information (RequestedUpdateFrequency Argument) indicating a value of the requested delivery frequency information as an input argument to the broadcast reception device. The requested delivery frequency information (RequestedUpdateFrequency Argument) may be information related to the A_ARG_TYPE_UpdateFrequency state variable.

In response to the delivery frequency information setup request (SetUpdateFrequency( ) action) from the companion screen device, the broadcast reception device may transmit the confirmed delivery frequency information (ConfirmedUpdateFrequency argument) as an output argument to the companion screen device. The confirmed delivery frequency information (ConfirmedUpdateFrequency variable) may be information related to the UpdateFrequency state variable.

When the broadcast reception device is capable of normally transmitting the service time information to the companion screen device with the delivery frequency information (RequestedUpdateFrequency Argument) requested by the companion screen device, the broadcast reception device may set the confirmed delivery frequency information as the same value as the requested delivery frequency information. Then, the broadcast reception device may return the confirmed delivery frequency information (ConfirmedUpdateFrequency Argument) including the delivery frequency information indicated by the requested delivery frequency information as an output argument. Then, the broadcast reception device may transmit the service time information to the companion screen device based on the confirmed delivery frequency information using an eventing method.

When the broadcast reception device is not capable of transmitting the service time information to the companion screen device with the delivery frequency information (RequestedUpdateFrequency Argument) requested by the companion screen device, the broadcast reception device may set (or maintain) the delivery frequency information to a value (default value or minimum value) closest to the requested delivery frequency information. Then, the broadcast reception device may return the confirmed delivery frequency information (ConfirmedUpdateFrequency Argument) including the delivery frequency information indicating the value closest to the requested delivery frequency information as an output argument. Then, the broadcast reception device may transmit the service time information to the companion screen device based on the confirmed delivery frequency information using an eventing method.

A detailed operation of the broadcast reception device and/or the companion screen device when duration is changed to a frequency may include the entire above description.

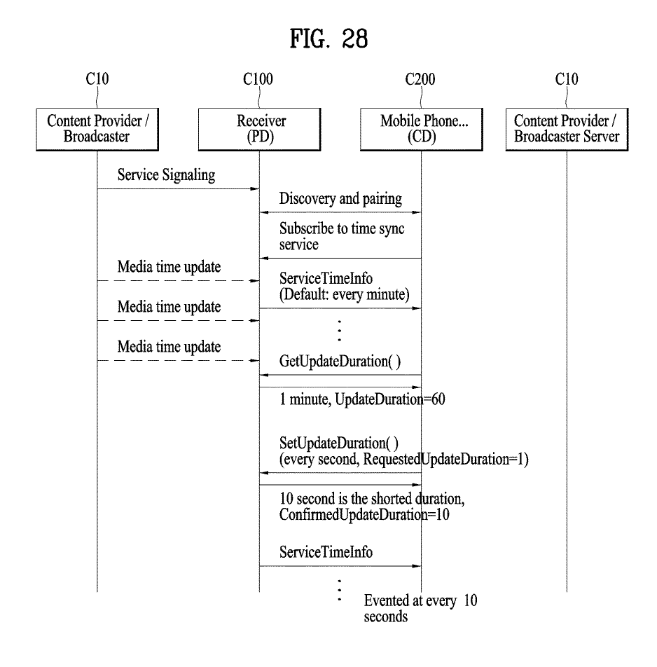

FIG. 28 is a flow diagram of transmitting service time information to a companion screen device by a broadcast reception device using an eventing method according to an embodiment of the present invention.

Referring to the drawing, the broadcast system according to an embodiment of the present invention may include at least one of the broadcaster/content provider C10, the broadcast reception device C100, and/or the companion screen device C200.

The broadcaster/content provider C10 may provide a broadcast service. For example, the broadcast service may include content (or linear service), an application (or non-linear service), and/or signaling information. The broadcaster/content provider C10 may include at least of the aforementioned broadcast transmission device (not shown), content provider (not shown), content server (not shown), controller (not shown), and/or transmitter (not shown).

The broadcast reception device C100 may receive a broadcast service through a broadcast network and/or the Internet. The broadcast reception device C100 may be referred to as a TV receiver and/or a PD.

The companion screen device C200 may receive a broadcast service through the Internet. The companion screen device may be referred to as a mobile phone and/or a CD.

Hereinafter, a method of transmitting service time information for time synchronization to the companion screen device by the broadcast reception device using an eventing method will be described.

First, the broadcast reception device C100 may receive a broadcast signal from the broadcaster/content provider C10. The broadcast reception device C100 may acquire signaling information based on the broadcast signal. In detail, the broadcast reception device C100 may acquire the application signaling information based on the signaling information. As described above, the receiver C100 may acquire the signaling information based on an MPEG-DASH protocol and/or an MMT protocol. The application signaling information may include at least one of a trigger for triggering an operation of an application and triggering application information (or TPT) for signaling information on the triggered application. When a user selects a channel, the broadcast reception device C100 may provide (or broadcast) a particular program based on the signaling information.

Then, the broadcast reception device C100 may perform discovery and/or pairing with the companion screen device C200. For example, according to the provided program, the broadcast reception device C100 may discover the companion screen device and may be electrically paired with the companion screen device so as to transmit and receive data.

Then, the broadcast reception device C100 may receive a request for subscription of the time synchronization service from the companion screen device C200. In addition, the companion screen device C200 may make a request for subscription of the time synchronization service to the broadcast reception device C100. The time synchronization service may refer to a service of generating service time information for providing time synchronization between A/V content displayed by the broadcast reception device C100 and content displayed by the companion screen device C200 and transmitting service time information to the companion screen device C200 from the broadcast reception device C100. The service time information may include the aforementioned media timeline checkpoint.

Then, the broadcast reception device C100 may receive the signaling information including media time information of presented A/V content from the broadcaster/content provider C10. The signaling information may include at least one of media time information and/or current time information (wall clock). As described above, the broadcast reception device C100 may receive signaling information based on the MPEG-DASH protocol and/or the MMT protocol. The broadcast reception device C100 may receive signaling information including media time information at a preset time interval during broadcast of a program.

Then, the broadcast reception device C100 may transmit the service time information (ServiceTimeInfo) to the companion screen device C200 using an eventing method. For example, the broadcast reception device C100 may transmit the service time information to the companion screen device C200 based on delivery duration information (e.g., every minute) obtained by setting the service time information to a default value using an eventing method.

Then, the broadcast reception device C100 may receive delivery duration information request (GetUpdateDuration( ) or second request) for making a request for acquisition of current delivery duration information of the broadcast reception device C100 from the companion screen device C200.

The companion screen device C200 may make a request for current delivery duration information of the broadcast reception device C100 to the broadcast reception device C100 based on the delivery duration information request. In response to the delivery duration information request from the companion screen device C200, the current delivery duration information indicating a value of delivery duration information at a time point indicated by wall-clock time based on the delivery duration information request may be generated and the current delivery duration information may be transmitted to the companion screen device C200.

The broadcast reception device C100 may transmit the current delivery duration information to the companion screen device C200 in response to a request of the companion screen device C200 (requesting method). The companion screen device C200 may check current delivery duration information of the broadcast reception device C100 based on the delivery duration information request.

Then, the broadcast reception device C100 may receive delivery duration information setup request (SetUpdateDuration( ) or third request) for making a request for setup of the delivery duration information from the companion screen device C200.

For example, when the companion screen device C200 receives service time information for time synchronization from the broadcast reception device C100 using an eventing method, the broadcast reception device C100 may receive delivery duration information setup request (SetUpdateDuration( ) action) for setup (or change) of delivery duration from the companion screen device C200. For example, the companion screen device C200 may transmit the requested delivery duration information (RequestedUpdateDuration Argument) indicating a value of the requested delivery duration information to the broadcast reception device.

For example, the requested delivery duration information (RequestedUpdateDuration Argument) may indicate “1 second”. The companion screen device C200 may make a request for setup of delivery duration to 1 second using the delivery duration information setup request (SetUpdateDuration( ) action).

Then, the broadcast reception device may generate confirmed delivery duration information (ConfirmedUpdateDuration Argument) based on the requested delivery duration information (RequestedUpdateDuration Argument). In addition, the broadcast reception device C100 may transmit the confirmed delivery duration information to the companion screen device. The confirmed delivery duration information (ConfirmedUpdateDuration Argument) may indicate the same value as the requested delivery duration information (RequestedUpdateDuration Argument) and/or a closest value to the requested delivery duration information (RequestedUpdateDuration Argument) of delivery duration information items provided by the broadcast reception device C100. For example, the confirmed delivery duration information (ConfirmedUpdateDuration Argument) may indicate “10 seconds”. Since “10 seconds” are a closest value (or minimum value of delivery duration information) if possible and, thus, the broadcast reception device C100 may set the confirmed delivery duration information to “10 seconds”.

Then, the broadcast reception device C100 may transmit service time information to the companion screen device based on the confirmed delivery duration information using an eventing method. For example, the first receiver may transmit the service time information to the companion screen device C200 every 10 seconds using an eventing method.

The broadcaster/content provider C10 may transmit time information (or signaling information) including media time information (or media time update) to the broadcast reception device at a particular time point of a program and/or periodically according to the type and/or characteristics of the program.

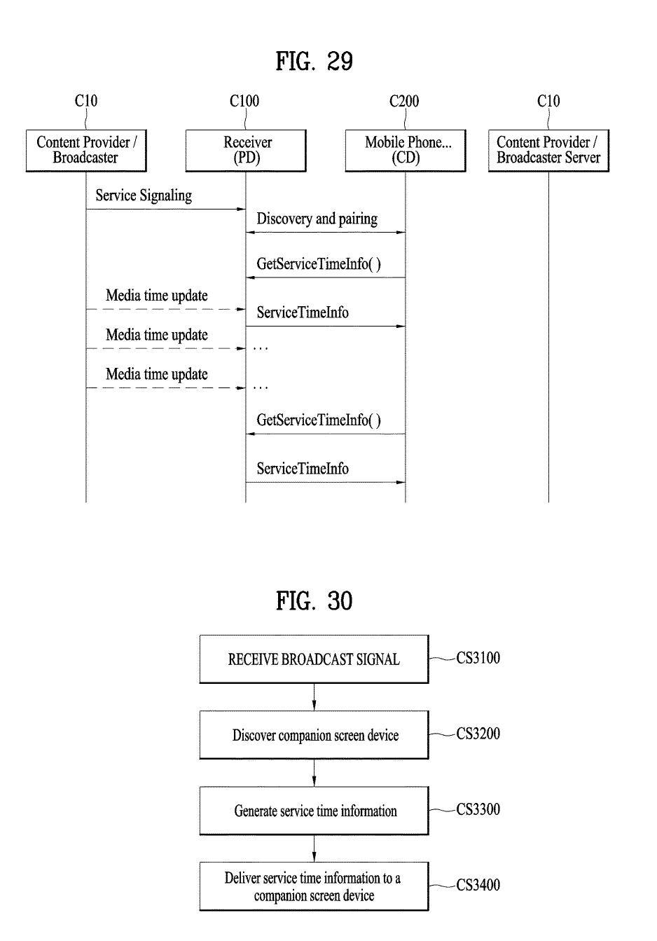

FIG. 29 is a flow diagram of transmitting service time information to a companion screen device by a broadcast reception device using a requesting method according to an embodiment of the present invention.

Referring to the drawing, the broadcast system according to an embodiment of the present invention may include at least one of the broadcaster/content provider C10, the broadcast reception device C100, and/or the companion screen device C200. A detailed description of the broadcast system according to an embodiment of the present invention may include the entire above description.

Hereinafter, a method of transmitting service time information for time synchronization to the companion screen device C200 by the broadcast reception device C100 using a requesting method will be described.

First, the broadcast reception device C100 may receive a broadcast signal from the broadcaster/content provider C10. The broadcast reception device C100 may acquire signaling information based on the broadcast signal. When a user selects a channel, the broadcast reception device C100 may provide (or broadcast) a particular program to the user based on the signaling information.

Then, the broadcast reception device C100 may perform discovery and/or pairing with the companion screen device C200. For example, according to the provided program, the broadcast reception device C100 may discover the companion screen device and may be electrically paired with the companion screen device C200 so as to transmit and receive data.

Then, the broadcast reception device C100 may receive service time information request (GetServiceTimeInfo( ) or first request) of making a request for acquisition of service time information from the companion screen device C200. The service time information request (GetServiceTimeInfo( ) action) may be an operation of making a request for service time information for time synchronization from the broadcast reception device C100 by the companion screen device C200. For example, the companion screen device C200 may make a request for service time information to the broadcast reception device C100 using the service time information request(GetServiceTimeInfo( ) action) at every required time.

Then, in response to a request of the companion screen device C200, the broadcast reception device C100 may transmit recent service time information to the companion screen device C200. For example, the broadcast reception device C100 may transmit service time information to the companion screen device C200 based on a request for acquisition of the service time information using a requesting method.

The broadcaster/content provider C10 may transmit time information (or signaling information) including media time information (or media time update) to the broadcast reception device at a particular time point of a program and/or periodically according to the type and/or characteristics of the program.

FIG. 30 is a flowchart illustrating an operation of a broadcast reception device according to an embodiment of the present invention.

A broadcast signal receiving apparatus may receive a broadcast signal using a broadcast interface (CS3100). For example, the broadcast signal receiving apparatus may receive signaling information and a service including an audio/video (A/V) program using the broadcast interface. For example, the program may refer to content. That is, the A/V program may refer to A/V content.

For example, the signaling information may include media time information of a presented A/V program.

Then, the broadcast reception device may discover the companion screen device using a companion screen interface (CS3200). The broadcast reception device may transmit data and/or signaling information to the companion screen device or receive data and/or signaling information from the companion screen device using the companion screen interface.

Then, the broadcast reception device may operate the broadcast interface and the companion screen interface using a controller. The controller may include a time synchronization service processor.

Then, the broadcast reception device may generate service time information for providing data related to time synchronization between an A/V program based on signaling information and an A/V program displayed by the companion screen device using the controller and/or the time synchronization service processor (CS3300).

Then, the broadcast reception device may transmit the service time information to the companion screen device using the companion screen interface (CS3400).

The service time information according to an embodiment of the present invention may include at least one of serviceId attribute indicating a service ID, programId attribute indicating an ID of a program presented in a service, mediaTime element indicating media time information of a program, and/or currentTime element indicating wall-clock time.

The broadcast reception device according to an embodiment of the present invention may transmit service time information using a requesting method. The broadcast signal receiving apparatus may transmit service time information to the companion screen device based on a first request of making a request for acquisition of service time information received from the companion screen device using the companion screen interface.

The broadcast reception device according to an embodiment of the present invention may transmit service time information using an eventing method. The broadcast reception device may generate update interval information indicating an interval for transmitting the service time information using the time synchronization service processor. Then, the broadcast reception device may transmit the service time information to the companion screen device based on the update interval information using the companion screen interface.

The update interval information according to an embodiment of the present invention may be one of delivery duration information indicating duration for transmitting service time information and delivery frequency information indicating a frequency for transmitting service time information. For example, the interval may include duration and/or a frequency. The update interval information may include update duration information and/or update frequency information.

The broadcast reception device may make a request for acquisition of the update interval information. The broadcast reception device may receive a second request (or update interval information request) of making a request for acquisition of the update interval information from the companion screen device using the companion screen interface. Then, the broadcast reception device may generate current update interval information indicating a value of the update interval information at a time point indicated by wall-clock time based on the second request using the time synchronization service processor. Then, the broadcast reception device may transmit the current update interval information to the companion screen device using the companion screen interface.

For example, the update interval information request may include a delivery duration information request and/or the delivery frequency information request. The current update interval information may include current delivery duration information and/or current delivery frequency information.

The broadcast reception device may make a request for setup of the update interval information. The broadcast reception device may receive a third request (or update interval information setup request) of making a request of setup of the update interval information from the companion screen device using the companion screen interface. The third request may include the requested update interval information indicating a value of the update interval information requested by the companion screen device. Then, the broadcast reception device may generate confirmed update interval information indicating one of the same value as the requested update interval information and a closest value to the requested update interval information using the time synchronization service processor. Then, the broadcast reception device may transmit the service time information to the companion screen device based on the confirmed update interval request information using the companion screen interface.

For example, the update interval information setup request may include a delivery duration information setup request and/or a delivery frequency information setup request. The requested update interval information may include the requested delivery duration information and/or the requested delivery frequency information. The confirmed update interval information may include confirmed delivery duration information and/or confirmed delivery frequency information.

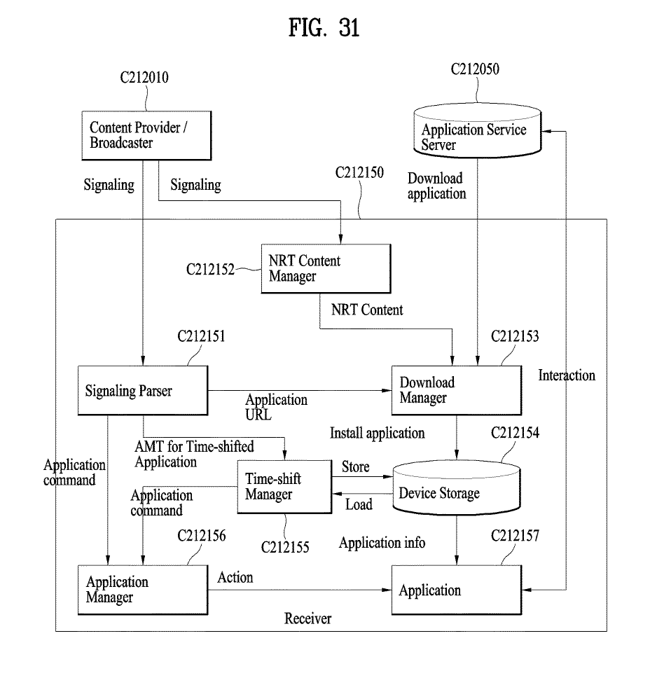

FIG. 31 is a diagram illustrating a structure of a broadcast reception device for supporting a time-shifted application according to an embodiment of the present invention.

Hereinafter, a method of supporting a time-shifted application in a next-generation hybrid broadcast system will be described.

With respect to a program provided for each service in a next-generation hybrid broadcast system, a user may perform replay, trick play, and so on using a time-shift function of the broadcast reception device. The present invention proposes a method of supporting time-shift by interactive application to be executed along with a program, i.e., app-based enhancement in a linear service when the program is time-shifted.

In order to support the time-shifted application by a companion screen device (e.g. second receiver or companion device) connected to the broadcast reception device (e.g. TV, primary device, and first receiver), signaling information for a time-shifted application may be transmitted using a method of transmitting application signaling to the companion screen device (or companion device) by the aforementioned broadcast reception device (or primary device).

According to an embodiment of the present invention, a user is watching a live car racing program being broadcast in channel #10 and, then, may start recording in order to re-watch the program. A broadcaster may inform the user that there is an interactive application for the current program. The interactive application to be provided in the Car racing program may allow the user to select a desired driver and to examine profile information of the driver, such as past competition record. Since the user is recording competition, the user may expect to examine profile information of a desired driver through the interactive application even when the user re-watches competition in the future like the user experience while live broadcast is watched. The interactive application may be valid for an available time period (e.g., one week) to be determined by a broadcaster server (broadcast transmission device, content server, or application service server). During the available time period determined by the broadcaster server, the user may user the interactive application whenever the user watches the recorded program.

According to an embodiment of the present invention, the user may set scheduled recording for a drama to be supposed to be broadcast in channel #20. A broadcaster may provide the interactive application for the current drama. The interactive application for the drama may provide information such as quiz of personal information and storyline to the user according to media time. The user may expect to use the interactive application even when the user watches the recorded drama in the future. Similarly, the interactive application may be valid for available time (e.g., three days) to be determined by the broadcaster server (broadcast transmission device, content server, or application service server). For the available time to be determined by the broadcaster server, the user may use the interactive application whenever the user watches the recorded program.

According to an embodiment of the present invention, the user may watch a drama in channel #30. The current drama may provide the interactive application. The user may return after stepping out in front of a TV for a while and, then, review the drama from the past scene and re-watch the drama using a tile-shift function of the TV. In this case, the user may expect to use the interactive application provided from the drama as before.

The drawing illustrates a structure of the next-generation hybrid broadcast system for supporting a time-shifted application according to an embodiment of the present invention.

The broadcast system according to an embodiment of the present invention may include at least one of a content provider/broadcaster C212010, an application service server C212050, and/or a broadcast reception device (receiver).

The content provider/broadcaster C212010 may indicate a content provider or a broadcast transmission device. The content provider/broadcaster C212010 may include a content provider and/or a broadcast transmission device.

The content provider may provide media content (e.g., real-time content and/or non-real time content) to the content provider/broadcaster C212010 and/or the application service server C212050.

The content provider/broadcaster C212010 may transmit a broadcast signal including a broadcast service using at least one of satellite, terrestrial, and cable broadcast networks. The broadcast service may include at least one of signaling data (or signaling information), ESG data, non real time (NRT) content data, and/or real-time content data. The real time content data may include media data such as video data, audio data, and/or subtitle data. In addition, the NRT content data may include media data and/or an application.

The content provider/broadcaster C212010 may include a controller (not shown) and a transmitter (not shown) of the content provider/broadcaster C212010. The controller may control an operation of the content provider/broadcaster C212010.

When an application provided for a particular program supports a time-shift function, the content provider/broadcaster C212010 may transmit application signaling information (e.g., trigger) on the case in which a particular program is presented via time-shift in a particular table (e.g., activation messages table and AMT) to the broadcast reception device. According to an embodiment of the present invention, the content provider/broadcaster C212010 transmits a trigger to the broadcast reception device through the AMT. The AMT may be originally used when activation trigger information of a plurality of applications, that is, bulk application triggers, are transmitted. According to an embodiment of the present invention, the ATM may be used to trigger an application for the time-shifted program. The ATM may be transmitted to the broadcast reception device through a broadcast network and/or the Internet.

The application service server C212050 may transmit a broadcast signal including a broadcast service based on a request of the broadcast reception device. The application service server C212050 may be an application service server for providing an application and/or application data. The application service server may be provided by a content provider or a broadcaster and, in this case, may be included in the content provider/broadcaster C212010.

The broadcast reception device (or receiver) according to an embodiment of the present invention may include at least one of a broadcast interface (not shown or broadcast receiver), a broadband interface (not shown or IP transceiver), a companion screen interface (not shown or an app transceiver), and/or a controller C212150. The broadcast reception device may operate a broadcast interface, a broadband interface, and/or a companion screen interface using the controller C212150. The broadcast reception device may receive a broadcast signal including a broadcast service using the broadcast interface. In this case, the broadcast signal may be transmitted using at least one of satellite, terrestrial, and cable broadcast networks. Accordingly, the broadcast interface may include at least one of a satellite tuner, a terrestrial tuner, and a cable tuner in order to receive the broadcast signal. The broadcast reception device may make a request for the broadcast service to the application service server C212050 using the broadband interface. The broadcast reception device may receive the broadcast service from the application service server C212050 using the broadband interface. The broadcast reception device may transmit data and/or signaling information to the companion screen device (not shown) or receive data and/or signaling information from the companion screen device using the companion screen interface. The broadcast reception device may decode the broadcast service using a decoder.

The controller C212150 of the broadcast reception device according to an embodiment of the present invention may include at least one of a signaling parser C212151, an NRT content manager C212152, a download manager C212153, device storage C212154, a time-shift manager C212155, an application manager C212156, and/or an application processor C212157.

The signaling parser C212151 may parse a broadcast signal provided by the content provider/broadcaster C212010 to extract a broadcast service. For example, the broadcast service may include at least one of signaling data (or signaling information), ESG data, non real time (NRT) content data, and/or real-time content data. The signaling parser C212151 may parse signaling information to extract application signaling information for signaling an application. For example, the application signaling information may include at least one of a trigger (e.g., application command) for triggering an operation of an application, an AMT, and/or application location information (e.g., application URL) indicating a location of an application for downloading an application in the application service server C212050. For example, the AMT may be an AMT for an application (time-shifted application) for supporting a time-shift function. The application signaling information may further include at least one of triggering application information (e.g., TPT) for signaling information on a triggered application and/or application notification including information on an application notification.

The NRT content manager C212152 may mange NRT content data. For example, the NRT content manager C212152 may parse the broadcast signal to extract NRT content data. For example, the NRT content manager C212152 may parse the broadcast signal to extract NRT content. For example, the NRT content data may include signaling information including triggering application information (e.g., TPT).

The download manager C212153 may receive NRT content data from the content provider or the content provider/broadcaster C212010 and/or the application service server C212050. For example, the download manager C212153 may receive information related to NRT content from the NRT content manager C212152. The download manager C212153 may receive information signaling information, an application, application data, and/or application related information from the application service server C212050. The download manager C212153 may receive signaling information, application, application related information, and NRT content data based on the signaling information. For example, the download manager C212153 may receive signaling information, an application, application related information, and NRT content data from the application service server C212050 based on the application location information. Then, the download manager C212153 may transmit signaling information, an application, application related information, and NRT content data to the device storage C212154. In addition, the download manager C212153 may install an application in the device storage C212154.

The device storage C212154 may store a broadcast service, data, content, a time-shift management table (TMT), application related information, and/or signaling information. For example, the device storage C212154 may store signaling information including an AMT and/or triggering application information (e.g., TPT). The device storage C212154 may transmit the stored information items to other devices.

The time-shift manager C212155 may generate a time-shift management table (TMT) for stating an application for supporting a time-shift function. For example, the time-shift manager C212155 may generate signaling information and/or a TMT for stating an application for supporting a time-shift function based on the AMT. The time-shift manager C212155 may transmit or store the AMT, the TMT, and/or the signaling information to the device storage C212154 or extract or load the AMT, the TMT, and/or signaling information stored in the device storage C212154. The time-shift manager C212155 may extract the AMT and/or a TPT related to the application based on the TMT. For example, the time-shift manager C212155 may extract a trigger (e.g. application command) for triggering an operation of an application included in the AMT based on the TMT.

In the case of a real time program, a broadcaster transmits a trigger and signaling information on an application through a broadcast network but, in the case of a time-shifted program, the time-shift manager C212155 may perform this function. That is, the time-shift manager C212155 may transmit a trigger and signaling information on an application for supporting a time-shift function for a time-shifted program based on the TMT.

The time-shift manager C212155 may configure a new table (e.g., time-shift management table) using a current service, program information, and a TPT ID when timeShiftEnabled attribute of application attribute information (e.g. TPT) to be transmitted from a broadcaster is “true” and store the new table in the device storage C212154. The signaling information may include timeshift attribute indicating whether the corresponding content or program is time-shifted content or program. The time-shift manager C212155 may configure the new table (e.g., Time-shift Management Table) using the current service, program information, and a TPT ID based on the timeshift attribute and store the new table in the device storage C212154.

In the future, when a program recorded by a user is presented or trick-played, the broadcast reception device may extract application attribute information (e.g., TPT) and application trigger information (e.g., trigger) related to a program using a time-shift management table (TMT) of a currently watched program and perform an operation of an application according to the application trigger information. For example, the broadcast reception device may extract a trigger included in the AMT and a TPT stored in device storage based on the TMT using the time-shift manager C212155. The broadcast reception device may operate an application based on the trigger and the TPT using an application manager.

The application manager C212156 may manage an application based on signaling information (e.g., application signaling information) related to the application. For example, the application manager C212156 may control an operation of the application based on the trigger (e.g. application command) and/or the triggering application information (e.g. TPT and application information). Here, the operation of the application may be Activate (Launch or Execute), Suspend, Resume, or Terminate (Exit).

The application processor C212157 may operate the application based on the signaling information. For example, the application processor C212157 may operate an application based on the trigger and/or the triggering application information. For example, the application processor C212157 may perform interaction with the application service server C212050. The application processor C212157 may transmit data to the application service server C212050 and receive data from the application service server C212050. The application processor C212157 may decode the received application and display the application on a screen. According to an embodiment of the present invention, the application may be included in the application processor C212157.

Each device included in the broadcast system may be embodied in the form of hardware or software. When each device is embodied in the form of hardware, the expression ‘manager’ may be replaced with the ‘processor’.

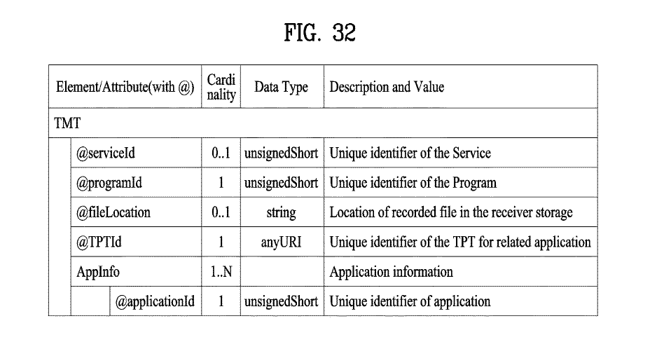

FIG. 32 is a diagram illustrating a time-shift management table (TMT) according to an embodiment of the present invention.

The TMT may describe an application applicable to a time-shifted program. The TMT may describe an application for supporting a time-shift function. For example, the TMT may include at least one of serviceId attribute, programId attribute, fileLocation attribute. TPTId attribute, and/or AppInfo element. The TMT may include at least one trigger and/or trigger information. The trigger information may include information on attribute of a trigger.

The serviceId attribute may indicate a unique ID of a service. For example, the serviceId attribute may indicate a service ID of a service for providing an application for supporting a time-shift function. The serviceId attribute may be optional information.

The programId attribute may indicate a unique ID of a program. For example, the programId attribute may indicate an ID for identifying a particular program included in a service. The program may provide an application for supporting a time-shift function. The programId attribute may be necessary information.

The fileLocation attribute may indicate a location of a file recorded in device storage of the broadcast reception device. The fileLocation attribute may indicate a location of a program stored in the broadcast reception device. The fileLocation attribute may be optional information.

The TPTId attribute may indicate a unique ID of triggering application information (or TPT) on a related application. The TPTId attribute may be necessary information.

The AppInfo element may include application attribute or application information. The AppInfo element may be necessary information. The AppInfo element may include applicationId attribute. The applicationId attribute may indicate a unique Id of an application. The applicationId attribute may be necessary information. The AppInfo element may include at least one trigger and/or trigger information on a corresponding application. The trigger information may include information on trigger attribute.

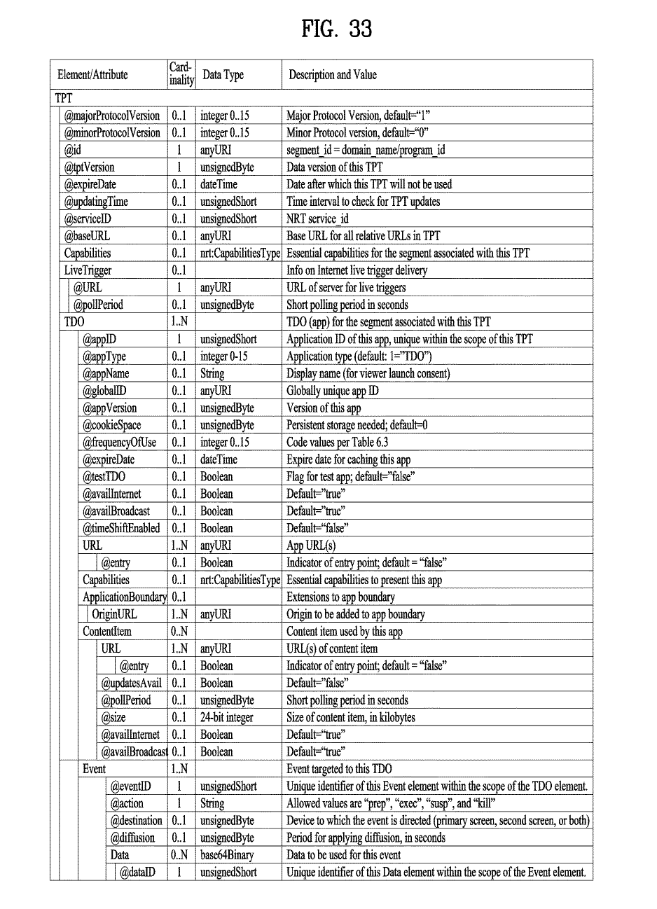

FIG. 33 is a diagram illustrating TPT signaling according to an embodiment of the present invention.

Hereinafter, application signaling information for an application for supporting a time-shift function will be described. The application signaling information may include a trigger and/or triggering application information (or TPT). First, the triggering application information (or TPT) will be described.

The triggering application information may signal information on a triggered application. Alternatively, the triggering application information may include at least one triggered declarative object (TDO) of a segment and metadata of at least one event targeted to at least one TDO. For example, the TDO may be an application. The triggering application information may be a TDO parameters table (TPT). The triggering application information may signal an application corresponding to an entire program segment or a partial program segment according to a time. In this case, the segment or the program segment may indicate time duration included in the program.

The triggering application information may include at least one of majorProtocolVersion attribute, minorProtocolVersion attribute, id attribute, tptVersion attribute, expireDate attribute, updatingTime attribute, serviceID attribute, baseURL attribute, Capabilities element, LiveTrigger element, and/or TDO element. A detailed description of the attribute and/or the element included in triggering application information may include the entire above description.

The TDO element may include at least one of appID attribute, appType attribute, appName attribute, globalID attribute, appVersion attribute, cookieSpace attribute, frequencyOfUse attribute, expireDate attribute, testTDO attribute, availInternet attribute, availBroadcast attribute, URL element, Capabilities element, ApplicationBoundary element, ContentItem element, and/or Event element. A detailed description of the attribute and/or the element included in the TDO element may include the entire above description.

In order to support time-shift according to an application, the broadcast transmission device may also transmit flag information indicating whether an application is capable of being used in a time-shifted program. For example, the broadcast transmission device may also transmit flag information indicating whether a corresponding application of the application signaling information (or triggering application information) is capable of supporting time-shift.

To this end, the TDO element according to an embodiment of the present invention may further include timeShiftEnabled attribute. The timeShiftEnabled attribute may indicate whether the application is capable of supporting a time-shift function. For example, the timeShiftEnabled attribute may indicate whether an application is capable of being operated with respect to a time-shifted program. The timeShiftEnabled attribute may have a “false” as a default value.

The broadcast transmission device may add the timeShiftEnabled attribute to a table (e.g., TPT) indicating information on an application during application signaling and transmit the table to the broadcast reception device.

The broadcast reception device may receive triggering application information (or TPT). The broadcast reception device may store a TPT based on the timeShiftEnabled attribute and/or an AMT for time-shift. For example, when timeShiftEnabled attribute is “true”, the broadcast reception device may also store the AMT for time-shift transmitted along with the current TPT when a program is recorded by a user in the future.

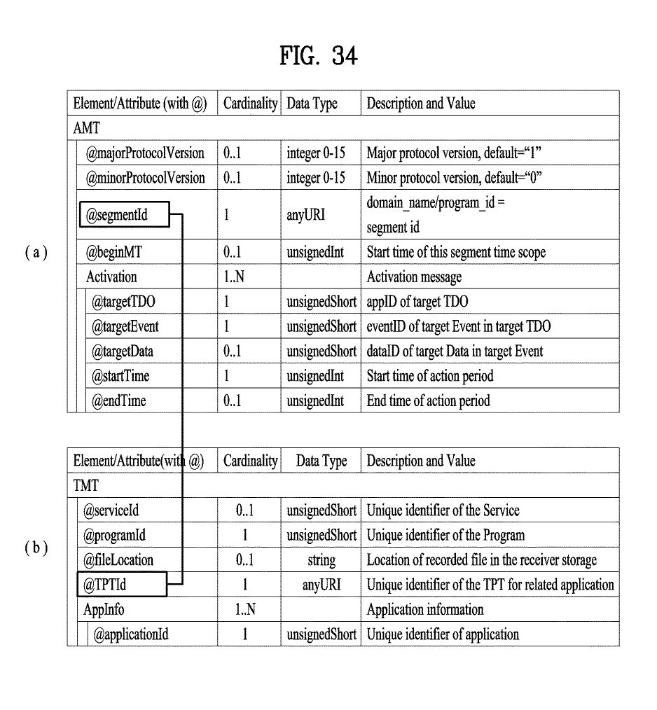

FIG. 34 is a diagram illustrating trigger signaling according to an embodiment of the present invention.

When the broadcast reception device presents a time-shifted program, the broadcast reception device may not receive a trigger (or application trigger) from the broadcast transmission device through a broadcast network.

Hereinafter, a method of signaling a trigger by a broadcast reception device when the broadcast reception device presents a time-shifted program will be described.

A trigger may trigger an operation of an application. The trigger may identify signaling and may establish timing of play out of at least one interactive event. The trigger may perform timing-related signaling functions in order to support at least one interactive service.

For example, the trigger information may include information on attribute of the trigger. The trigger information may include at least one of an application ID (or appID) for identifying an application (or TDO) targeted by a triggering event, a triggering event ID (or eventID) for identifying a triggering event (or event) of an application, a data ID (or dataID) for identifying data related to a triggering event, start time information (or startTime) indicating start time of a triggering event, and/or end time information (or endTime) indicating end time of a triggering event.

(a) of the figure illustrates an Activation Messages Table (AMT). The AMT may include information corresponding to at least one activation trigger of a program segment. For example, the AMT may include a large amount of at least one activation trigger of the program segment. The AMT may be transmitted through a broadcast network and/or the Internet by the broadcast transmission device.

The AMT may include at least one of majorProtocolVersion attribute, minorProtocolVersion attribute, segmentId attribute, beginMT attribute, and/or Activation element.

The majorProtocolVersion attribute may indicate a major protocol version.

The minorProtocolVersion attribute may indicate a minor protocol version.

The segmentId attribute may be an ID matched with an ID of triggering application information (or TPT) including at least one application (or TDO) and/or at least one triggering event. The activation element in the AMT may be applied to at least one application (or TDO) and/or at least one triggering event.

The beginMT attribute may indicate start media time of a program segment. The AMT instance may provide activation times of start media time of a program segment.

The Activation element may include an activation message. The Activation element may indicate a command for activating a particular triggering event at a particular time point. Optionally, the Activation element may indicate a command for activating a particular triggering event with particular data related to a triggering event. The Activation element may include at least one of targetTDO attribute, targetEvent attribute, targetData attribute, startTime attribute, and/or endTime attribute. The Activation element may correspond to a trigger.

The targetTDO attribute may be information matched with an application ID (or appID) of an application (or TDO) of triggering application information (or TPT) related to an AMT. The targetTDO attribute may identify a target application of an activation command.

The targetEvent attribute may be information matched with a triggering event ID (e.g., eventID) of a triggering event element (or event element) included in an application (or TDO element) identified according to the targetTDO attribute. The targetEvent attribute may identify a target triggering event of an activation command.

The targetData attribute may be information matched with a data ID (or dataID) of a data element (or Data element) included in the triggering event (or Event element) identified according to the targetTDO attribute and the targetEvent attribute. When the activation command is applied, the targetData attribute may identify data related to the target triggering event.

The startTime attribute may indicate start of a valid time period of a triggering event related to media time. When the media time reaches a value of the startTime attribute, the broadcast reception device may execute a command.

The endTime attribute may indicate end of a valid time period of a triggering event related to media time. When the media time exceeds a value of the endTime attribute, the broadcast reception device may not execute a command.

Activation elements of an AMT may be indicated in an order in which a value of the startTime attribute increases. When the broadcast reception device activates triggering events according to the Activation elements in the AMT, the broadcast reception device may apply activation of each triggering event at a time point indicated by a value of the startTime attribute. The broadcast reception device may apply activation of each triggering event at an earlier time if possible after a time point indicated by the startTime attribute. For example, when the broadcast reception device participates in a service and receives an AMT at a particular time point after time indicated by the startTime attribute prior to time indicated by the endTime attribute, the broadcast reception device may apply activation of each triggering event at an earlier time if possible after time indicated by the startTime attribute. When the action attribute of a triggering event indicates “execution (or exec)”, the broadcast reception device may transmit a triggering event (or TriggerEvent) to a target application.

(b) of the figure illustrates a Time-shift Management Table (TMT). The TMT may describe an application for supporting a time-shift function. For example, the TMT may include at least one of serviceId attribute, programId attribute, fileLocation attribute, TPTId attribute, and/or AppInfo element. The AppInfo element may include applicationId attribute. A detailed description of the TMT may be the same as the above description.

While recording a program, the broadcast reception device may receive and store an Activation Messages Table (AMT) for time-shift. According to an embodiment of the present invention, the AMT may include at least one trigger (or trigger information).

Then, the broadcast reception device may generate a TMT that describes an application for supporting a time-shift function based on an AMT including at least one trigger using a time-shift manager.

Then, when a program recorded by a user is present, a time-shift manager of the broadcast reception device may search for a TPT and/or application ID (or application ID) associated with a program based on the TMT. For example, the TPTId attribute of the TMT may be matched with the ID attribute of the TPT. In addition, the applicationId attribute of the TMT may be matched with the appID attribute of the TPT.

The broadcast reception device may search for a trigger based on an AMT related to the TMT. For example, the broadcast reception device may search for a trigger (trigger information or application trigger information) of time-shifted application using the segmented of the AMT as the same ID value as TPTId of the TMT. For example, the TPTId attribute of the TMT may be matched with the segmentId attribute of the AMT. In addition, the applicationId attribute of the TMT may be matched with the targetTDO attribute of the AMT.

Then, the broadcast reception device may execute an application based on a trigger included in the AMT. In addition, the broadcast reception device may execute an application based on the AMT. For example, the broadcast reception device may execute an application like real time broadcast based on the AMT that is related to the TMT and has the same application ID (or application ID).

The broadcast reception device may provide an interaction to a user through an action of an application.

Accordingly, the broadcast reception device may discover a TPT and/or an application based on the TMT and may execute the application based on a trigger included in the AMT included in the TMT. For example, the broadcast reception device may execute a target triggering event included in the TPT on a target application based on a trigger.

The broadcast reception device may transmit signaling information signaling including a TMT, an AMT, and/or a TPT to the companion screen device. For example, the broadcast reception device may transmit signaling information including a TMT, an AMT, and/or a TPT to the companion screen device using an eventing method and/or a requesting method.

Accordingly, the companion screen device may operate an application for supporting a time-shift function while presenting a time-shifted program. A detailed description of the companion screen device may include the entire above description of the broadcast reception device.

The broadcast transmission device may transmit at least one of triggering application information (or TPT) and/or an AMT.

The triggering application information may include at least one triggered declarative object (TDO) of a segment and metadata of at least one event targeted to at least one TDO.

The AMT may include at least one trigger information time indicating attribute of at least one trigger of a program segment. The program segment may indicate a segment of the time-shifted program. The segment or the program segment may indicate time duration included in the program.

The broadcast reception device at least one of triggering application information (or TPT) and/or an AMT. The broadcast reception device may store at least one of the triggering application information (or TPT) and/or the AMT.

Then, the broadcast reception device may generate a TMT that describes an application related to a segment of a time-shifted program based on the AMT using a time-shift manager.

The TMT may include application signaling information. For example, the TMT may include at least one trigger information item indicating attribute of at least one trigger of a program segment. The TMT may include information included in the triggering application information (or TPT) and/or at least one trigger information item indicating attribute of at least one trigger included in the AMT for time-shift.

In this case, the broadcast reception device needs to maintain the triggering application information (or TPT) but it may not be necessary to maintain the AMT. This is because the broadcast reception device already generates a TMT including information included in the triggering application information (or TPT) based on the AMT and/or at least one trigger information item indicating attribute of at least one trigger included in the AMT for time-shift.

Then, the broadcast reception device may operate an application related to a segment of a time-shifted program based on at least one trigger information item included in the TMT.

FIG. 35 is a flowchart illustrating an operation of an application based on a broadcast signal by a broadcast reception device according to another embodiment of the present invention.

The broadcast reception device may receive a broadcast signal (CS4100). In detail, the broadcast reception device may receive signaling information and a service including a program using a broadcast interface. The broadcast reception device may receive signaling information based on an MPEG-DASH protocol and/or an MMT protocol using a broadcast interface. The signaling information may include media time information of the presented program.

The broadcast reception device may acquire signaling information including application signaling information from the broadcast signal using a signaling parser (CS4200).

The broadcast reception device may discover a companion screen device using a companion screen interface. The broadcast reception device may operate a broadcast interface and a companion screen interface using a controller. For example, the controller may include a time synchronization service processor for generating service time information for providing data related to time synchronization between the program and a program displayed by the companion screen device based on signaling information. The broadcast reception device may transmit the service time information to the companion screen device using the companion screen interface.

The signaling information may include an activation message table including at least one trigger of a program.

The broadcast reception device may generate a time-shift management table (TMT) based on the application signaling information using the controller (CS4300).

For example, the controller may further include a time-shift manager for generating a time-shift management table that describes an application executed in a time-shifted program based on the activation message table.

The broadcast reception device may operate an application based on the activation message table (CS4400). For example, the broadcast reception device may operate an application based on the time-shift management table using the controller.

The signaling information may include triggering application information including metadata of an application. The broadcast reception device may extract a trigger and triggering application information based on the time-shift management table using the controller. The broadcast reception device may operate an application based on the trigger and the triggering application information using the controller.

The triggering application information may include timeShiftEnabled attribute indicating whether an application is operated with respect to a time-shifted program.

The activation message table may include at least one of majorProtocolVersion attribute indicating a major protocol version, minorProtocolVersion attribute indicating a minor protocol version, segmentId attribute indicating an ID matched with an ID of the triggering application information, beginMT attribute indicating start media time of a program segment, and Activation element including an activation message.

The broadcast reception device may further include a broadcast interface connected to a content server through the Internet. The activation message table may further include TPTURL attribute indicating a location of the triggering application information. The broadcast reception device may receive triggering application information from the content server based on the TPTURL attribute using the broadband interface.

The activation message table may further include expireDate attribute indicating an available time of the activation message table. The broadcast reception device may delete an activation message table using the controller when a time indicated by the expireDate attribute elapses.

The time-shift management table may include at least one of serviceId attribute indicating a unique ID of a service, programId attribute indicating a unique ID of the program, fileLocation attribute indicating a location of a file, TPTId attribute indicating a unique ID of triggering application information, AppInfo element including attribute of the application, and ActivationInfo element including trigger information indicating attribute of the trigger.

The broadcast reception device may transmit a time-shift management table to a second screen device using the companion screen interface. For example, the broadcast reception device may transmit the time-shift management table to the second screen device using at least one of an eventing method and/or a requesting method using the companion screen interface.

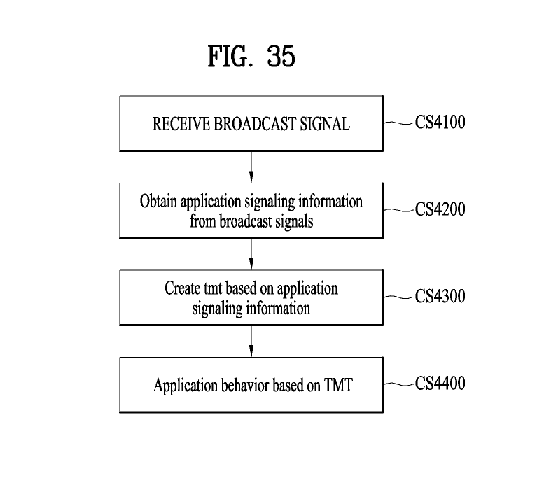

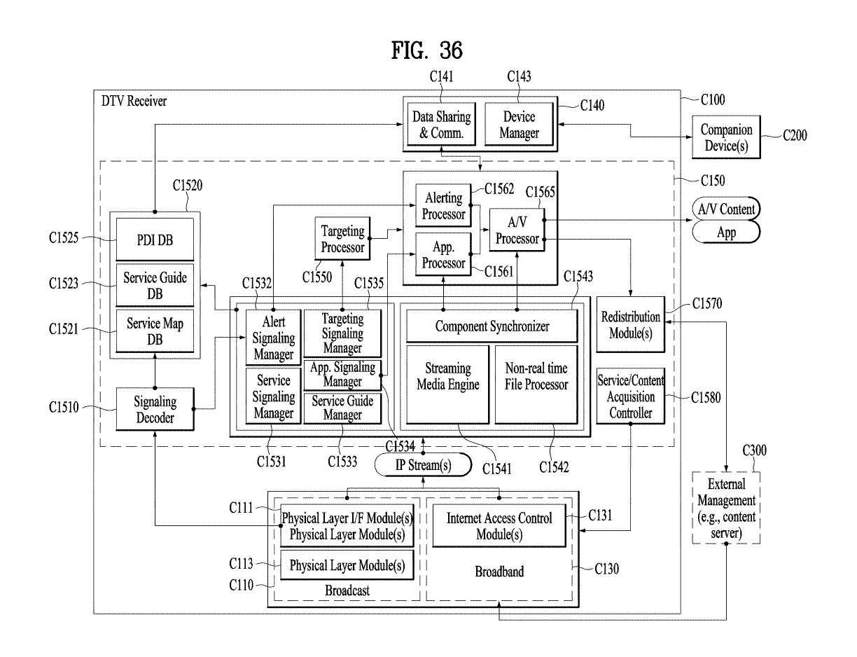

FIG. 36 illustrates a configuration of a broadcast system according to an embodiment of the present invention.

The broadcast system according to an embodiment of the present invention may include a broadcast reception device, a companion device C200 and/or an external management device C300. The broadcast reception device may receive and process broadcast signals. The companion screen device C200 may be an external device that shares audio, video and/or signaling information with the broadcast reception device. The companion screen device C200 can receive broadcast services through the Internet. The companion screen device C200 may be referred to as a second broadcast reception device, a second receiver, a second screen device, a slave device (SD) or a companion device (CD). Description of the broadcast reception device and the companion screen device C200 may include the above description. The external management device C300 may refer to external modules of the broadcast reception device for providing broadcast service content, such as a next generation broadcast service content server.

The broadcast reception device (DTV receiver) according to an embodiment of the present invention includes at least one of a broadcast interface C110, a broadband interface C130, a companion screen interface C140 and a controller C150.

The broadcast interface C110 may be one or more processors executing functions thereof and may include one or more circuits and one or more hardware modules. Specifically, the broadcast interface C110 may be a system on chip (SOC) on which various semiconductor components are integrated. Here, the SOC may be a semiconductor device in which multimedia components such as graphic, audio and video processors and a modem, a processor and a DRAM are integrated. The broadcast interface C110 may include a physical layer module C113 and a physical layer IP frame module C111. The physical layer module C113 receives broadcast related signals through broadcast channels of broadcast networks and processes the broadcast related signals. The physical layer IP frame module C111 converts data packets such as IP datagrams acquired from the physical layer module C113 into specific frames. For example, the physical layer module C113 can convert IP datagrams into RS frames or GSE.

The broadband interface C130 may be one or more processors executing functions thereof and may include one or more circuits and one or more hardware modules. Specifically, the broadband interface C130 may be a system on chip (SOC) in which various semiconductor components are integrated. Here, the SOC may be a semiconductor device in which multimedia components such as graphic, audio and video processors and a modem, a processor and a DRAM are integrated. The broadband interface C130 may include an Internet access control module C131. The Internet access control module C131 controls operation of the broadcast reception device to acquire at least one of a service, content and signaling data over a broadband network.

The companion screen interface C140 can discover the companion screen device C200. The companion screen interface C140 can deliver data and/or signaling information to the companion screen device C200 or receive data and/or signaling information from the companion screen device C200. The companion screen interface C140 may include at least one of a data sharing & communication unit C141 and a device manager C143. For example, the companion screen interface C140 can be included in the controller C150.

The data sharing & communication unit C141 performs data transmission between the broadcast reception device and an external device and processes exchange related information. Specifically, the data sharing & communication unit C141 can transmit AV data or signaling information to an external device. In addition, the data sharing & communication unit C141 can receive AV data or signaling information from the external device.

The device manager C143 manages interoperable external devices. Specifically, the device manager C143 can perform at least one of addition, deletion and update of external devices. External devices can be connected to the broadcast reception device and exchange data with the broadcast reception device.

The controller C150 may be one or more processors executing functions thereof and may include one or more circuits and one or more hardware modules. Specifically, the controller C150 may be a system on chip (SOC) in which various semiconductor components are integrated. Here, the SOC may be a semiconductor device in which multimedia components such as graphic, audio and video processor and a modem, a processor and a DRAM are integrated. The controller C150 may include at least one of a signaling decoder C1510, a database C1520, a service signaling manager C1531, an alert signaling manager C1532, a service guide manager C1533, an application signaling manager C1534, a targeting signaling manager C1535, a streaming media engine C1541, a non-real time file processor C1542, a component synchronizer C1543, a targeting processor C1550, an application processor C1561, an alert processor C1562, an AV processor C1565, a redistribution module C1570 and a service content acquisition controller C1580.

The signaling decoder C1510 decodes signaling information.

The database C1520 can store data. The database C1520 may include at least one of a service map database C1521, a service guide database C1523 and a PDI database C1525. The service map database C1521 can store information related to a service map. The service guide database C1523 can store information relate to service guide data. The PDI database C1525 can store data related to PDI.

The service signaling manager C1531 parses service signaling information. The service signaling manager C1531 can extract signaling information related to service scan and service content from IP datagrams and parses and manages the signaling information. For example, the service signaling manager C1531 extracts and parses signaling information related to a service. Here, the signaling information related to the service may be signaling information related to service scan. In addition, the signaling information related to the service may be signaling information related to content provided through the service.

The alert signaling manager C1532 extracts signaling information related to alert from IP datagrams and parses the signaling information.

The service guide manager C1533 extracts announcement information from IP datagrams, manages the service guide (SG) database and provides service guide information.

The application signaling manager C1534 can extract signaling information related to application acquisition from IP datagrams and parse and manage the signaling information. The signaling information related to application acquisition may include signaling information related to an application and/or application signaling information.

The targeting signaling manager C1535 extracts and parses signaling information for personalizing a service or content or targeting information.

The streaming media engine C1541 can extract audio and video data for AV streaming from IP datagram and decode the audio and video data. The streaming media engine C1541 may include a scheduled streaming decoder (not shown) for decoding scheduled streaming that is content streamed according to a schedule determined by a content provider such as a broadcaster. In addition, the streaming media engine C1541 may include a user request streaming decoder (not shown) for decoding on-demand streaming that is content streamed at the request of a user.

The non-real time file processor C1542 can extract NRT data and data in a file format such as an application from an IP datagram, decode the extracted data and manage the data. The non-real time file processor C1542 may include a file decoder (not shown) for decoding downloaded files. The file decoder decodes files downloaded through broadcast networks and broadband networks. Furthermore, the non-real time file processor C1542 may include a file database (not shown) storing files. Specifically, the file database can store files downloaded through broadcast networks and/or broadband networks.

The component synchronizer C1543 synchronizes content or services. The component synchronizer C1543 can synchronize content such as streaming audio/video data and NRT data and services. Specifically, the component synchronizer C1543 synchronizes content decoded by at least one of the non-real time file processor C1542 and the streaming media engine C1541.

The targeting processor C1550 processes information for personalizing services or content.

The application processor C1561 controls application related information and execution of applications. Specifically, the application processor C1561 processes states of downloaded applications and display parameters.

The alert processor C1562 processes signaling information related to alert.

The AV processor C1565 processes operations related to audio/video rendering on the basis of decoded audio/video and application data.

The redistribution module C1570 performs operation for supporting acquisition of at least one of a service, content, service related information and content related information when the service or content is not received through a broadcast network. Specifically, the redistribution module C1570 can request that the external management device C300 provide at least one of the service, content, service related information and content related information.

The service content acquisition controller C1580 controls operation of the receiver to acquire at least one of a service, content and signaling information related to the service or content. The service content acquisition controller C1580 controls operation of the receiver to acquire a service, content and signaling data related to the service or content through a broadcast network or a broadband network.

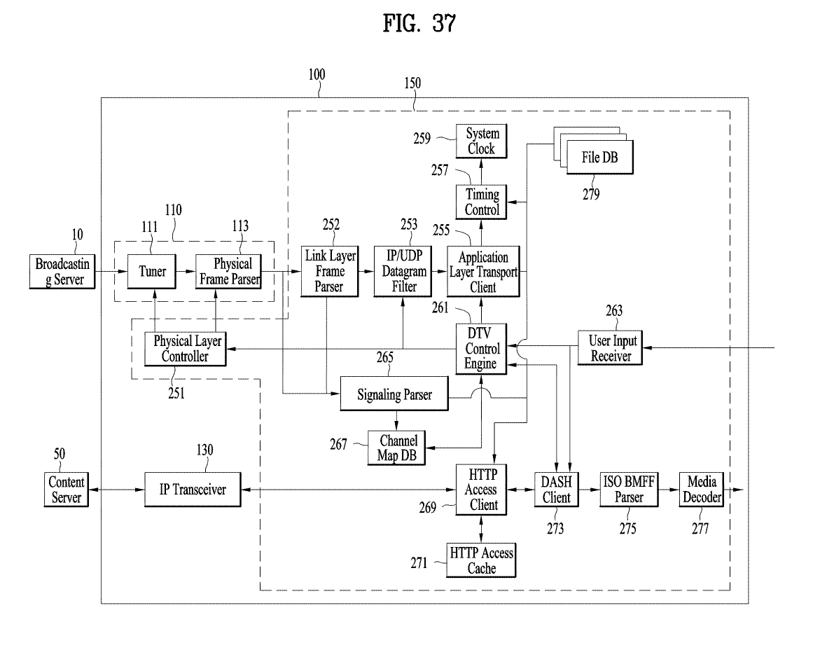

FIG. 37 illustrates a configuration of a broadcast reception device according to an embodiment of the present invention.

The broadcast reception apparatus 100 may include at least one of a broadcast interface 110, a broadband interface 130, a companion screen interface (not shown) and a controller 150. The companion screen interface (not shown) may be included in the controller 150.

The broadcast interface 110 may include at least one of a tuner 111 and a physical frame parser 113.

The tuner 111 receives a broadcast signal transmitted through a broadcast network. In addition, the tuner 111 can convert the received broadcast signal into physical frames.

The physical frame parser 113 extracts link layer frames from the physical frames of the received broadcast signal.

The broadband interface 130 receives and transmits IP data.

The controller 150 may include at least one of a physical layer controller 251, a link layer frame parser 252, an IP/UDP datagram filter 253, an application layer transport client 255, a timing controller 257, a system clock 259, a DTV control engine 261, a user input receiver 263, a signaling parser 265, a channel map database 267, an HTTP access client 269, an HTTP access cache 271, a DASH client 273, an ISO BMFF parser 275, a media decoder 277 and a file database 279.

The physical layer controller 251 controls operation of the broadcast receiver 110. Specifically, the physical layer controller 251 can selectively receive a broadcast signal by controlling transport parameters of broadcast signals received by the broadcast receiver 110. For example, the physical layer controller 251 can control the frequency of a broadcast signal received by the tuner 111. In addition, the physical layer controller 251 can extract link layer frames from a broadcast signal by controlling the physical frame parser 113.

The link layer frame parser 252 extracts data corresponding to payloads of link layer frames of a broadcast signal from the link layer frames. Specifically, the link layer frame parser 252 can extract link layer signaling from the link layer frames. Link layer signaling signals broadcast services through a link layer. Accordingly, the broadcast reception device 100 can acquire information about broadcast services without extracting an application layer. Therefore, the broadcast reception device 100 can rapidly scan and switch broadcast services. Furthermore, the link layer frame parser 252 can extract IP/UDP datagrams from link layer frames.

The IP/UDP datagram filter 253 extracts a specific IP/UDP datagram from IP/UDP datagrams. Since data transmission through a broadcast network or multicast through a broadband network is unidirectional communication, the broadcast reception device 100 receives data in addition to data necessary therefor. Accordingly, the broadcast reception device 100 needs to extract necessary data from data streams. The IP/UDP datagram filter 253 extracts IP/UDP datagram necessary for the broadcast reception device 100 from IP/UDP datagram streams. Specifically, the IP/UDP datagram filter 253 extracts an IP/UDP datagram corresponding to a designated IP address and UDP port number. Here, the IP address can include one of a source address and a destination address.

The application layer transport client 255 processes application layer transport packets. Specifically, the application layer transport client 255 processes real-time object delivery over unidirectional transport (ROUTE) based ALCLCT packets. A ROUTE protocol is an application layer protocol for transmitting real-time data using ALCLCT packets. The broadcast reception device 100 can extract at least one of broadcast service signaling information, NRT data and media content from ALCLCT packets. Here, the media content may be in MPEG-DASH format. Specifically, the media content can be encapsulated in an ISO base media file format (ISP BMFF) and transmitted through the MPEG-DASH protocol. The broadcast reception device 100 can extract MPEG-DASH segments from ROUTE packets. In addition, the broadcast reception device 100 can extract ISO BMFF files from the MPEG-DASH segments.

The application layer transport client 255 can process ROUTE based ALCLCT packets and/or transport packets such as MPEG media transport (MMT) packets and collect and process packets to generate one or more ISO base media file format objects.

The timing controller 257 processes a packet including system time information that is a basis for media content playback. In addition, the timing controller 257 can control a system clock on the basis of the system time information.

The system clock 259 provides a reference clock that is a basis for operation of the broadcast reception device 100.

The DTV control engine 261 serves as an interface between components. Specifically, the DTV control engine 261 can deliver parameters for operation control of each component.

The user input receiver 263 receives user input. Specifically, the user input receiver 263 can receive at least one of remote control input and key input of a user.

The signaling parser 265 extracts information about a broadcast service by parsing broadcast service signaling information that delivers the information about the broadcast service to signal the broadcast service. Specifically, the signaling parser 265 can extract information about a broadcast service by parsing broadcast service signaling information extracted from an application layer. In a specific embodiment, the signaling parser 265 can extract information about a broadcast service by parsing broadcast service signaling information extracted from a link layer.

The channel map database 267 stores information about a channel map of broadcast services. Specifically, the signaling parser 265 can extract information about broadcast services and store information about a channel map in the channel map database 267. The DTV control engine 261 can acquire information about the channel map of broadcast services from the channel map database. Here, the information about the channel map may include at least one of channel numbers indicating broadcast services and names of the broadcast services.

The HTTP access client 269 processes HTTP data. Specifically, the HTTP access client 269 can transmit a request to a content server 50 using HTTP and receive a response to the request from the content server 50.

The HTTP access cache 271 caches HTTP data to improve HTTP data processing speed.

The DASH client 273 processes MPEG-DASH segments. Specifically, the DASH client 273 can process MPEG-DASH segments received through a broadband network. In addition, the DASH client 273 can process MPEG-DASH segments extracted from an application layer of a broadcast signal received through a broadcast network.

The ISO BMFF parser 275 processes ISO BMFF packets. Specifically, the ISO BMFF parser 275 can extract media content from ISO BMFF packets.

The media decoder 277 decodes media content. Specifically, the media decoder 277 can decode media content to play the media content.

The file database 279 stores files necessary for broadcast services. Specifically, the file database 279 can store files extracted from an application layer of a broadcast signal.

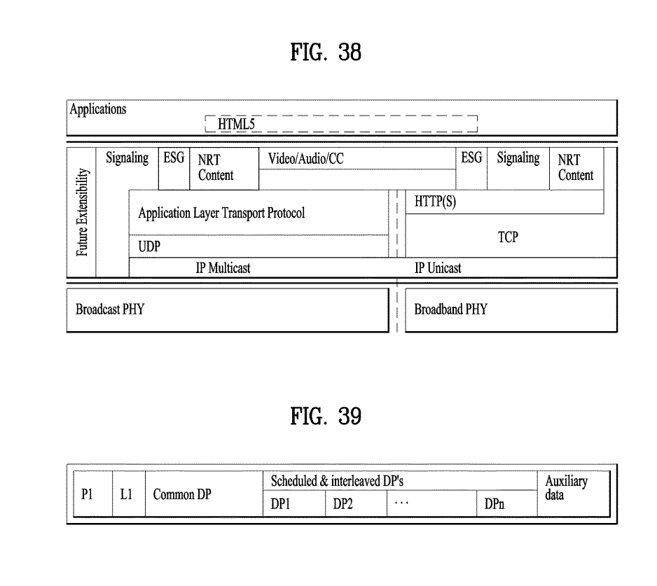

FIG. 38 illustrates an application layer transport protocol stack according to an embodiment of the present invention.

The figure shows a protocol stack of a system supporting IP based next-generation hybrid broadcast.

A broadcast transmission device according to an embodiment of the present invention can transmit broadcast services on the basis of the application layer transport protocol stack.

Broadcast services according to an embodiment of the present invention can include not only media data (e.g., video data, audio data and closed captioning data) but also additional services such as an HTML5 application, interactive service, ACR service, second screen service and personalization service.

For example, broadcast services of a next-generation broadcast system supporting IP based hybrid broadcast can include real-time content data, signaling data, electronic service guide (ESG) data and non-real time (NRT) content data.

Such broadcast services can be transmitted through terrestrial, cable and/or satellite broadcast networks. In addition, the broadcast services according to an embodiment of the present invention can be transmitted through the Internet.

A description will be given of a method of transmitting a broadcast service through a broadcast network.

Media data can include video data, audio data and/or captioning data. The media data can be encapsulated into MPEG (Moving Picture Expert Group)-DASH (Dynamic Adaptive Streaming over HTTP) segments and/or MMT (MPEG Media Transport) MPUs (Media Processing Units). For example, an MPEG-DASH segment and/or an MMT MPU may have an ISO Base Media File Format (ISO BMFF).

Signaling data, ESG data, NRT (Non-Real Time) content data and/or real-time content data can be encapsulated into application layer transport protocol packets supporting real-time delivery. For example, real-time content data can include media data such as video data, audio data and captioning data. NRT content data can include media data and/or applications. The application layer transport protocol can include ROUTE (Real-Time Object Delivery over Unidirectional Transport) and/or MMT. Application layer transport protocol packets can include a ROUTE packet and/or an MMT packet. The application layer transport protocol packets may be simply referred to as packets hereinafter.

The data encapsulated into application layer transport protocol packets can be encapsulated into UDP datagrams.

Then, the UDP datagrams can be encapsulated into IP datagrams. For example, the IP datagrams can be IP multicast or IP unicast based datagramns.

The IP datagram can be transmitted in a broadcast signal. For example, the IP datagram can be transmitted through a physical layer (broadcast PHY).

Signaling data according to an embodiment of the present invention can be transmitted through a specific physical layer pipe (PLP) of transport frames (or frames) delivered through physical layers of a next-generation broadcast transmission system and broadcast network depending on signaling properties. For example, signaling may be encapsulated into bit streams or IP datagrams.

Next, a method of transmitting a broadcast service through the Internet will be described.

Signaling data, ESG data, NRT content data, and/or real-time content data may be encapsulated into HyperText Transfer Protocol (HTTP) packets.

Then, the data encapsulated into the HTTP packets may be encapsulated into Transmission Control Protocol (TCP) packets. A broadcast service according to an embodiment of the present invention can be directly encapsulated into TCP packets.

The TCP packets may be encapsulated into IP datagrams. For example, the IP datagrams may be IP multicast or IP unicast datagrams.

The IP datagrams may be loaded on a broadcast signal and transmitted. For example, the IP datagrams can be transmitted through a physical layer (Broadband PHY).

In the case of the Internet, signaling data, ESG data, NRT content data and/or real-time content data may be delivered as a response to a request of a receiver.

The broadcast reception device may receive the broadcast service on the basis of the aforementioned ROUTE protocol stack.

A description will be given based on a case in which the aforementioned signaling data, ESG data, NRT content data and/or real-time content data are encapsulated into ROUTE transport packets.

Real-Time Object Delivery over Unidirectional Transport (ROUTE) is a protocol for file delivery through IP multicast networks. The ROUTE protocol uses Asynchronous Layered Coding (ALC) and Layered Coding Transport (LCT) which are base protocols designed for massively scalable multicast distribution, and other well-known Internet protocols. ROUTE is an enhanced version or functional substitute of FLUTE, which has additional features.

ROUTE can deliver signaling messages, Electronic Service Guide (ESG) messages and NRT content. Particularly, ROUTE is suitable to deliver streaming media such as MPEG-DASH media segment files. Compared to FLUTE, ROUTE provides lower end-to-end latency through a delivery chain.

The ROUTE protocol is a generic transport application that provides transmission of any type of object. The ROUTE protocol supports rich presentation including scene descriptions, media objects and DRM related information. Particularly, ROUTE is suitable for delivery of real-time media content and provides many features.

For example, ROUTE provides individual delivery and access for different media components (e.g., language tracks, subtitles and alternative video views). In addition, ROUTE supports layered coding by facilitating delivery in different transport sessions or different ROUTE sessions. Furthermore, ROUTE supports flexible FEC protection including multiple stages. ROUTE provides easy MPEG-DASH combinations. MPEG-DASH combination produces synergy between broadcast and broadband delivery modes of DASH. In addition, ROUTE provides fast access to media when joining a ROUTE session and/or a transport session. Furthermore, ROUTE provides high extendibility by focusing on delivery concept. In addition, ROUTE provides compatibility with previous IETF protocols and compatibility with use of IETF-endorsed extension mechanisms.

FIG. 39 illustrates a broadcast transport frame according to an embodiment of the present invention.

Hereinafter, a data pipe (DP) may be represented as a physical layer pipe (PLP).

In an embodiment, a broadcast transport frame includes a P1 part, an L1 part, a common PLP part, an interleaved PLP (Scheduled & Interleaved PLP's) part and an auxiliary data part.

In an embodiment, a broadcast transmission device transmits information for transport signal detection through the P1 part of the broadcast transport frame. In addition, the broadcast transmission device may transmit tuning information for broadcast signal tuning through the P1 part.

In an embodiment, the broadcast transmission device transmits the configuration of the broadcast transport frame and characteristics of each PLP through the L1 part. Here, the broadcast reception device may acquire the configuration of the broadcast transport frame and characteristics of each PLP by decoding the L1 part on the basis of the P1 part.

In an embodiment, the broadcast transmission device may transmit information commonly applied to PLPs through the common PLP part. The broadcast transport frame may not include the common PLP part according to a specific embodiment.

In an embodiment, the broadcast transmission device transmits a plurality of components included in a broadcast service through the interleaved PLP part. Here, the interleaved PLP part includes a plurality of PLPs.

In an embodiment, the broadcast transmission device may signal a PLP through which components constituting each broadcast service are transmitted using the L1 part or the common PLP part. However, to acquire specific broadcast service information for broadcast service scan and the like, the broadcast reception device needs to decode all PLPs of the interleaved PLP part.

The broadcast transmission device can transmit a broadcast transport frame including separate parts containing information about the broadcast service transmitted through the broadcast transport frame and components included in the broadcast service. Here, the broadcast reception device can rapidly acquire the information about the broadcast service and the components included in the broadcast service through the separate parts.

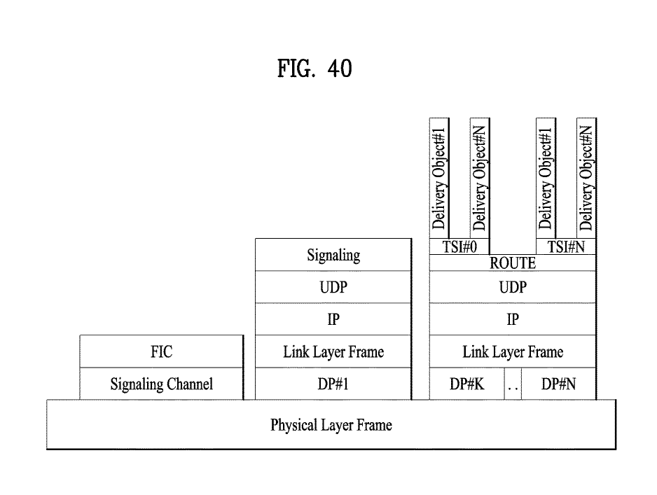

FIG. 40 illustrates delivery of signaling information according to an embodiment of the present invention through an FIC and/or a PLP.

Signaling data of the next-generation broadcast system can be transmitted as follows. The broadcast transmission device may deliver signaling data about a broadcast service through corresponding physical layer frames using a fast information channel (FIC) to support rapid service content scanning of the broadcast reception device. If the FIC is not present, the signaling data about the broadcast service may be delivered through a path through which link layer signaling is delivered.

Signaling information including information about a service and/or components (audio and video component and the like) included in the service may be encapsulated into an IP/UDP datagram and/or application layer transport packets (e.g., ROUTE packets or MMP packets) through one or more PLPs in physical layer frames.

The figure shows an embodiment when such signaling data is delivered through the FIC and/or one or more DPs. Signaling data for supporting rapid service scan acquisition may be delivered through the FIC. Furthermore, signaling data including detailed information about a service may be encapsulated into an IP datagram and delivered through a specific PLP.

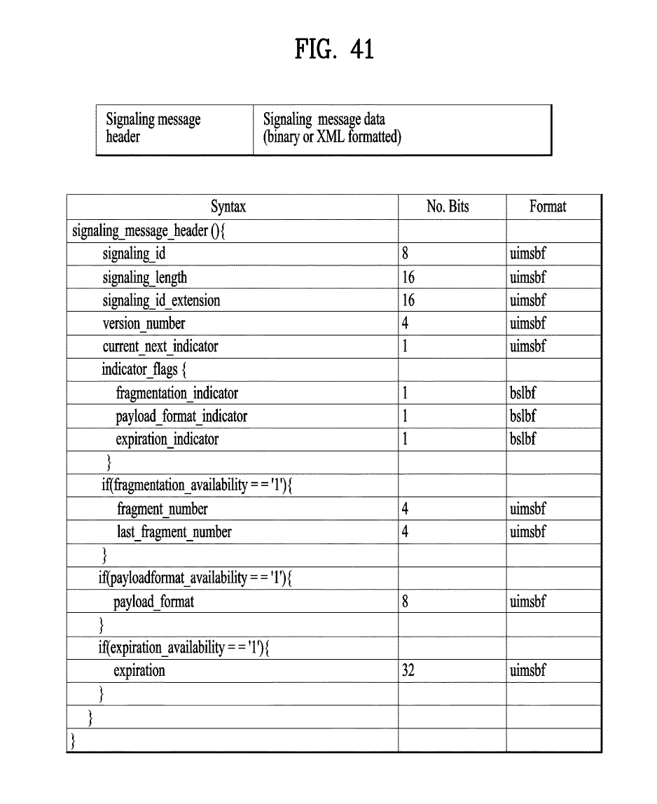

FIG. 41 illustrates a configuration of a service signaling message according to an embodiment of the present invention.

Specifically, the figure shows a syntax of a service signaling message header according to an embodiment of the present invention. The service signaling message according to an embodiment of the present invention may include a signaling message header and a signaling message. Here, the signaling message may be represented in binary or XML format. In addition, the service signaling message may be included in a payload of a transport protocol packet.

The signaling message header according to an embodiment may include identification information for identifying the signaling message. For example, the signaling message may take the form of a section. In this case, ID information of the signaling information can indicate an ID of a signaling table section. A field indicating the ID information of the signaling message may be signaling_id. In a specific embodiment, the signaling_id field may be 8 bits. For example, when the signaling message is represented in the form of a section, the ID information of the signaling message can indicate a signaling table section ID.

Furthermore, the signaling message header according to an embodiment may include length information specifying the length of the signaling message. A field indicating the length information of the signaling message may be signaling_length. In a specific embodiment, the signaling_length field may be 16 bits.

In addition, the signaling message header according to an embodiment may include ID extension information indicating extension of the ID of the signaling message. Here, the ID extension information may be information for identifying signaling along with signaling ID information. A field indicating the ID extension information of the signaling message may be signaling_id_extension. The signaling_id_extension field may be 16 bits in a specific embodiment.

Here, the ID extension information may include protocol version information of the signaling message. A field indicating the protocol version information of the signaling message may be protocol_version. The protocol_version field may be 8 bits in a specific embodiment.

In addition, the signaling message header according to an embodiment may include version information of the signaling message. The version information of the signaling message may change when content of the signaling message varies. A field indicating the version information of the signaling message may be version_number. The version_number field may be 4 bits in a specific embodiment.

Furthermore, the signaling message header according to an embodiment may include information indicating whether the signaling message is currently available. A field indicating whether the signaling message is currently available may be current_next_indicator. When the current_next_indicator field is 1, for example, the current_next_indicator field can indicate that the signaling message is available. If the current_next_indicator field is 0, the current_next_indicator field can indicate that the signaling message is not available and another signaling message including the same signaling ID information, signaling ID extension information or fragment number information is available.

In addition, the signaling message header according to an embodiment may include indicator_flags. The indicator_flags may include at least one of fragmentation_indicator, payload_format_indicator and expiration_indicator.

The fragmentation_indicator can indicate whether the corresponding signaling message has been fragmented. When the fragmentation_indicator is “1”, the fragmentation_indicator can indicate that the corresponding signaling message has been fragmented. In this case, the fragmentation_indicator can indicate that signaling_message_data( ) includes only part of signaling data. When the fragmentation_indicator is “0”, the fragmentation_indicator can indicate that signaling_message_data( ) includes all signaling data.

The payload_format_indicator can indicate whether the signaling message header currently includes a payload_format value. When the payload_format_indicator is “1”, the payload format_indicator can indicate that the signaling message header includes a payload_format value.

The expiration_indicator can indicate whether the signaling message header currently includes an expiration value. If the expiration_indicator value is “1”, the expiration_indicator can indicate that the signaling message header includes an expiration value.

In addition, the signaling message header according to an embodiment may include fragment number information of the signaling message. One signaling message may be divided into a plurality of fragments and transmitted. Accordingly, a receiver can identify the plurality of fragments using the fragment number information. A field indicating the fragment number information may be fragment_number. The fragment_number field may be 4 bits in a specific embodiment. When one signaling message is divided into multiple fragments and transmitted, for example, the fragment_number field can indicate a fragment number of the current signaling message.

Furthermore, the signaling message header according to an embodiment may include last fragment number information when one signaling message is divided into multiple fragments and transmitted. For example, if the last fragment number information is 3, this can indicate that the signaling message is divided into 3 fragments and transmitted. In addition, this can indicate that a fragment having the fragment number of 3 includes last data of the signaling message. A field indicating the last fragment number information may be last_fragment_number. The last_fragment_number field may be 4 bits in a specific embodiment.

In addition, the signaling message header according to an embodiment may include payload format information indicating a format of signaling message data included in the payload. A field indicating the payload format information may be payload_format. For example, payload_format can indicate one of binary and XML formats.

Moreover, the signaling message header according to an embodiment may include may include expiration information indicating expiration of the signaling message included in the payload. A field indicating expiration may be expiration.

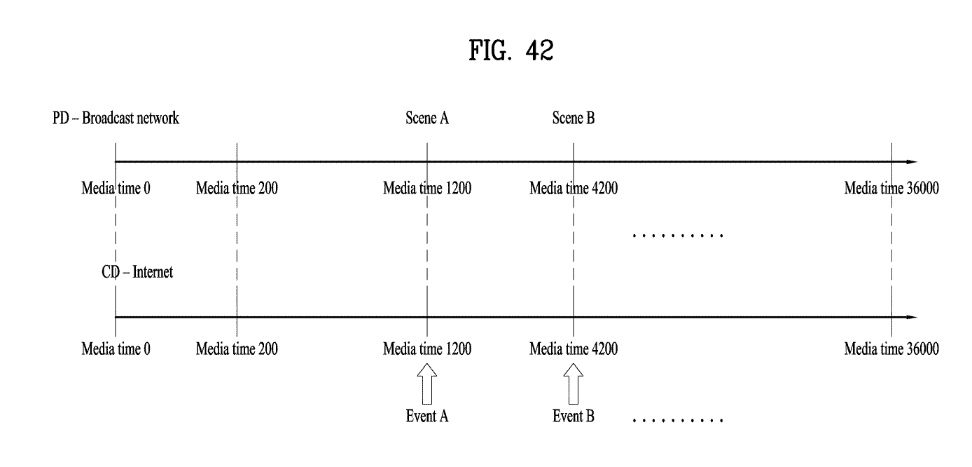

FIG. 42 illustrates synchronization between the broadcast reception device and a companion screen device according to an embodiment of the present invention.

The following situation can be assumed. A user views a drama program through the broadcast reception device (or PD). The drama program can provide additional information such as thoughts of characters, twitter messages and pop-up quizzes per scene to the user through an application of the companion screen device (or CD). The companion screen device (or CD) has been connected (or paired) with the broadcast reception device by the user. Audio and video content of the drama can be delivered to the broadcast reception device through a broadcast network. The additional information can be delivered to the broadcast reception device and the companion screen device through the Internet. The broadcast transmission device and/or the content provider can cause the companion screen device to display specific additional information depending on the media type of the drama. The broadcast reception device and/or the companion screen device can display the specific additional information depending on the media type of the drama.

Referring to the figure, the broadcast reception device and the companion screen device have been synchronized with each other.

The broadcast reception device has been connected to the companion screen device. In addition, the broadcast reception device can receive a program including audio and video content through broadcast networks. Furthermore, the broadcast reception device can receive application data including additional information through broadcast networks and/or the Internet. The additional information may include an event A and/or an event B.

The broadcast reception device can execute the event A at a media time (1200 seconds) corresponding to a scene A of the program. In addition, the broadcast reception device can execute the event B at a media time (4200 seconds) corresponding to a scene B.

The companion screen device can receive application data including additional information through the Internet. The additional information may include the event A and/or the event B.

The companion screen device can execute the event A at media time (1,200 sec) corresponding to the scene A of the program. In addition, the companion screen device can execute the event B at media time (4,200 sec) corresponding to the scene B of the program.

Since the broadcast reception device and the companion screen device have been synchronized with each other, the event A of the broadcast reception device and the event A of the companion screen device can be simultaneously executed. That is, a wall-clock at which the event A is executed in the broadcast reception device is the same as a wall-clock at which the event A is executed in the companion screen device. Furthermore, the event B of the broadcast reception device and the event B of the companion screen device can be simultaneously executed. That is, a wall-clock at which the event B is executed in the broadcast reception device is the same as a wall-clock at which the event B is executed in the companion screen device.

FIG. 43 shows that the broadcast reception device and the companion screen device according to an embodiment of the present invention are not synchronized with each other.

Referring to the figure, the broadcast reception device and the companion screen device are not synchronized with each other.

Since the broadcast reception device and the companion screen device are not synchronized with each other, the event A of the broadcast reception device and the event A of the companion screen device are not simultaneously executed. That is, the wall-clock at which the event A is executed in the broadcast reception device differs from the wall-clock at which the event A is executed in the companion screen device. Furthermore, the event B of the broadcast reception device and the event B of the companion screen device are not simultaneously executed. That is, the wall-clock at which the event B is executed in the broadcast reception device differs from the wall-clock at which the event B is executed in the companion screen device.

The broadcast reception device and the companion screen device are not synchronized with each other for the following reasons.

First, the broadcast reception device and the companion screen device can have different system clock signals according to characteristics of the devices and/or applications. Even through the wall-clock of a media time start point in the broadcast reception device is identical to the wall-clock of a media time start point in the companion screen device, the wall-clock of the media time in the broadcast reception device may differ from the wall-clock of the media time in the companion screen device depending on system clock rates.

Second, the broadcast reception device and the companion screen device may be asynchronized due to network delay in delivery of an event (or triggering event) between the broadcast reception device and the companion screen device.

For such reasons, the media time in the broadcast reception device and the media time in the companion screen device may be different from each other at a specific wall-clock. Accordingly, a scene displayed through the broadcast reception device may not correspond to additional information displayed through the companion screen device at a specific wall-clock.

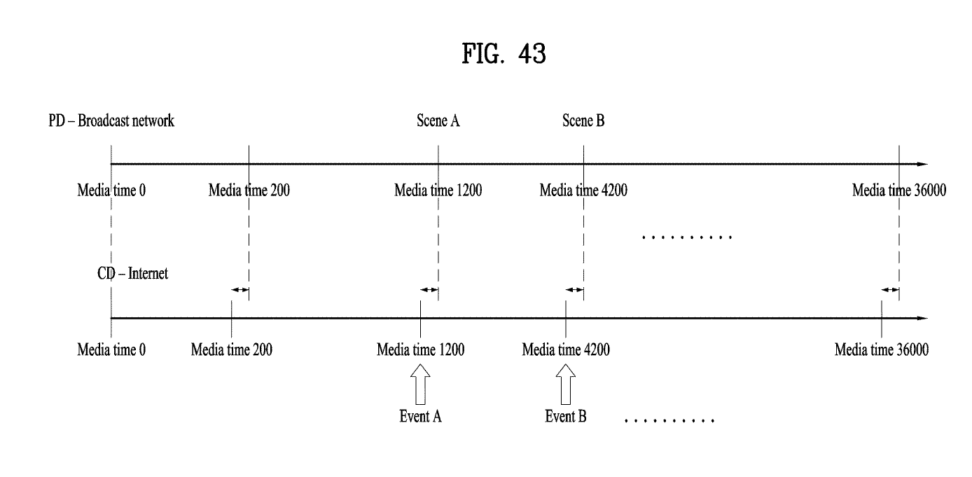

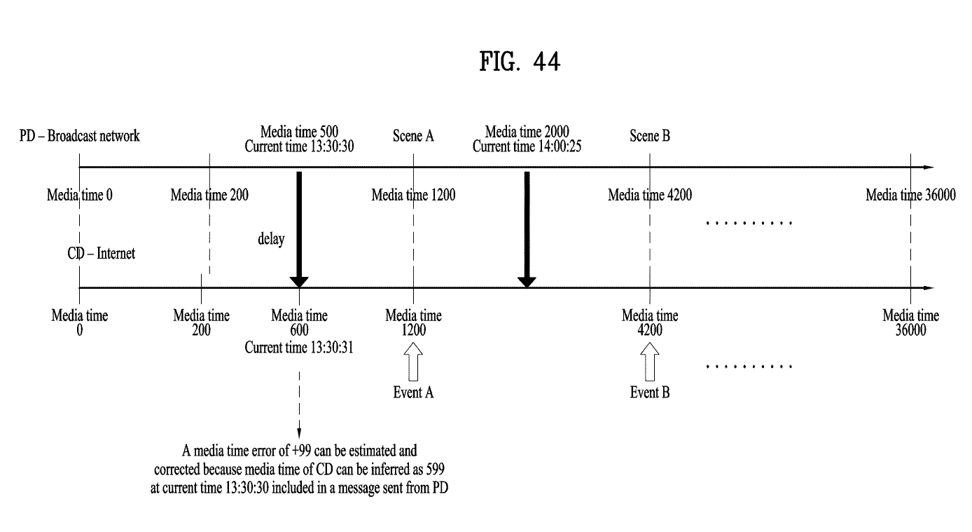

FIG. 44 illustrates a method for synchronizing the broadcast reception device with the companion screen device according to an embodiment of the present invention.

To synchronize the media time of the broadcast reception device PD with the media time of the companion screen device CD at a specific wall-clock, the broadcast reception device can deliver media time information and wall-clock information (or current time or absolute time) in a pair to the companion screen device. Service time information may include media time information and wall-clock information. The broadcast reception device can deliver the service time information to the companion screen device.

The broadcast reception device may periodically deliver the service time information to the companion screen device (eventing method). For example, the broadcast reception device PD can periodically deliver the media time information and the wall-clock information together to the companion screen device CD. The broadcast reception device may deliver the service time information to the companion screen device as a response to a request of the companion screen device (requesting method). For example, the broadcast reception device can deliver the media time information and the wall-clock information together to the companion screen device as a response to a request of the companion screen device.

The figure shows a method through which the broadcast reception device PD is synchronized with the companion screen device CD. For example, the broadcast reception device PD can deliver service time information including media time information and wall-clock information to the companion screen device CD using the eventing method.

The broadcast reception device PD can deliver service time information including media time information indicating 500 sec and wall-clock information indicating 13:30:30 to the companion screen device CD at 13:30:30. In addition, the broadcast reception device can deliver service time information including media time information indicating 2000 sec and wall-clock information indicating 14:00:25 to the companion screen device CD at 14:00:25.

It is assumed that a delay generated when the service time information is delivered from the broadcast reception device PD to the companion screen device is 1 sec. Additionally, it is assumed that the wall-clock of the broadcast reception device PD is synchronized with the wall-clock of the companion screen device CD.

At the wall-clock of 13:30:30, the media time of the broadcast reception device can be 500 sec and the media time of the companion screen device can be 599 sec. Accordingly, the companion screen device CD can receive the service time information from the broadcast reception device PD at the wall-clock of 13:30:31. That is, a media time difference can be calculated using the information of the media time of 500 sec and the wall-clock of 13:30:30 delivered from the broadcast reception device to the companion screen device. When the wall-clock is 13:30:30, the media time of the broadcast reception device is 500 sec and the media time of the companion screen device is 599 sec. Accordingly, it can be known that there is an error of +99 sec in the media time of the companion screen device.

When the wall-clock is 14:00:25, the media time of the broadcast reception device is 2,000 sec and the media time of the companion screen device is 2,099 sec. Accordingly, the companion screen device CD can receive the service time information from the broadcast reception device PD at the wall-clock of 14:00:26. In the same manner as the aforementioned one, the companion screen device CD can calculate a difference between the media time of the broadcast reception device and the media time of the companion screen device on the basis of the service time information.

Then, the companion screen device CD can be synchronized with the broadcast reception device PD on the basis of the service time information. For example, the companion screen device CD can synchronize the media time thereof with the media time of the broadcast reception device PD on the basis of the media time difference.

According to an embodiment of the present invention, when the broadcast reception device PD delivers the service time information to the companion screen device CD using the requesting method, the companion screen device CD can correct network delay.

By delivering media time information and wall-clock information together from the broadcast reception device PD to the companion screen device CD, the companion screen device CD can be synchronized with the broadcast reception device PD even if when the broadcast reception device PD sends the service time information does not correspond to when the companion screen device CD receives the service time information. For example, the companion screen device CD can calculate media time information on the basis of the wall-clock information and be synchronized with the broadcast reception device PD.

When the companion screen device CD updates media time information to the broadcast reception device PD using the requesting method, the companion screen device CD can correct network delay using Cristian's algorithm and/or NTP in consideration of network delay between a request and a response. Of course, the broadcast reception device PD can correct network delay.

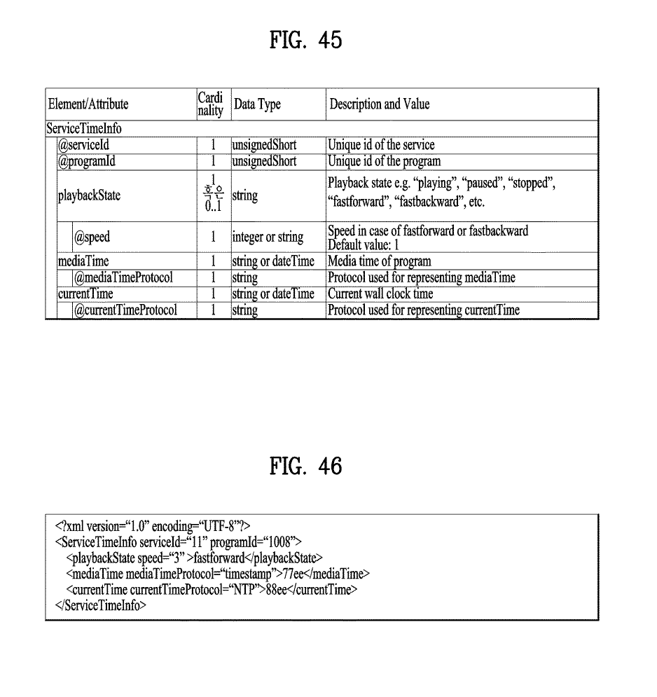

FIG. 45 illustrates service time information including playback state information according to an embodiment of the present invention.

In the case of a program providing an on-demand service, such as an NRT broadcast program, a user can trick-play playback of the program. In this case, the broadcast reception device PD needs to deliver information about a playback state to the companion screen device CD paired therewith.

A description will be given of a method through which the broadcast reception device PD delivers playback state information to the companion screen device CD. The playback state information can indicate a state of a program played back in the broadcast reception device PD.

According to a first method, the broadcast reception device PD may deliver service time information including the playback state information to the companion screen device CD. The broadcast reception device PD can periodically deliver service time information including media time information, wall-clock information and/or playback state information to the companion screen device CD.

According to a second method, the broadcast reception device may define an additional state variable for the playback state information and deliver the playback state information to the companion screen device CD.

The figure shows service time information including playback state information according to an embodiment of the present invention.

The service time information according to an embodiment of the present invention is information for synchronization between the broadcast reception device and the companion screen device. The service time information can be included in at least one of media time information and wall-clock information (or absolute time information or current time information) of a program being played or served through the broadcast reception device. Furthermore, the service time information may include the aforementioned Media Timeline Checkpoint.

Specifically, the service time information may include at least one of a serviceId attribute, a programId attribute, a mediaTime element and a currentTime element.

The serviceId attribute indicates a unique ID of a service currently selected by a first receiver. For example, the service may include at least one of a linear service and a non-linear service.

The programId attribute indicates a unique ID of a currently played program. For example, the program may include content included in the linear service and/or the non-linear service.

The mediaTime element indicates media time information of the currently played program. The mediaTime element may include a mediaTimeProtocol attribute that specifies a protocol used to represent the mediaTime element. For example, the mediaTimeProtocol attribute can indicate a timestamp.

The currentTime element indicates current time information (wall-clock time). The currentTime element may include a currentTimeProtocol attribute that specifies a protocol used to represent the currentTime element. For example, the currentTimeProtocol attribute can indicate the Network Time Protocol (NTP).

The service time information according to an embodiment of the present invention may further include a playbackState element. The playbackState element may be called playback state information.

The playbackState element can indicate the current playback state of a program played back in the broadcast reception device PD. For example, playback states may include at least one of playing, paused, stopped, fast-forward and fast-backward. The playbackState element may include a speed attribute.

The speed attribute indicates the current playback speed of the program in the broadcast reception device PD. When the program is fast forwarded or fast backwarded, the speed attribute can indicate the current playback speed of the program.

For example, an integer value corresponding to a value indicated by the speed attribute can be represented as follows. When the speed attribute indicates “1”, the playback speed can be a “normal playback speed”. When the speed attribute indicates “2”, the playback speed can be “2× normal playback speed”. When the speed attribute indicates “3”, the playback speed can be “3× normal playback speed”. When the speed attribute indicates “4”, the playback speed can be “4× normal playback speed”. The speed attribute can indicate “1” as a default value.

The broadcast reception device may deliver the service time information including the playback state information indicating the state of the program played back therein to the companion screen device by executing an event (or triggering event) (eventing method). Alternatively, the broadcast reception device may deliver the service time information including the playback state information indicating the state of the program played back therein to the companion screen device as a response to a request of the companion screen device (requesting method).

FIG. 46 illustrates an XML format of service time information according to an embodiment of the present invention.

Referring to the figure, the service time information may include at least one of a serviceId attribute, a programId attribute, a mediaTime element, a currentTime element and a playbackState element.

The serviceId attribute can indicate “11”, the programId attribute can indicate “1008”. The mediaTime element may include a mediaTimeProtocol attribute. The playbackState element can indicate “fast-forward”. In addition, a speed attribute included in the playbackState element can indicate “3”. The mediaTimeProtocol attribute can indicate “timestamp”. The mediaTime element can indicate “77ee”. The currentTime element may include a currentTimeProtocol attribute. The currentTimeProtocol attribute can indicate “NTP”. The currentTime element can indicate “88ee”.

With respect to a program having a program ID of “1008” in a service having a service ID of “11”, the broadcast reception device can deliver, to the companion screen device, service time information including media time information indicating “77ee” as a timestamp, wall-clock information (or current time information) indicating “88ee” as NTP and/or playback state information indicating that the program is “fast-forwarded” at “3×”.

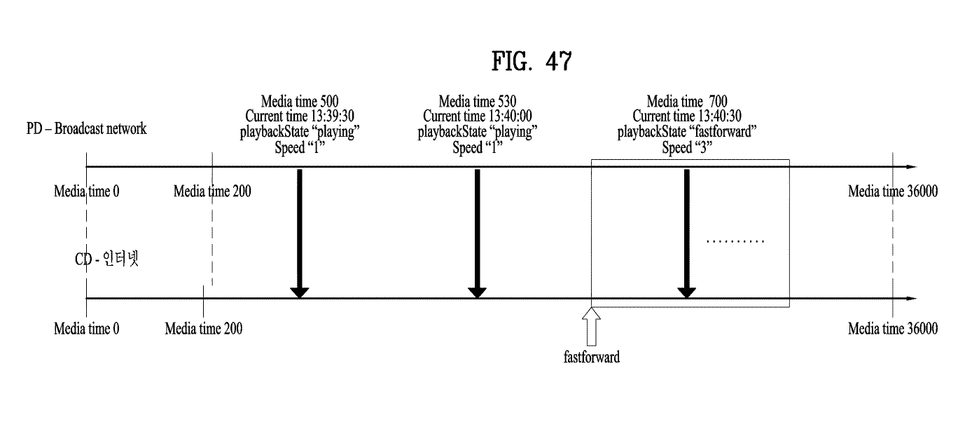

FIG. 47 illustrates delivery of playback state information according to an embodiment of the present invention.

Referring to the figure, the broadcast reception device PD may periodically deliver service time information including playback state information to the companion screen device CD.

For example, the broadcast reception device PD can deliver the service time information to the companion screen device CD at intervals of 30 seconds.

At the wall-clock “13:39:30”, the broadcast reception device can deliver service time information including media time information indicating “500 sec”, wall-clock information indicating “13:39:30” and/or playback state information indicating “1× playback” to the companion screen device.

At the wall-clock “13:40:00”, the broadcast reception device can deliver service time information including media time information indicating “530 sec”, wall-clock information indicating “13:40:00” and/or playback state information indicating “1× playback” to the companion screen device.

At the wall-clock “13:40:30”, the broadcast reception device can deliver service time information including media time information indicating “700 sec”, wall-clock information indicating “13:40:30” and/or playback state information indicating “3× fast-forward” to the companion screen device.

Although the broadcast reception device performs “fast-forward” operation before the wall-clock “13:40:30”, the broadcast reception device can periodically deliver the service time information to the companion screen device.

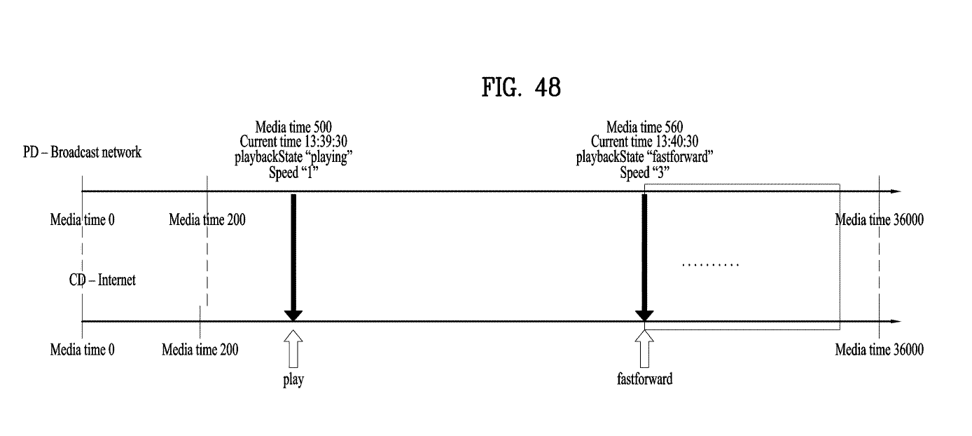

FIG. 48 illustrates delivery of playback state information according to an embodiment of the present invention.

Referring to the figure, the broadcast reception device PD may deliver service time information including playback state information to the companion screen device CD when the playback state information changes.

For example, when the playback state information changes from “1× playback” to “3× fast-forward”, the broadcast reception device PD can deliver service time information including the changed playback state information to the companion screen device CD.

At the wall-clock “13:39:30”, the broadcast reception device can deliver service time information including media time information indicating “500 sec”, wall-clock information indicating “13:39:30” and/or playback state information indicating “1× playback” to the companion screen device.

At the wall-clock “13:40:30”, the playback state information can change from “1× playback” to “3× fast-forward”.

At the wall-clock “13:40:30”, the broadcast reception device can deliver service time information including media time information indicating “560 sec”, wall-clock information indicating “13:40:30” and/or playback state information indicating “3× fast-forward” to the companion screen device.

The broadcast reception device can deliver the service time information including the playback state information to the companion screen device only when the playback state information changes instead of periodically delivering the service time information to the companion screen device.

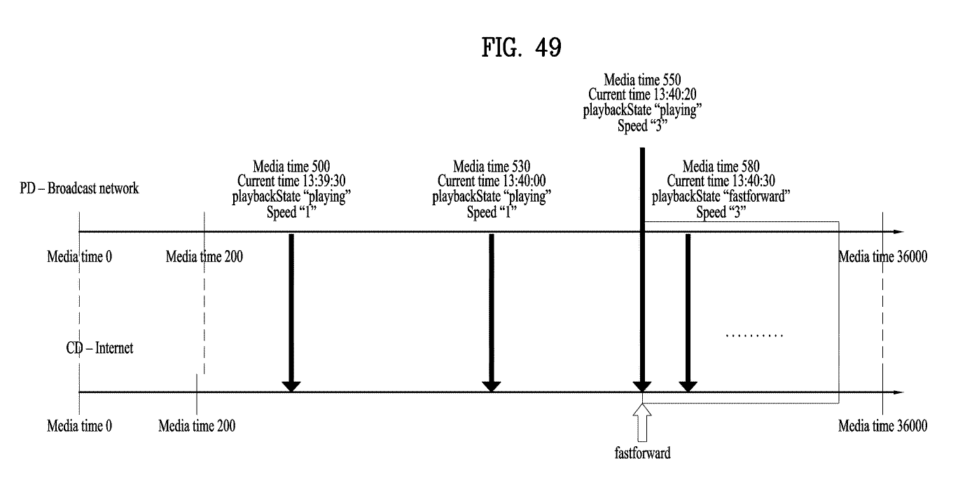

FIG. 49 illustrates delivery of playback state information according to an embodiment of the present invention.

Referring to the figure, the broadcast reception device PD may periodically deliver service time information including playback state information to the companion screen device CD and also deliver the service time information including the playback state information to the companion screen device CD when the playback state information changes.

For example, the broadcast reception device PD can deliver the service time information to the companion screen device CD at intervals of 30 seconds. In addition, when the playback state information changes from “1× playback” to “3× fast-forward”, the broadcast reception device PD can deliver service time information including the changed playback state information to the companion screen device CD.

At the wall-clock “13:39:30”, the broadcast reception device can deliver service time information including media time information indicating “500 sec”, wall-clock information indicating “13:39:30” and/or playback state information indicating “1× playback” to the companion screen device.

At the wall-clock “13:40:00”, the broadcast reception device can deliver service time information including media time information indicating “530 sec”, wall-clock information indicating “13:40:00” and/or playback state information indicating “1× playing” to the companion screen device.

At the wall-clock “13:40:20”, the playback state information can change from “1× playback” to “3× fast-forward”.

At the wall-clock “13:40:20”, the broadcast reception device can deliver service time information including media time information indicating “550 sec”, wall-clock information indicating “13:40:20” and/or playback state information indicating “3× fast-forward” to the companion screen device.

At the wall-clock “13:40:30”, the broadcast reception device can deliver service time information including media time information indicating “580 sec”, wall-clock information indicating “13:40:30” and/or playback state information indicating “3× fast-forward” to the companion screen device.

The broadcast reception device can periodically deliver service time information including playback state information to the companion screen device and also additionally deliver the service time information to the companion screen device when the playback state information changes.

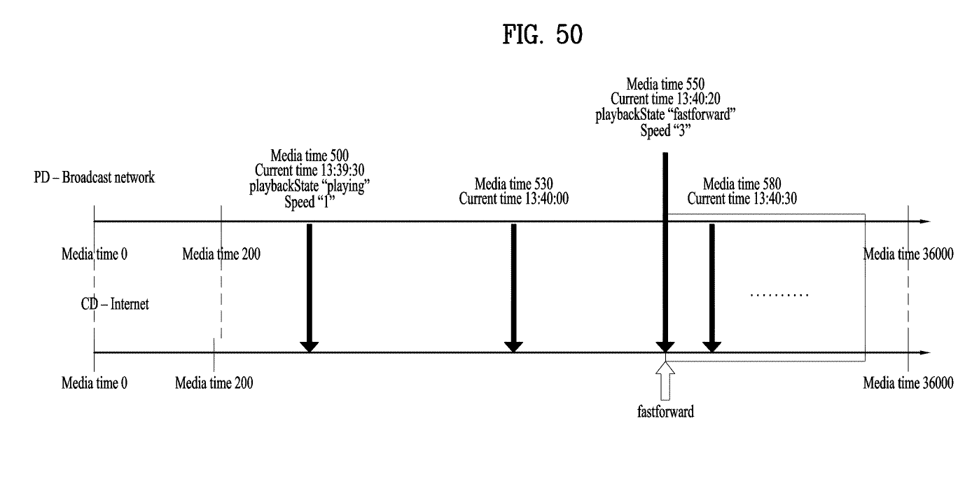

FIG. 50 illustrates delivery of playback state information according to an embodiment of the present invention.

Referring to the figure, the broadcast reception device PD may periodically deliver service time information including no playback state information to the companion screen device CD and deliver the service time information including the playback state information to the companion screen device CD when the playback state information changes. The service time information including no playback state information may refer to service time information including playback state information indicating a default value.

For example, the broadcast reception device PD can deliver the service time information including no playback state information to the companion screen device CD at intervals of 30 seconds. In addition, when the playback state information changes from “1× playback” to “3× fast-forward”, the broadcast reception device PD can deliver service time information including the changed playback state information to the companion screen device CD.

At the wall-clock “13:39:30”, the playback state information may change to “1× playback” from a certain state. Otherwise, the playback state information may indicate the default value at the wall-clock “13:39:30”. The default value may indicate “1× playback”.

At the wall-clock “13:39:30”, the broadcast reception device can deliver service time information including media time information indicating “500 sec”, wall-clock information indicating “13:39:30” and/or playback state information indicating “1× playback” to the companion screen device.

At the wall-clock “13:40:00”, the broadcast reception device can deliver service time information including media time information indicating “530 sec” and wall-clock information indicating “13:40:00” to the companion screen device. Here, the service time information may not include the playback state information.

At the wall-clock “13:40:20”, the playback state information can change from “1× playback” to “3× fast-forward”.

At the wall-clock “13:40:20”, the broadcast reception device can deliver service time information including media time information indicating “550 sec”, wall-clock information indicating “13:40:20” and/or playback state information indicating “3× fast-forward” to the companion screen device.

At the wall-clock “13:40:30”, the broadcast reception device can deliver service time information including media time information indicating “580 sec” and wall-clock information indicating “13:40:30” to the companion screen device. Here, the service time information may not include the playback state information.

The broadcast reception device can periodically deliver service time information including no playback state information to the companion screen device and also additionally deliver service time information including the playback state information to the companion screen device when the playback state information changes.

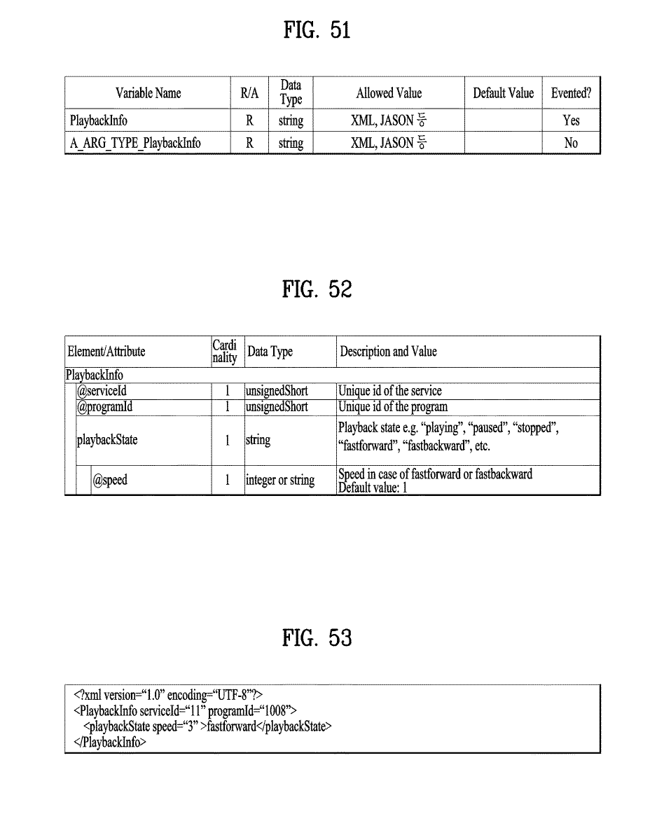

FIG. 51 illustrates state variables for playback information delivery according to an embodiment of the present invention.

A description will be given of a method through which the broadcast reception device PD defines additional state variables for playback state information and delivers the playback state information to the companion screen device CD. State variables and actions for playback state information can be added to the aforementioned synchronization service state variables.

The figure shows state variables for playback information delivery. Playback information can include playback state information. The state variables for playback information delivery may include at least one of a PlaybackInfo state variable containing playback information and an A_ARG_TYPE_PlaybackInfo state variable containing requested playback information. The PlaybackInfo state variable and the A_ARG_TYPE_PlaybackInfo state variable may be required state variables. The PlaybackInfo state variable indicates playback information when the broadcast reception device delivers the playback information to the companion screen device using the eventing method. The A_ARG_TYPE_PlaybackInfo state variable can be used for request and/or response of the playback information when the broadcast reception device delivers the playback information to the companion screen device using the requesting method.

FIG. 52 illustrates playback information according to an embodiment of the present invention.

The playback information includes data related to a playback state of a program played back in the broadcast reception device.

Specifically, the playback information may include at least one of a serviceId attribute, a programId attribute and a playbackState element.

The serviceId attribute indicates a unique identifier of a currently selected service in the broadcast reception device. For example, the service may be a linear service and/or a non-linear service.

The programId attribute indicates a unique identifier of a current program. For example, the program may include content contained in a linear service and/or a non-linear service.

The playbackState element indicates a current playback state of a program played back in the broadcast reception device PD. For example, a playback state may include at least one of playing, paused, stopped, fast-forward and fast-backward. The playbackState element may include a speed attribute.

The speed attribute specifies a current playback speed of a program in the broadcast reception device PD. When the program is fast forwarded or fast backwarded, the speed attribute can indicate the current playback speed of the program.

For example, integer values corresponding to values indicated by the speed attribute may be represented as follows. When the speed attribute is “1”, the speed attribute indicates a “normal playback speed”. When the speed attribute is “2”, the speed attribute indicates “2× normal playback speed”. When the speed attribute is “3”, the speed attribute indicates “3× normal playback speed”. When the speed attribute is “4”, the speed attribute indicates “4× normal playback speed”. The speed attribute may indicate “1” as a default value.

The broadcast reception device can execute an event (or triggering event) to deliver playback information including playback state information indicating a state of a program played back in the broadcast reception device PD to the companion screen device (eventing method). Furthermore, the broadcast reception device can deliver playback information including playback state information indicating a state of a program played back in the broadcast reception device PD to the companion screen device as a response to a request of the companion screen device (requesting method).

FIG. 53 illustrates an XML format of the playback state according to an embodiment of the present invention.

Referring to the figure, the playback information may include at least one of the serviceId attribute, programId attribute and playbackState element.

The serviceId attribute can indicate “11”. The programId attribute can indicate “1008”. The playbackState element can indicate “fast-forward”. The speed attribute included in the playbackState element can indicate “3”.

With respect to a program having a program ID of “1008” in a service having a service ID of “11”, the broadcast reception device can deliver, to the companion screen device, playback information including playback state information that indicates that the program is “3× fast-forwarded”.

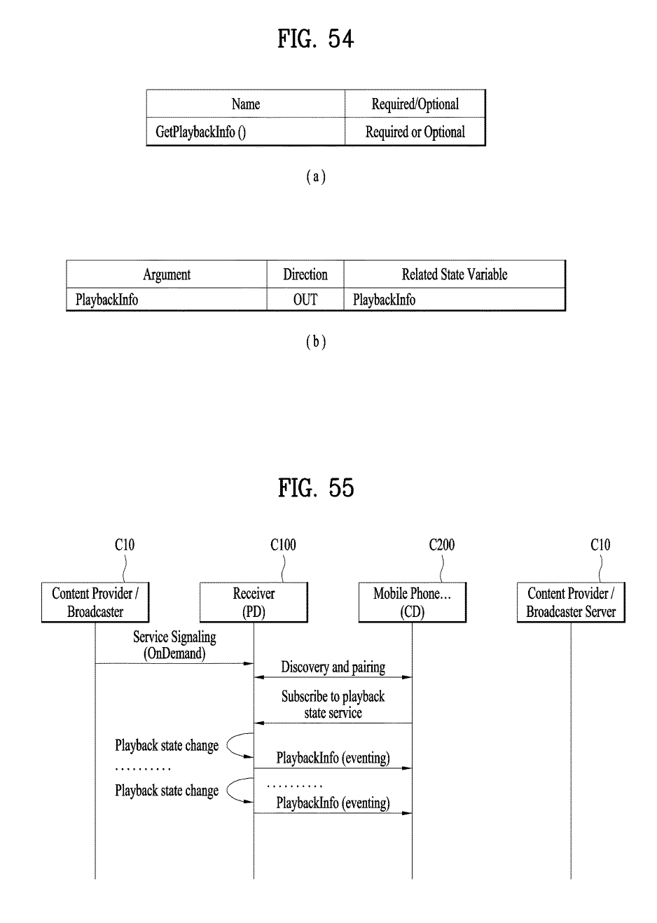

FIG. 54 illustrates operations necessary for playback information delivery according to an embodiment of the present invention.

Referring to FIG. 54(a), operations necessary for playback information delivery may include a playback information request (GetPlaybackInfo( )).

The playback information request (GetPlaybackInfo( )) is an operation of the companion screen device to request the broadcast reception device for acquisition of playback information including playback state information indicating the current playback state of a program played back in the broadcast reception device.

The playback information request may be a mandatory or optional operation. FIG. 54(b) shows an argument related to the playback information request.

The playback information request (GetPlaybackInfo( )) can be used when the companion screen device sends, to the broadcast reception device, a request for acquisition of playback information including playback state information indicating the current playback state of a program played back in the broadcast reception device. The companion screen device can request the broadcast reception device for playback information on the basis of the playback information request. The broadcast reception device can deliver playback information (PlaybackInfo Argument) including playback state information to the companion screen device as a response to the playback information request from the companion screen device on the basis of the playback information request using a companion screen interface. The playback information (PlaybackInfo Argument) is related to the PlaybackInfo state variable.

That is, the broadcast reception device can deliver playback information including playback state information indicating the current playback state of a program played back in the broadcast reception device to the companion screen device as a response to the request of the companion screen device (requesting method).

FIG. 55 is a flow diagram illustrating delivery of playback information from the broadcast reception device to the companion screen device using the eventing method according to an embodiment of the present invention.

Referring to the figure, a broadcast system according to an embodiment of the present invention may include at least one of a broadcast transmission device content server C10, a broadcast reception device C100 and a companion screen device C200.

The broadcast transmission device content server C10 can provide broadcast services. For example, broadcast services may include at least one of content (or linear services), applications (or non-linear services) and signaling information. The broadcast transmission device content server C10 can include at least one of the aforementioned broadcast transmission device (not shown), content provider (not shown), content server (not shown), controller (not shown) and transmitter (not shown).

The broadcast reception device C100 can receive broadcast services through broadcast networks and/or the Internet. The broadcast reception device C100 may be referred to as a TV receiver and/or a PD.

The companion screen device C200 can receive broadcast services through the Internet. The companion screen device may be referred to as a mobile phone and/or a CD.

A description will be given of a method through which the broadcast reception device delivers playback information including data related to a playback state of a program played back in the broadcast reception device to the companion screen device using the eventing method. The playback information can indicate the current playback state of the program played in the broadcast reception device.

First, the broadcast reception device C100 can receive a broadcast signal including a broadcast service from the broadcast transmission device content server C10. The broadcast service may include at least one of an on-demand streaming service and a non-real-time (NRT) service. In the case of an NRT service, the broadcast reception device can store at least one program included in the NRT service. For example, a user can view a specific program through the broadcast reception device using the on-demand service.

In addition, the broadcast reception device C100 can acquire signaling information on the basis of the broadcast signal. The signaling information may be related to the on-demand streaming service and/or the NRT service. The broadcast reception device can store the received signaling information.

Specifically, the broadcast reception device C100 can acquire application signaling information on the basis of the signaling information. As described above, the receiver C100 can acquire the signaling information on the basis of the MPEG-DASH protocol and/or MMT protocol. The application signaling information can include at least one of a trigger for triggering an application operation and triggering application information (or TPT) for signaling information about a triggered application. When the user selects a specific channel or a specific program, the broadcast reception device C100 can provide (or broadcast) the specific program to the user on the basis of the signaling information.

Then, the broadcast reception device C100 discovers and pairs with the companion screen device C200. For example, the broadcast reception device C100 can discover the companion screen device and electrically pair with the companion screen device to transmit/receive data to/from the companion screen device according to a provided program.

Subsequently, the broadcast reception device C100 can receive a request for subscription to a playback state service from the companion screen device C200. The companion screen device C200 can send a request for playback state service subscription to the broadcast reception device C100. The playback state service refers to a service of generating playback information including data related to a playback state of a program (or AV content) played back in the broadcast reception device C100 and delivering the playback information from the broadcast reception device C100 to the companion screen device C200.

The broadcast reception device C100 can play back a selected specific program.

A playback state of the broadcast reception device C100 may be changed by a user and/or for other reasons.

The broadcast reception device C100 can generate playback state information indicating a playback state of the played program.

The broadcast reception device C100 can deliver playback information including the playback state information to the companion screen device C200 using the eventing method. The broadcast reception device C100 can periodically deliver the playback information to the companion screen device C200 using the eventing method. Otherwise, the broadcast reception device C100 can deliver the playback information including the playback state information to the companion screen device C200 using the eventing method when the playback state information has changed.

Alternatively, the broadcast reception device C100 can deliver service time information including the playback state information to the companion screen device C200 using the eventing method.

For example, the broadcast reception device C100 can periodically deliver the service time information including the playback state information to the companion screen device C200 using the eventing method. Otherwise, the broadcast reception device C100 can deliver the service time information including the playback state information to the companion screen device C200 using the eventing method when the playback state information has changed. Furthermore, the broadcast reception device C100 can periodically deliver the service time information including the playback state information to the companion screen device C200 using the eventing method and, even when the playback state information has changed, the broadcast reception device C100 can deliver the service time information including the playback state information to the companion screen device C200. In addition, the broadcast reception device C100 can periodically deliver service time information including no playback state information to the companion screen device C200 using the eventing method and, when the playback state information has changed, the broadcast reception device C100 can deliver the service time information including the playback state information to the companion screen device C200. The service time information including no playback state information may refer to service time information including playback state information indicating a default value.

The broadcast reception device C100 can deliver playback information and/or service time information to the companion screen device C200 using the eventing method on the basis of update interval information (e.g., update duration information and update frequency information).

The broadcast reception device C100 can receive, from the companion screen device C200, a request for acquisition of current update interval information of the broadcast reception device C100.

The broadcast reception device C100 can deliver the current update interval information to the companion screen device C200 as a response to the request of the companion screen device C200 (requesting method). The companion screen device C200 can check the current update interval information of the broadcast reception device C100 on the basis of the update interval information request.

The broadcast reception device C100 can receive an update interval information setting request from the companion screen device C200.

The broadcast reception device C100 can generate confirmed update interval information on the basis of the requested update interval information. In addition, the broadcast reception device C100 can transmit the confirmed update interval information to the companion screen device.

The broadcast reception device C100 can deliver playback information and/or service time information to the companion screen device C200 on the basis of the confirmed update interval information using the eventing method.

The broadcast transmission device content server C10 can deliver time information (or signaling information) including media time information (or media time update) to the broadcast reception device C100 at a specific time or periodically according to program type and/or characteristics.

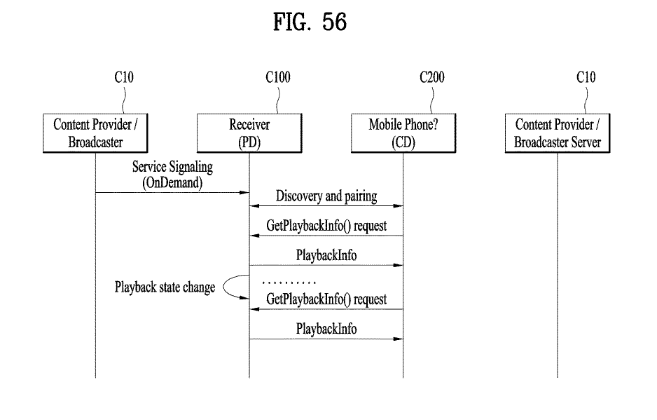

FIG. 56 is a flow diagram illustrating delivery of playback information from the broadcast reception device to the companion screen device using the requesting method according to an embodiment of the present invention.

Referring to the figure, a broadcast system according to an embodiment of the present invention can include at least one of a broadcast transmission device content server C10, a broadcast reception device C100 and a companion screen device C200. Description of the broadcast system according to an embodiment of the present invention can include the above description.

A description will be given of a method through which the broadcast reception device C100 delivers playback information to the companion screen device C200 using the requesting method.

First, the broadcast reception device C100 can receive a broadcast signal including a broadcast service from the broadcast transmission device content server C10. The broadcast service may include at least one of an on-demand streaming service and a non-real-time (NRT) service. In the case of an NRT service, the broadcast reception device can store at least one program included in the NRT service. For example, a user can view a specific program through the broadcast reception device using the on-demand service.

In addition, the broadcast reception device C100 can acquire signaling information on the basis of the broadcast signal. The signaling information may be related to the on-demand streaming service and/or the NRT service. The broadcast reception device can store the received signaling information.

Then, the broadcast reception device C100 discovers and pairs with the companion screen device C200. For example, the broadcast reception device C100 can discover the companion screen device and electrically pair with the companion screen device to transmit/receive data to/from the companion screen device according to a provided program.

Subsequently, the broadcast reception device C100 can receive a playback information request for acquisition of playback information from the companion screen device C200. The playback information request (GetPlaybackInfo( )) is an operation of the companion screen device to request the broadcast reception device for acquisition of playback information including playback state information indicating the current playback state of a program played back by the broadcast reception device.

Thereafter, the broadcast reception device C100 can generate playback information and deliver the playback information to the companion screen device C200 as a response to the request of the companion screen device C200. For example, the broadcast reception device C100 can deliver the playback information to the companion screen device C200 using the requesting method on the basis of the playback information acquisition request.

The playback state of the broadcast reception device C100 may be changed by the user and/or for other reasons.

In this case, the broadcast reception device C100 can receive the playback information request for acquisition of playback information from the companion screen device C200. For example, the companion screen device C200 can send, to the broadcast reception device C100, a request for acquisition of playback information using the playback information request (GetPlaybackInfo( ) action) as necessary or periodically.

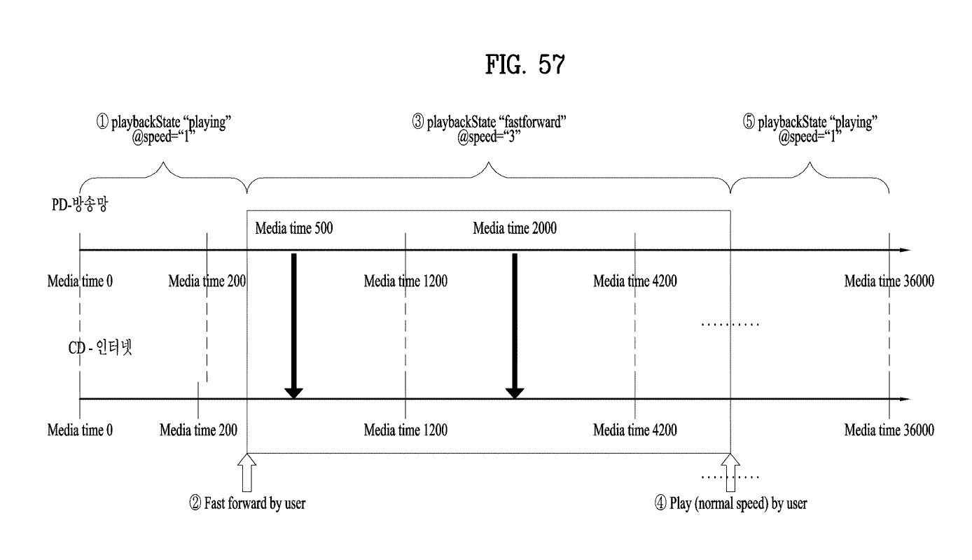

FIG. 57 illustrates delivery of playback state information according to an embodiment of the present invention.

Playback state information can be included in service time information and delivered or delivered through a separate state variable.

For example, two users view a movie through the broadcast reception device PD using an on-demand service. The broadcast transmission device content provider provides video content and first audio content (English audio) associated with the movie to the broadcast reception device through a broadcast network. A content server provides second audio content (Korean audio) associated with the movie to the broadcast reception device and/or the companion screen device CD through the Internet. That is, the companion screen device CD paired with the broadcast reception device PD can receive the second audio content through the Internet. The first user can view the movie (or program) including the video content and the first audio content (English speech) using the broadcast reception device. The second user can view the video content associated with the movie using the broadcast reception device and hear the second audio content associated with the movie using his or her companion screen device. The two users can use trick play such as fast-backward and fast-forward while viewing the movie.

In each playback state, the companion screen device can operate as follows. When the playback state of the broadcast reception device PD is “paused”, the second audio content of the companion screen device CD can be temporarily stopped. When the playback state of the broadcast reception device PD is “stopped”, the second audio content of the companion screen device CD can be stopped. When the playback state of the broadcast reception device PD is “fast-forward”, the second audio content of the companion screen device CD can be fast forwarded at the same speed. Since the broadcast reception device PD can periodically deliver media time information and/or wall-clock information to the companion screen device even during fast forward, the broadcast reception device PD and the companion screen device CD can be synchronized with each other. Since the broadcast reception device PD can deliver media time information and wall-clock information to the companion screen device even when the playback state thereof switches to “playing”, the broadcast reception device PD and the companion screen device CD can be synchronized with each other. When the playback state of the broadcast reception device PD is “fast-backward”, the second audio content of the companion screen device CD can be fast back warded at the same speed. Description of fast-backward is identical to the aforementioned description of fast-forward.

The figure illustrates a method for synchronization of the broadcast reception device and the companion screen device when the playback state of the broadcast reception device is “fast-forward”.

When a user views a movie, playback state information playbackState indicates “playing” and the speed attribute can be “1”. The broadcast reception device can deliver the playback state information to the companion screen device.

The playback state of the broadcast reception device may be changed to “3× fast-forward” by the user.

Then, the broadcast reception device can generate playback state information including information indicating that the playback state thereof has changed to “fast-forward” and information indicating that the speed attribute is “3” and deliver the playback state information to the companion screen device.

Thereafter, the playback state of the broadcast reception device may be changed to “normal play” by the user.

Then, the broadcast reception device can generate playback state information including information indicating that the playback state thereof has changed to “normal play” and information indicating that the speed attribute is “3” and deliver the playback state information to the companion screen device.

The broadcast reception device can periodically deliver service time information including media time information and/or wall-clock information to the companion screen device using the eventing method even during “fast-forward”.

The companion screen device can receive the playback state information from the broadcast reception device and be synchronized with the broadcast reception device.

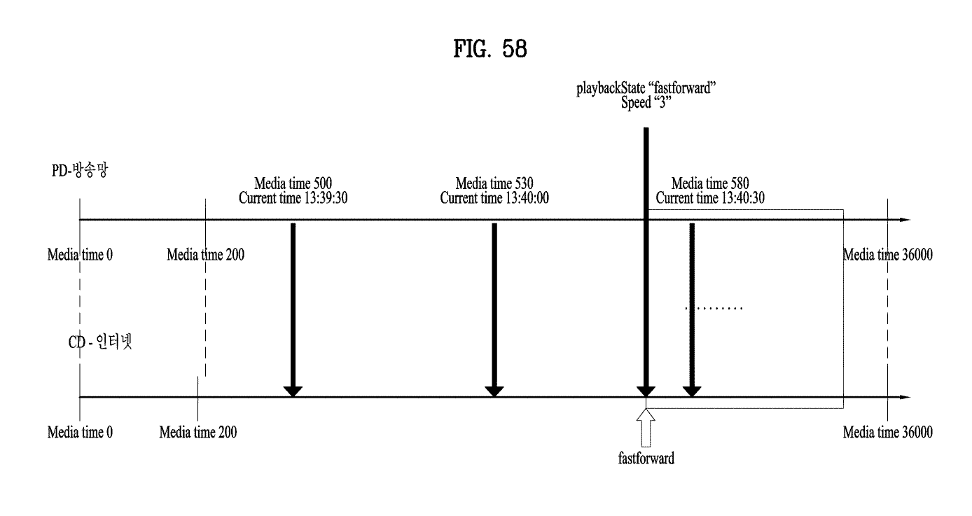

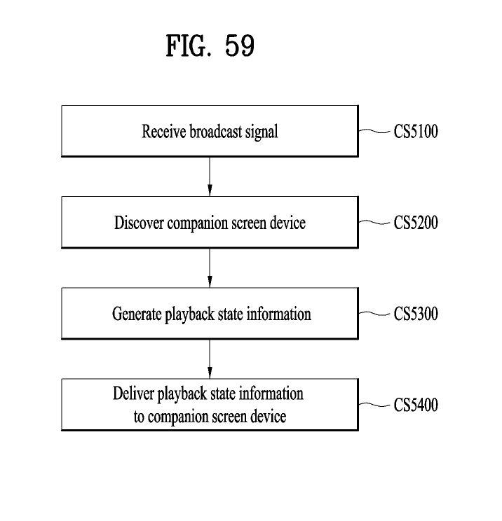

FIG. 58 illustrates delivery of playback state information according to an embodiment of the present invention.

Referring to the figure, the broadcast reception device PD may periodically deliver service time information including no playback state information to the companion screen device CD using the eventing method and, when playback state information has changed, deliver the playback state information to the companion screen device CD. The service time information including no playback state information may refer to service time information including playback state information indicating a default value.

The broadcast reception device PD can periodically deliver service time information including no playback state information to the companion screen device CD and additionally deliver playback state information to the companion screen device when the playback state information has changed.

FIG. 59 is a flowchart illustrating operation of the broadcast reception device according to an embodiment of the present invention.

The broadcast reception device can receive a broadcast signal containing a service including audio/video (AV) programs and signaling information using a broadcast interface (CS5100). For example, programs may refer to content. That is, the AV programs can refer to AV content.

For example, the signaling information can include service layer signaling (or first information) that provides discovery and acquisition of a service and at least one content component included in the service. In addition, the signaling information can include a service list table (or FIC or second information) containing data related to fast channel participation and switching. The service list table can build a list of services and provide bootstrap discovery of service layer signaling. The FIC allows the broadcast reception device to build a basic service list and bootstrap discovery of service layer signaling for each service. According to an embodiment, the FIC can be represented as a service list table (SLT). The FIC (or SLT) can be delivered through link layer signaling. Furthermore, the FIC (or SLT) can be transmitted in each physical layer frame for fast acquisition. According to an embodiment, the FIC (or SLT) can be transmitted through at least one of a physical layer frame, a PLP delivering signaling and a PLP assigned per broadcaster.

In addition, the signaling information can include media time information of played AV programs.

The signaling information can include at least one of a fragmentation_indicator that indicates whether the signaling information has been fragmented, a payload format_indicator that indicates whether the header of the signaling information includes information about the payload format, an expiration_indicator that indicates whether the header of the signaling information includes expiration of the signaling information, a fragment_number attribute that indicates the number of a signaling information fragment, a last_fragment_number attribute that indicates the number of the last signaling information fragment, a payload_format attribute that indicates the payload format of the signaling information and an expiration attribute that indicates expiration of the signaling information.

The broadcast reception device can discover the companion screen device using a companion screen interface (CS5200). The broadcast reception device can deliver data and/or signaling information to the companion screen device using the companion screen interface or receive data and/or signaling information from the companion screen device.

Then, the broadcast reception device can operate the broadcast interface and the companion screen interface using the controller.

The controller may include a playback state service processor (not shown). The broadcast reception device can generate playback state information indicating a playback state of a program on the basis of the signaling information using the controller and the playback state service processor (CS5300). The playback state information can include a speed attribute that indicates a playback speed of the program.

Thereafter, the broadcast reception device can deliver the playback state information to the companion screen device using the companion screen interface (CS5400).

The broadcast reception device according to an embodiment of the present invention can deliver the playback state information using the requesting method. For example, the broadcast reception device can receive a playback information request for acquisition of playback information from the companion screen device using the companion screen interface. In addition, the broadcast reception device may generate playback information including playback state information indicating the playback state of a played program using the controller (or playback state service processor). Then, the broadcast reception device can deliver the playback information to the companion screen device using the companion screen interface.

The broadcast reception device according to an embodiment of the present invention can deliver service time information using the eventing method. For example, when the playback state information has changed, the broadcast reception device can generate playback information including the playback state information indicating a playback state of a program using the controller (or playback state service processor). Thereafter, the broadcast reception device can generate an event and deliver the playback information to the companion screen device using the companion screen interface.

The controller of the broadcast reception device may include a synchronization service processor (not shown). The broadcast reception device can generate service time information providing data related to synchronization between an AV program and an AV program displayed through the companion screen device on the basis of the signaling information using the controller or the synchronization service processor. The service time information can include playback state information. The broadcast reception device can deliver the service time information to the companion screen device using the companion screen interface.

The service time information according to an embodiment of the present invention can include at least one of a serviceId attribute that indicates a service ID, a programId attribute that indicates the ID of a played program in a service, a mediaTime element that indicates media time information of a program and a currentTime element that indicates wall-clock time.

The broadcast reception device according to an embodiment of the present invention can deliver the service time information using the requesting method. The broadcast reception device can deliver the service time information to the companion screen device on the basis of a first request for acquisition of the service time information, received from the companion screen device, using the companion screen interface.

The broadcast reception device according to an embodiment of the present invention can deliver the service time information using the eventing method. For example, the broadcast reception device can generate service time information including playback state information indicating a playback state of a program using the controller (or synchronization service processor) when the playback state information has changed. Then, the broadcast reception device can generate an event and deliver the service time information to the companion screen device using the companion screen interface.

Furthermore, the broadcast reception device can generate update interval information indicating a service time information delivery interval using the controller. Then, the broadcast reception device can deliver the service time information to the companion screen device on the basis of the update interval information using the companion screen interface.

The update interval information according to an embodiment of the present invention may be one of update duration information indicating a service time information delivery duration and update frequency information indicating service time information delivery frequency. For example, an interval can include a duration and/or frequency. The update interval information can include update duration information and/or update frequency information.

The broadcast reception device can request acquisition of the update interval information. The broadcast reception device can receive a second request (or update interval information request) for acquisition of the update interval information from the companion screen device using the companions screen interface. Then, the broadcast reception device can generate current update interval information indicating the value of the update interval information at the time indicated by wall-clock time on the basis of the second request using the controller (or synchronization service processor). Thereafter, the broadcast reception device can deliver the current update interval information to the companion screen device using the companion screen interface.

For example, the update interval information request may include an update duration information request and/or an update frequency information request. The current update interval information may include current update duration information and/or current update frequency information.

The broadcast reception device can request setting of update interval information. The broadcast reception device can receive a third request (or update interval information setting request) for setting of update interval information from the companion screen device using the companions screen interface. The third request can include requested update interval information indicating a value of update interval information requested by the companion screen device. Then, the broadcast reception device can generate confirmed update interval information that indicates one of the same value as the requested update interval information and a value closest to the requested update interval information. Subsequently, the broadcast reception device can deliver the service time information to the companion screen device on the basis of the confirmed update interval information using the controller (or synchronization service processor).

For example, the update interval information setting request may include an update duration information setting request and/or an update frequency information setting request. The requested update interval information may include requested update duration information and/or requested update frequency information. The confirmed update interval information may include confirmed update duration information and/or confirmed update frequency information.

A module, a processor, a device, or a unit may be processors for execution of consecutive procedures stored in a memory (or storage unit). Each operation described in the aforementioned embodiments may be performed by hardware/processors. Each module/block/units described in the aforementioned embodiments may be executed as code. The code may be written in a storage medium readable by a processor and, accordingly, readable by a processor provided by an apparatus.

A method invention according to the present invention may be embodied in the form of a program command to be executed through various computer elements and recorded in a computer readable medium.

The computer readable medium may include a program command, a data file, a data configuration, and so on alone or in combination thereof. The program command stored in the medium may be particularly designed and configured for the present invention or may be well known or used by one of the ordinary skill in the art of computer software. Examples of the computer readable medium may include magnetic media such as a hard disk, a floppy disk, and a magnetic tape, optical media such as CD-ROM and DVD, magneto-optical media such as floptical disks, and a hardware device that is particularly configured to store and execute a program command such as a read only memory (ROM), a random access memory (RAM), and a flash memory. Examples of the program command may include a high-level language code to be executed by a computer using an interpreter or the like as well as a machine code generated by a compiler. The hardware device may be configured to operate as one or more software modules in order to perform the operation according to the present invention and vice versa.

It will be apparent to those skilled in the art that various modifications and variations can be made in the present invention without departing from the spirit or scope of the inventions. Thus, it is intended that the present invention cover the modifications and variations of this invention provided they come within the scope of the appended claims and their equivalents.

Accordingly, it will be apparent to those skilled in the art that various modifications and variations can be made in the present invention within the scope of the appended claims and their equivalents.

In addition, throughout this specification, both device and method inventions have been described. As necessary, the description of the device and method inventions may be applied supplementarily.

### MODE FOR INVENTION

Various embodiments have been described in the best mode for carrying out the invention.

### INDUSTRIAL APPLICABILITY

The present invention may be used in all fields related to broadcasting.

1. A broadcast reception device comprising:
a broadcast interface for receiving a service including a program and signaling information;
a companion screen interface for discovering a companion screen device; and
a controller for discovering the service and extracting signaling descriptive information on the service,
wherein the controller generates playback state information indicating a playback state of the program on the basis of the signaling information, and
wherein the companion screen interface delivers the playback state information to the companion screen device.

2. The broadcast reception device according to claim 1, wherein the signaling information includes at least one of a fragmentation_indicator indicating whether the signaling information has been fragmented, a payload_format_indicator indicating whether a header of the signaling information includes information about a payload format, an expiration_indicator indicating whether the header of the signaling information includes expiration of the signaling information, a fragment_number attribute indicating the number of a fragment of the signaling information, a last_fragment_number attribute indicating the number of the last fragment of the signaling information, a payload_format attribute indicating a payload format of the signaling information, and an expiration attribute indicating expiration of the signaling information.

3. The broadcast reception device according to claim 1, wherein the signaling information includes first information providing discovery and acquisition of the service and at least one content component included in the service.

4. The broadcast reception device according to claim 1, wherein the signaling information includes second information containing data related to fast channel participation and switching,
wherein the second information builds a list of the service and provides bootstrap discovery of the first information.

5. The broadcast reception device according to claim 1, wherein the playback state information includes a speed attribute indicating a playback speed of the program.

6. The broadcast reception device according to claim 1, wherein the companion screen interface receives, from the companion screen device, a playback information request for acquisition of playback information,
wherein the controller generates playback information including playback state information indicating a playback state of the playback program; and
wherein the companion screen interface delivers the playback information to the companion screen device.

7. The broadcast reception device according to claim 1, wherein the controller generates playback information including playback state information indicating the playback state of the program when the playback state of the program has changed, and
wherein the companion screen interface generates an event and delivers the playback information to the companion screen device.

8. The broadcast reception device according to claim 1, wherein the controller generates service time information providing information related to synchronization between the program and a program displayed through the companion screen device on the basis of the signaling information,
wherein the service time information includes the playback state information.

9. The broadcast reception device according to claim 8, wherein the service time information further includes at least one of a serviceId attribute indicating an ID of the service, a programId attribute indicating an ID of the playback program in the service, a mediaTime element indicating the media time information of the program and a currentTime element indicating wall-clock time.

10. The broadcast reception device according to claim 8, wherein the companion screen interface delivers the service time information to the companion screen device on the basis of a first request for acquisition of the service time information received from the companion screen device.

11. The broadcast reception device according to claim 8, wherein the controller generates service time information including playback state information indicating the playback state of the program when the playback state of the program has changed, and
wherein the companion screen interface generates an event and delivers the service time information to the companion screen device.

12. The broadcast reception device according to claim 8, wherein the controller generates update interval information indicating an interval at which the service time information is delivered, and
wherein the companion screen interface delivers the service time information to the companion screen device on the basis of the update interval information.

13. The broadcast reception device according to claim 12, wherein the update interval information is one of update duration information indicating a duration in which the service time information is delivered and update frequency information indicating frequency with which the service time information is delivered.

14. The broadcast reception device according to claim 12, wherein the companion screen interface receives a second request for acquisition of update interval information from the companion screen device,
wherein the controller generates current update interval information indicating a value of the update interval information at a time indicated by the wall-clock time on the basis of the second request, and
wherein the companion screen interface delivers the current update interval information to the companion screen device.

15. The broadcast reception device according to claim 12, wherein the companion screen interface receives a third request for setting of update interval information from the companion screen device,
wherein the third request includes requested update interval information indicating a value of update interval information requested by the companion screen device,
wherein the controller generates confirmed update interval information indicating one of the same value as the requested update interval information and a value closest to the requested update interval information, and
wherein the companion screen interface delivers the service time information to the companion screen device on the basis of the confirmed update interval information.
